(19) United States
(12) Patent Application Publication
(10) Pub. No.: US 2018/0091930 A1
(43) Pub. Date: Mar. 29, 2018

(54) SYSTEMS AND METHODS FOR VEHICLE ACCESS AND MANAGEMENT

(71) Applicant: Mobilogix, Inc., Montrose, CA (US)

(72) Inventor: James Jefferies, Irvine, CA (US)

(21) Appl. No.: 15/280,886

(22) Filed: Sep. 29, 2016

(51) Int. Cl. H04W 4/00; H04L 12/40; H04L 29/08; H04L 29/06; H04W 12/06; H04W 12/08; G07C 9/00

(52) U.S. Cl. CPC H04W 4/008; H04L 12/40013; H04L 67/125; H04L 67/306; G07C 9/00896; H04L 63/102; H04W 12/06; H04W 12/08; H04L 63/062; H04L 63/08

(57) ABSTRACT

Various embodiments of vehicle access and management systems and methods are disclosed herein for providing added functionality and connected-vehicle services to vehicles. The frontend of the system may include an in-vehicle infotainment unit running a custom application which may communicate with the various electronic systems of the vehicle in order to issue commands, perform actions, and obtain data. Through the custom application, the in-vehicle infotainment unit may be able to pair with peripheral devices for added functionality or wirelessly communicate with the backend of the system, which may include remote servers, cloud-based servers, and/or mobile applications configured to carry out the connected-vehicle services and manage their associated databases. When the in-vehicle infotainment unit cannot directly pair with a peripheral device or utilize an available wireless connection to the backend, the system may also include an external hub device configured to bridge the in-vehicle infotainment unit to the peripheral devices or provide a wireless connection between the in-vehicle infotainment unit and the backend. This external hub has numerous components and features that allow it to carry out the functionality of the custom application if desired and it may be easily plugged into an on-board diagnostic port of the vehicle. Examples of connected-vehicle services provided may include car rental, car sharing, taxi management, ignition interlock, equipment rental, and so forth.

### TECHNICAL FIELD

Embodiments of the present disclosure are directed to vehicle access and management systems and methods of use. More specifically, the vehicle access and management systems include various components, such as modular hardware devices and specially-designed software, which are designed to be used in conjunction with in-vehicle infotainment units in order to provide connected-vehicle services and extend the functionality of a vehicle for a variety of purposes.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In-vehicle infotainment units are frequently found in modern vehicles and serve as specially adapted computers designed to operate within the vehicle. For example, infotainment units can frequently be found in the dashboards or seats of modern automobiles and have a screen from which operations can be managed by the driver or a passenger. As another example, infotainment units can also be frequently found in the back of seats on commercial airliners to entertain passengers on flights. These infotainment units are typically used to deliver entertainment and information content to the operator or a passenger of the vehicle, and may be controlled with voice commands, touchscreen input, or physical controls.

Typical tasks that can be performed with an in-vehicle infotainment unit include managing and playing audio content, utilizing navigation for driving, delivering rear-seat entertainment such as movies, games, social networking, etc., listening to incoming and sending outgoing SMS text messages, making phone calls, and accessing Internet-enabled or smartphone-enabled content such as traffic conditions, sports scores and weather forecasts.

However, these infotainment units may be limited in their functionality based on the hardware and/or software components provided by the manufacturer. A need exists for extending the functionality of these infotainment units in order to provide additional features, such as dynamic vehicle management and connected-car services, to vehicle operators, owners, and passengers.

### SUMMARY

Some embodiments of methods and systems in this disclosure overcome the aforementioned problems and are distinguished over the prior art by, among other novel features, a vehicle access and management system and method for use that utilizes a vehicle having a controller area network (CAN) bus interface and an infotainment unit running a custom in-vehicle application, which is configured to pair with modular peripheral devices and utilize an available wireless connection to a backend of the vehicle access and management system. The backend may include remote servers, cloud-based servers, and mobile applications running on mobile devices, which may be wirelessly connected to the vehicle to allow for monitoring and configuring the vehicle, the provision of connected-vehicle services, and the remote issuing of commands to the various systems of the vehicle.

Some embodiments may also include an external hub that may be installed in the vehicle, which may be configured to bridge the in-vehicle infotainment unit to the peripheral devices or provide a wireless connection between the in-vehicle infotainment unit and the backend when the in-vehicle infotainment unit cannot directly pair with a peripheral device or utilize an available wireless connection to the backend. The external hub may have numerous components and features that allow it to carry out the functionality of the custom application if desired, and it may be easily installed such as by plugging it into an on-board diagnostic port of the vehicle. Among other things, the external hub may include processors, an accelerometer, data storage, a GPS chipset with antenna, a PCB mounted wireless (cellular) modem and antenna, and CAN bus transceivers (controller area network) connected with the processor, and a USB programmable interface.

A feature and advantage of some embodiments is that the hardware components are modular and may be utilized when needed. Different hardware components may be selected and used with a custom application that is specifically tailored for carrying out specific functions and services. This allows the vehicle access and management system to be easily adapted for providing functions and services that have not yet been contemplated, while keeping down the cost of the hardware needed to perform different services.

Another feature and advantage of some embodiments is that they provide a method of digitally controlling electromechanical functions of a vehicle (e.g., enable/disable starter, door lock/unlock, flash lights, open/close windows, open/close sunroof, sound horn, pop trunk, etc.) through the vehicle's CAN Bus network. This reduces the installation time and increases reliability, typically only requiring that the infotainment unit download the custom application. If an external hub is needed, it may be quickly installed through a variety of methods, such as plugged into an OBDII port that is present in most modern vehicles. Instructions and commands may also be wirelessly transmitted to the vehicle, which allows remote control of the various systems and functions of the vehicle.

Another feature and advantage of some embodiments is that they are universal in nature and designed to auto-configure or be quickly configured to a specific type of vehicle. The system may be used with various years, makes, and models of vehicles. This universality also allows for reduction in installation time and increased reliability.

Another feature and advantage of some embodiments is that they may have power management and power save functionality, so that commands and data can be transmitted between the vehicle and the backend even if the vehicle is turned off. The application may have a high level of access to the vehicle so that it may be run on battery power, and it may be configured to run in various reduced-power schemes so that the battery is not drained. The external hub may also have this power management and power save functionality that can be used with vehicles where the application does not have a high level of access to the vehicle.

Another feature and advantage of some embodiments is that they can be used to provide connected-vehicle services, some examples of which include car rental, car sharing, taxi fleet management, ignition interlock, and equipment rental. These are services that are made possible with the vehicle having access to a wireless connection. Additional features and advantages described below may pertain to one or more contexts that these connected-vehicle services may be provided.

Another feature and advantage of some embodiments is that they provide a method of remotely gathering vehicle data, which can be used for monitoring purposes or for providing a benefit to the vehicle operator. Examples include monitoring, storing and reporting vehicle diagnostics (e.g., malfunction indicator light (MIL), airbag deployed, battery level, etc.), mileage, telltale, speed, location, route driven, geofence, hard/extreme braking and acceleration (onboard accelerometer). For example, vehicle data may be obtained and used to search the national vehicle recall database and displaying that specific vehicle's recall information (recall notice, repair status; repaired/not repaired) on a mobile device.

Another feature and advantage of some embodiments is that they provide a method of collecting and storing customer specific vehicle usage data (e.g., fuel level, start/end odometer reading, total miles, hours in use, max/average speed, idle time, start/stop dates and time, carbon foot print, driver rating, etc.) for purposes of billing (e.g., invoice based on hourly usage, mileage or flat day rate). Additional charges or discounts can be applied (e.g., User Based Insurance—UBI) for safe driving and safe driving areas (e.g., Location Based Insurance—LBI) if the vehicle is used in a high or low risk area.

Another feature and advantage of some embodiments is that they provide a method of remotely identifying a specific customer and verifying a reservation or use of a specific rental-carshare (RCS) vehicle for a predetermined period of time.

Another feature and advantage of some embodiments is that they provide a method of dynamically pairing a customer's contact information (e.g., mobile phone number, email address, emergency contact information) to a specific rental/car-share vehicle during their rental period and sending emergency alerts (e.g., email, SMS, voice call) to a specific customer's emergency contact list.

Another feature and advantage of some embodiments is that they enable customers to bypass the reservation desk and pickup/drop off reserved and non-reserved RCS vehicles using a Quick Response (QR)/Bar code, or Radio Frequency Identification (RFID)/Near Field Communication (NFC)/Bluetooth enabled mobile phone coupled with a mobile app. In either instance, an identifier may be obtained and sent to the servers for verification. Upon proper verification of the identifier and the reservation for the customer, the vehicle may be unlocked for the customer. These servers may contain, among other functionality, a vehicle database, a customer mobile device interface, SMS gateway, email gateway, and a billing system.

Another feature and advantage of some embodiments is that they provide a method of sending user specific emergency alerts (e.g., location, airbag deployed, collision or rollover, accelerometer, diagnostic freeze frame, speed, heading, extreme acceleration/braking for a predetermined period prior to the incident) to a third party emergency dispatch (e.g., 911 or bonded call center) and customers' emergency contacts.

Another feature and advantage of some embodiments is that they provide a method of gathering and updating and storing vehicle specific data (e.g., location, airbag deployed, collision or rollover, accelerometer, diagnostic freeze frame, speed, heading, extreme acceleration/braking) and onboard data (accelerometer) for a predetermined time period (e.g., every 15 seconds). Upon a collision or roll over the logged data can be uploaded via a wireless network to a third party or recovered via hard wired connection in order to determine the cause and/or fault of the accident.

Another feature and advantage of some embodiments is that they provide a method of notifying the RCS companies of any critical diagnostics and/or mileage based maintenance alerts.

Another feature and advantage of some embodiments is that they provide a method of automatically checking out and billing customers when a RCS vehicle is returned. The charge for the rental period can be dynamically generated based, for example, on time used (e.g., hours, days), miles traveled with additional charges for insurance (e.g., based on driver rating and location) and/or fuel (e.g., is the tank full; if not, additional charge for the difference—based on fuel tank level). The customer may be able to pay with a credit card before leaving the vehicle.

A further feature and advantage of some embodiments is that they provide a method of enabling RCS companies to remotely perform location based inventory utilizing a Graphic User Interface (GUI), wireless network and global positioning system (GPS); companies can perform a virtual roll call giving them count and location of all their vehicles and vehicle status (e.g., reserved, not reserved, in use, online, offline, miles to next service and diagnostic trouble code (DTC) status).

Another feature and advantage of some embodiments is that they provide a method of preloading the rental or fleet vehicle's onboard navigation system with the renter's trip destinations. During the reservation (web based or mobile app) process a renter can select their destinations (trip log) during the rental period; the trip log is stored in the customer's database. When the vehicle is checked out via the QR Code, RFID or NFC, the trip log is downloaded to the RCS control module which uploads the trip log to the onboard navigation system.

Another feature and advantage of some embodiments is that it can be used to replace current systems used by mobile-device taxi services or taxi cab companies. Instead of a driver being provided with a separate mobile phone for receiving pickup requests and drop-off destinations, the system would handle those functions along with metering and billing.

Another feature and advantage of some embodiments is that it can be used with any vehicle, including construction or farm vehicles among others. A customer may be able to reserve and rent a tractor and pay based on logged operating hours and usage, and so forth, using similar methods as for a RCS vehicle.

Neither this summary nor the following detailed description purports to define the scope of protection. The scope of protection is defined by the claims.

### BRIEF DESCRIPTION OF THE DRAWINGS

FIG. 1 is a system diagram that illustrates an environment for implementing one embodiment of the vehicle access and management system.

FIG. 2A is a system diagram that illustrates one embodiment of a vehicle access and management system.

FIG. 2B is a system diagram that illustrates one embodiment of a vehicle access and management system.

FIG. 3 is a diagram that illustrates some example peripheral devices that may be used with the vehicle access and management system.

FIG. 4 is a system diagram that illustrates some examples of electronic systems of a vehicle that may be accessed with one embodiment of the vehicle access and management system.

FIG. 5A is a system diagram that illustrates one embodiment of a vehicle access and management system.

FIG. 5B is a system diagram that illustrates one embodiment of a vehicle access and management system.

FIG. 6A is a system diagram that illustrates the connection methods of one embodiment of an external hub.

FIG. 6B is a system diagram that illustrates the connection methods of one embodiment of an external hub.

FIG. 7 is a system diagram that illustrates the components of one embodiment of an external hub.

FIG. 8 illustrates one embodiment of an external hub being plugged into an OBD2 Port.

FIG. 9 is a system diagram that illustrates how example embodiments of the external hub and infotainment unit are used in conjunction with various computers within a vehicle.

FIG. 10 is an example user interface of one embodiment of an in-vehicle infotainment unit.

FIG. 11 is a flowchart that illustrates how a user may access one embodiment of the in-vehicle application.

FIG. 12A is an example user interface of one embodiment of an in-vehicle application. More specifically, it illustrates a user interface in which a user may login to an associated user profile by entering credentials associated with that user profile.

FIG. 12B is an example user interface of one embodiment of an in-vehicle application.

FIG. 13A is a flowchart that illustrates how embodiments of the vehicle access and management system may be configured to identify the vehicle.

FIG. 13B is a flowchart that illustrates how embodiments of the vehicle access and management system may be configured to identify the vehicle.

FIG. 14 is a system diagram that illustrates how the vehicle access and management system may be implemented in an ignition interlock context.

FIG. 15 is a flowchart that illustrates how a user may access one embodiment of an in-vehicle breathalyzer application.

FIG. 16 is system diagram that illustrates how the vehicle access and management system may be implemented in an ignition interlock context.

FIG. 17 is a flowchart that illustrates how a customer may typically use a mobile application in the rental car context.

FIG. 18 is system diagram that illustrates how the vehicle access and management system may be implemented in a taxi management context.

FIG. 19 is a flowchart that illustrates how a user may download and access one embodiment of a road usage charge in-vehicle application (RIVA).

FIGS. 20A-20F illustrate various example user interfaces of one embodiment of a road usage charge in-vehicle application (RIVA).

FIG. 21 illustrates how payment is processed for a road usage charge in-vehicle application (RIVA).

FIG. 22 is a flowchart that illustrates how a user may download and access one embodiment of a finance in-vehicle application (FIVA).

FIGS. 23A-23G illustrate various example user interfaces of one embodiment of a finance in-vehicle application (FIVA).

FIGS. 24A-24H illustrate various example user interfaces of one embodiment of a rental-carshare in-vehicle application (RCSIVA).

FIG. 25 illustrates various example user interfaces on a mobile device used in conjunction with a rental-carshare in-vehicle application (RCSIVA).

FIGS. 26A-26G illustrate various example user interfaces of one embodiment of a rental-car-share in-vehicle application (RCSIVA).

FIG. 27 is a system diagram that illustrates how the vehicle access and management system may be implemented in a rental-carshare context.

FIGS. 28A and 28B illustrate how the vehicle access and management system may be implemented in a rental-carshare context.

FIG. 29 is a block diagram showing embodiments of a computing device, an external hub, and remote servers which are all in communication through a wireless network.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

It should also be noted that this disclosure makes frequent references to automobiles and connected-car services in order to facilitate a better understanding of the vehicle access and management system. The automobile examples are not intended to be limiting and the vehicle access and management systems may be applied to any type of vehicle or mobile machine used to transport people. Some additional examples of vehicles that can utilize a vehicle access and management system include cars, motorcycles, buses, farm machinery (e.g., tractors), long and short-haul trucking vehicles, airplanes, boats (commercial and private), spacecraft, among others.

### Introduction and General Overview

The present disclosure is directed to vehicle access and management systems and methods. These vehicle access and management systems may include hardware devices, software applications, and/or modular components that electronically interface with various aspects of a vehicle. In some cases, these vehicle access and management systems may include in-vehicle infotainment units, which are frequently found in modern vehicles and serve as specially adapted computers designed to operate within the vehicle. The vehicle access and management systems may extend the basic functionality of these infotainment units by pairing them with specially-designed software, Internet or Network connections, and/or peripheral devices. The vehicle access and management systems may enhance the experience of the vehicle operator and/or passengers by providing a variety of additional functions and services, depending on the software. The specially-designed software may be configured to utilize the various components of the vehicle access and management system in order to perform specific tasks, such as providing improved control of vehicle access and functionality, providing vehicle tracking and diagnostics, and carrying out connected-vehicle services.

In order to facilitate an understanding of the disclosed embodiments of the invention, a general overview will initially be provided of vehicle electrical systems and in-vehicle infotainment units before describing embodiments of vehicle access and management systems.

Modern vehicles are increasingly reliant on complex electrical systems. These electrical systems may be used to control various aspects of the vehicle or utilize available instrumentation and sensors. Many vehicles employ electronic control units (ECUs), which are embedded systems that control one or more of the electrical systems or subsystems of the vehicle. In some cases, a vehicle may have as many as 70 ECUs for its various subsystems.

Some non-limiting examples of ECUs found in automobiles include the Electronic/Engine Control Module (ECM), the Powertrain Control Module (PCM), the Transmission Control Module (TCM), the Brake Control Module (BCM or EBCM), the Central Control Module (CCM), the Central Timing Module (CTM), the General Electronic Module (GEM), the Body Control Module (BCM), the Suspension Control Module (SCM), the Engine Control Unit, the Door Control Unit (DCU), the Electric Power Steering Control Unit (PSCU), the Human-Machine Interface (HMI), the Seat Control Unit, the Speed Control Unit (SCU), the Telematic Control Unit (TCU), the Telemetry Unit (TU), and the Battery Management System (BMS).

Taken together, these various ECUs and embedded electronic systems are sometimes referred to as the vehicle's computer. However, in reality there may not be a central or host computer tasked with managing all the ECUs. Instead, the ECUs may operate independently and communicate with one another over a serial bus, such that when an ECU sends a message it is broadcast to every other ECU on the bus. In order for all the ECUs to effectively communicate and understand each other, the ECUs rely on a unified “language”.

The controller area network (CAN bus) is a multi-master broadcast serial bus standard that defines how the connected ECUs communicate with one another. More specifically, CAN is a low-level signaling protocol that defines the data frame format, which is the structure and the way data is communicated between the ECUs. There are other signaling protocols besides the CAN protocol, but the CAN protocol is frequently found in modern automobiles in the United States since it became mandatory in the year 2008.

Since the CAN protocol is only a low-level signaling protocol, it must be used in conjunction with other protocols. For example, someone learning the English language would not be able to understand and communicate effectively with other English speakers if they were only taught the twenty-six letters that make up the English alphabet. There would be additional grammatical rules and individual words would need to be defined and given meanings. Similarly, the CAN protocol only specifies that the data field can be as long as 64 bits, but it does not specify how to encode data in the data field. A higher layer protocol, such as an application data protocol, is needed in order to additionally specify the meaning of the bits in the data field of a CAN message. Such a protocol will define, for example, that “01001101” in the data field of the CAN data frame means that the engine coolant temperature is 100 degrees Celsius.

Vehicles may have on-board diagnostics, which provides the vehicle a self-diagnostic and reporting capability. The vehicle is provided access to the status of the various vehicle sub-systems, such as engine temperature and engine speed. The vehicle may also have a diagnostic connector that allows a diagnostics tool to be connected to the on-board diagnostics system in order to retrieve this information. Modern automobiles sold in the United States after 1996 follow the On-Board Diagnostics (OBD-II) vehicle diagnostics standard, which specifies the type of diagnostic connector, the pinout/design of the diagnostic connector, the electrical signaling protocols available, and the messaging format.

Thus, automobiles that abide by the ODB-II standard have certain features in common. These automobiles have an internal OBD-II system that allows diagnosis on the state of the car. For example, if the OBD-II system detects something wrong with the engine, it would turn on the “Check Engine” light. These automobiles utilize at least the CAN protocol and four specific higher-layer protocols that are part of the standard. This collection of protocols help define the OBD-II standard parameters, which define the information and format for diagnostic messages sent over the CAN bus. These automobiles also have a diagnostic connector that is located within two feet of the steering wheel, and OBD-II standard diagnostic tools or scanners may be connected to the diagnostic connector in order to send and receive diagnostic command messages over the CAN bus.

Modern vehicles may also have in-vehicle infotainment units. These in-vehicle infotainment units may serve as specially adapted computers designed to be operated within the vehicle by a vehicle operator or passenger. These infotainment units are typically used to deliver entertainment and information content to the operator or a passenger of the vehicle, and may be controlled with voice commands, touchscreen input, or physical controls. In some cases, these infotainment units may utilize Bluetooth technology and/or smartphones to provide a user control. For example, infotainment units can also be frequently found in the back of seats on commercial airliners to entertain passengers on flights.

As another example, in-vehicle infotainment units are frequently found in the dashboards or seats of modern automobiles and have a screen from which operations can be managed by the driver or a passenger. Typically, these infotainment units are used to perform tasks including managing and playing audio content, utilizing navigation for driving, delivering rear-seat entertainment such as movies, games, social networking, etc., listening to incoming and sending outgoing SMS text messages, receiving voice commands, and making phone calls. In some cases, the infotainment unit may have Internet access, either directly or through a paired smartphone. These infotainment units may be used to access Internet-enabled or smartphone-enabled content such as traffic conditions, sports scores and weather forecasts. Other examples of Internet-enabled tasks such infotainment units can perform include the automatic notification of crashes, the notification of speeding and safety alerts, playing music/audio off the Internet, navigation, managing roadside assistance, providing contextual help/offers, running parking applications, and running other software applications (including smartphone applications).

These infotainment units may also be able to access or interface with the various sensors and electronics present in modern day vehicles via the CAN bus. In other words, the infotainment units may be able to communicate with the various ECUs and electronic systems of the car. For example, the infotainment unit may be able to interact with or take readings from door locks, the engine, the odometer, and so forth; the infotainment unit may have the ability to send digital commands for locking/unlocking doors, managing fuel consumption, managing vehicle or engine speed/rpms, and so forth. This existing connection between the infotainment units and the various electronic systems of the car may be leveraged in order to provide additional features and benefits to vehicle operators, owners, and passengers, beyond those functionalities envisioned by the manufacturer. In some cases, the added functionality is a result of bridging various peripheral devices (which are not native to the vehicle) to the electronic systems of the car, which can be accomplished using the vehicle access and management systems described herein.

These vehicle access and management systems generally include modular hardware components and/or software applications that electronically interface with a vehicle in order to provide improved control of vehicle access and functionality. In some embodiments, the vehicle access and management system includes the infotainment unit and various modular hardware and/or software applications to be used in conjunction with the infotainment unit, in order to perform specific tasks beyond the base functionality of the infotainment unit, such as providing improved control of vehicle access and functionality, providing vehicle tracking and diagnostics, and carrying out connected-car services.

The modular hardware components may include various peripheral devices usable by the vehicle operator or passenger. These peripheral devices may be used to perform functions that the in-vehicle infotainment unit cannot perform.

The modular hardware components may also include an external hub device, which may be used to cure certain technological deficiencies in a particular infotainment unit. For example, the external hub device may allow the peripheral devices to be connected to the infotainment unit if the peripheral devices are unable to be paired directly to the infotainment unit, or the external hub device may provide the infotainment unit access to the Internet (or some other communications network) if the infotainment unit is unable to do so directly. Thus, the external hub device may be needed to accommodate peripheral devices and other functionality when a particular infotainment unit does not grant a high level of access and control (over wireless/Bluetooth communications, etc.) by default.

The software applications may include specially designed, custom In-Vehicle Applications (IVA) configured to be run on the infotainment unit of the vehicle access and management system. The IVA may direct the infotainment unit to access the modular hardware components of the vehicle access and management system, as well as the various ECUs and electronic system of the vehicles, and use any available Internet connection in order to provide connected-vehicle services.

There may also be a server-side application carrying out backend functions for the connected-vehicle service, and the infotainment unit may be able to use the Internet connection in order to connect to a gateway (e.g. network appliance(s) or server(s), or optionally a cloud-based gateway) hosting the server-side application in order to communicate data needed to carry out the connected-vehicle service.

The exact task or service that a vehicle access and management system performs may depend on the context, the hardware components, and the IVA used. Thus, the functionality and services provided by the vehicle access and management system may be altered by swapping out modular hardware components and running a different IVA. This provides a great deal of flexibility to the vehicle access and management system. The configuration of the vehicle access and management system can be changed in order to fit any need that arises. As new technologies arise, there may be new functionalities and new peripheral devices that are conceived and the modularity of the vehicle access and management systems disclosed herein advantageously allows for those possibilities. Accordingly, this disclosure does not list every possible functionality or component that may be associated with the vehicle access and management systems disclosed herein, and the example functionalities and peripheral devices provided are not intended to be limiting.

When paired with an available Internet connection (or another similar telecommunications network connection), the vehicle access and management system may be able to use that connection to provide connected-car services. Some non-limiting examples of such connected-car services include rental vehicle services, vehicle sharing services, management of taxi operations, DUI-prevention through ignition interlock devices, and so forth. This disclosure also discusses, in further detail, example embodiments of vehicle access and management systems specifically configured for these connected-car services.

It should be noted that this disclosure uses the terms CAN Network and CAN Bus interchangeably, in order to refer to a specific communication system for transferring data between various electrical components in modern vehicles. However, the vehicle access and management systems described may be utilized with any kind of communication system present in any type of vehicle, and are not restricted to communication systems associated with the CAN protocol.

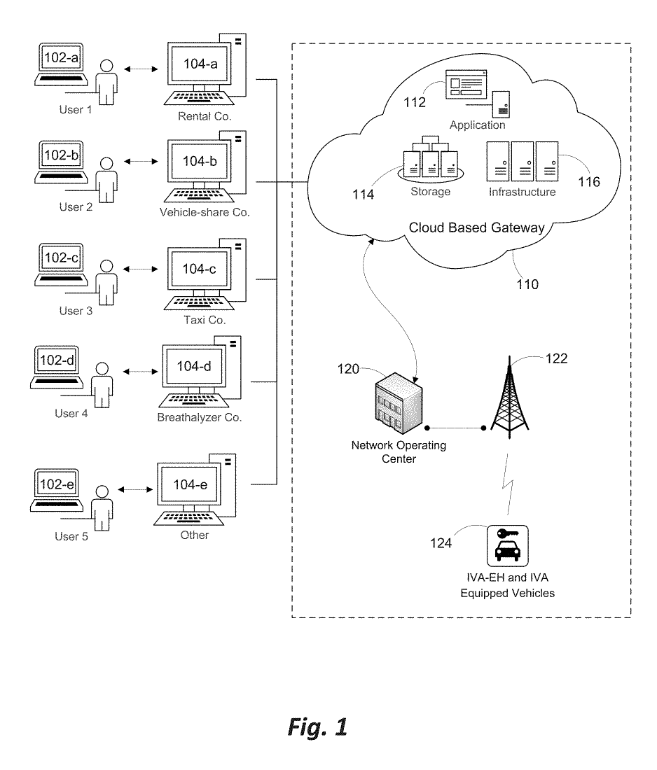

### Vehicle Access and Management System—(FIGS. 1-13)

FIG. 1 is a system diagram that illustrates an environment for implementing one embodiment of the vehicle access and management system. More specifically, the figure is directed to an environment that can be used for providing connected-car services through a vehicle access and management system, and it provides an overview of the dataflow between the vehicle and a commercial entity or end-user.

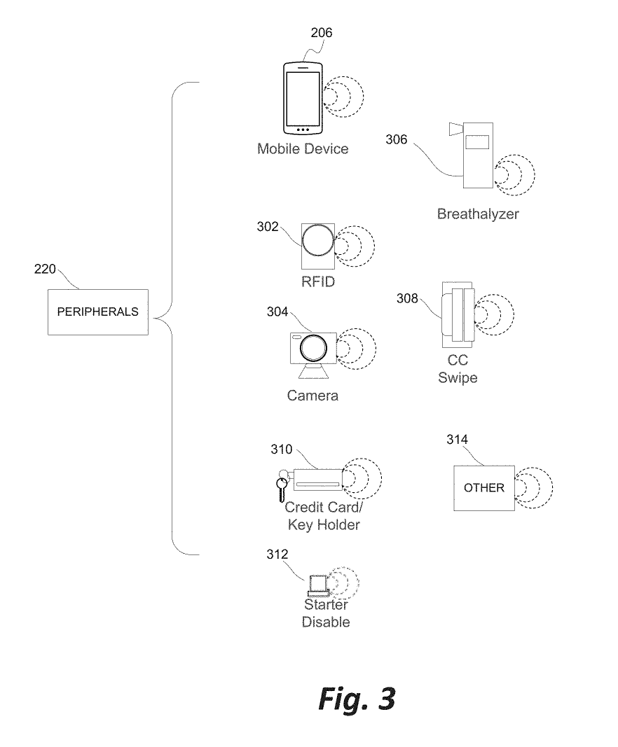

Vehicle 124 may be a vehicle that is equipped with an in-vehicle infotainment unit capable of running a custom IVA, pairing with peripheral devices, and having access to one or more telecommunications networks. The in-vehicle infotainment unit may be configured to access various wireless data connections or communications networks, such as cellular, Bluetooth, GPS, RFID, wi-fi and so forth. In some embodiments, the infotainment unit may be able to use these connections to access the Internet and connect to a gateway (e.g. network appliance(s) or server(s), or optionally a cloud-based gateway). In some embodiments, the infotainment unit may be to use the wireless data connection of a smart phone or mobile device that is paired with the infotainment unit. More information about peripherals is provided in regards to FIG. 3.

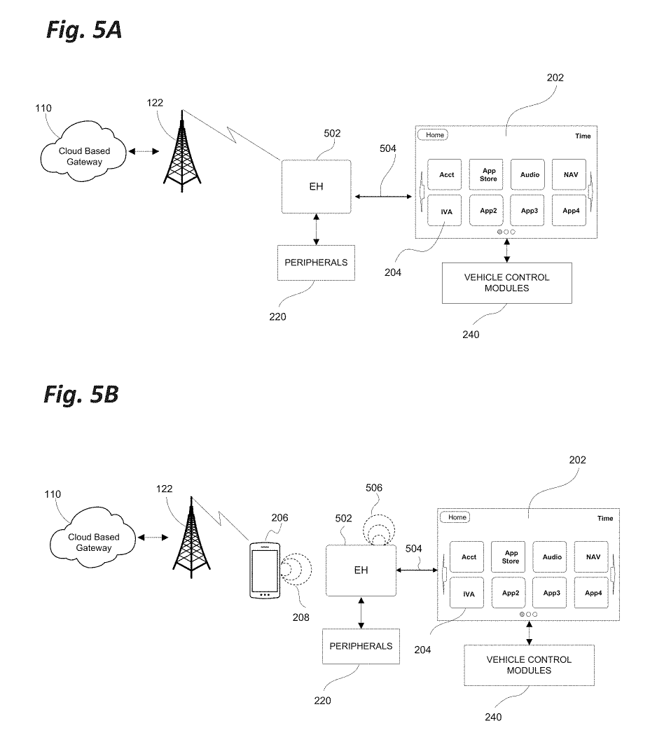

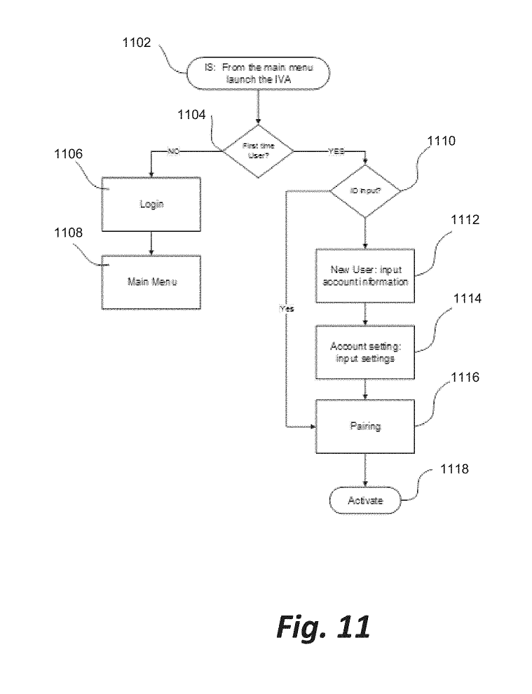

Some infotainment systems may lack the necessary connections or protocols for peripheral devices, or may lack flexibility in the kinds of peripheral devices they can connect to. If the infotainment unit cannot pair with a specific peripheral device or access the desired communication network, an external hub device may additionally be used with the infotainment unit running the custom IVA in order to overcome those deficiencies. Among other things, the external hub may be used to bridge the infotainment unit with any peripheral devices or desired communications networks. For example, the infotainment unit in its default configuration may not have Internet access and may not have been designed for pairing with a smart phone, so there is no wireless or Bluetooth capability or port for connecting a smart phone. The main function of this example infotainment unit may be to play the radio, satellite radio, and other audio. In this scenario, the external hub may be paired with that infotainment unit. The external hub may have wireless or Bluetooth capability, or a physical port, for connecting to a smart phone having Internet access as well as other useful peripheral devices. Through the external hub, the infotainment unit gains access to various peripheral devices and their functionality. More information about the external hub is provided in FIGS. 5A and 5B all the way up to FIG. 11. The environment illustrated in the figure is applicable to vehicle access and management systems that involve an external hub paired with an infotainment unit or the infotainment unit by itself.

The infotainment unit of Vehicle 124 may communicate with Communications Carrier 122, which may be a cellular carrier or telecommunications tower that transmits and receives wireless communications signals and can also communicate with Network Operating Center 120. In other embodiments, Network Operating Center 120 may be operating Communications Carrier 122, or Communications Carrier 122 may not exist and communication is with directly with the Network operating Center 120. Through Communications Carrier 122 and Network Operating Center 120, the infotainment unit may be able to connect to a gateway (e.g. network appliance(s) or server(s), or optionally a cloud-based gateway). In some embodiments, this connection is via the Internet.

In the figure shown, the gateway is Cloud Based Gateway 110 and includes Application 112, Storage 114, and Infrastructure 116. However, the vehicle access and management system may be implemented using dedicated or cloud based servers. Infrastructure 116 may be the remote computing devices or servers which run Application 112, the backend of the vehicle access and management system. Relevant data, such as user profiles and preferences, may be stored in databases on Storage 114. Cloud Based Gateway 110 may be connected to Network Operating Center 120, such as via the Internet. What matters is that Cloud Based Gateway 110 may somehow communicate with the infotainment unit of Vehicle 124, since Cloud Based Gateway 110 may be configured to serve as the backend for the connected-car services.

Cloud Based Gateway 110 may be configured to carry out workflows on the behalf of one, or more than one, company that is offering a connected-car service. In the figure shown, Cloud Based Gate 110 may be in communication with Servers 104-a, 104-b, 104-c, 104-d, and 104-e. These servers may be respectively associated with a car rental company, a vehicle-sharing company, a taxi company, a breathalyzer company, or any other entity. For example, a user of a connected-car service, such as a vehicle operator, owner, passenger, or some third-party, may register, update, or access their user or vehicle profile through the server. In the figure, User 102-a, 102-b, 102-c, 102-d, and 102-e are shown accessing the various servers. The specific functions of Servers 104 may depend on the specific connected-car services being provided to User 102.

As a contextual example, User 102-a may access Server 104-a hosting a car rental company's online reservation system to view available vehicles, rental rates and reserve a vehicle. The User 102-a may select a vehicle type, date and time they want to access a specific vehicle and confirm the reservation. Upon confirming the reservation, the rental car company will send the reservation data (vehicle ID, customer ID, start/end date, start/end time, user specific vehicle data—seat settings, preset radio channels) to Vehicle 124 via Cloud Based Gateway 110. Vehicle 124 may store and manage all of this data pre and post-reservation, uploading the reservation data when the reservation is terminated. After booking the reservation electronically via the vehicle access and management system, User 102-a may be able to walk up to Vehicle 124, obtain access to it, and then drive away.

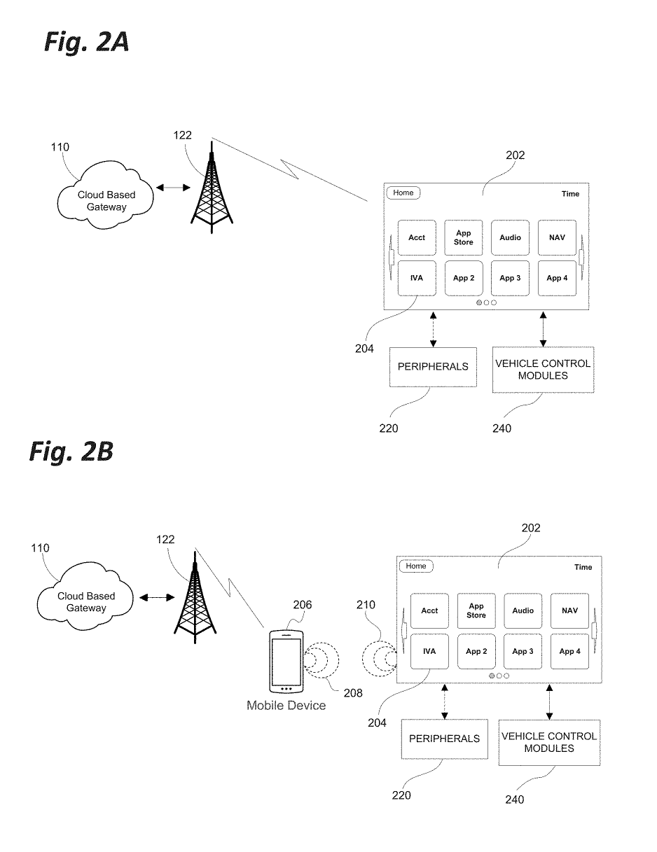

FIG. 2A is a system diagram that illustrates one embodiment of a vehicle access and management system. More specifically, the figure depicts some of the aspects of the vehicle access and management system that a vehicle operator or passenger would be exposed to when an external hub device is not used.

In the figure, Cloud Based Gateway 110 communicates with the In-Vehicle Infotainment Unit 202 via Communications Carrier 122. This communication can be performed using any kind of wireless data connection, such as a cellular connection, satellite connection, a Wi-Fi connection, and so forth. Examples of more specific wireless technologies that may be used by vehicles and their infotainment units may include cellular Wi-Fi, Bluetooth, Zig-Bee, Lora, and so forth. As new wireless technologies are developed, those may be used as well. In some embodiments, the Infotainment Unit 202 or the vehicle may have an embedded cellular modem that can be utilized by IVA 204 to connect to a wireless network and access Cloud Based Gateway 110 through Communications Carrier 122.

The Infotainment Unit 202 may be a component of the vehicle, and it is abstractly represented in the figure by a depiction of a typical user interface that would be presented on an infotainment unit to the driver of a car. The Infotainment Unit 202 may be able to install or run custom applications or software, such as IVA 204. Infotainment Unit 202 may also be able to be connected to a variety of Peripherals 220. More information about these peripheral devices is provided in regards to FIG. 3. Infotainment Unit 202 may also be able to communicate with Vehicle Control Modules 240, which include the various ECUs and electronic systems/subsystems present in the vehicle.

In the figure, IVA 204 is abstractly represented as a button on the user interface of the Infotainment Unit 202. A vehicle operator, owner, or passenger may be able to press this button in order to run IVA 204 for managing, interfacing, or accessing the vehicle access and management system. IVA 204 may be a third-party application developed for the Infotainment Unit 202. In some cases, IVA 204 is not factory-installed in Infotainment Unit 202 and may be downloaded from the third-party.

IVA 204 may be used to provide a variety of connected vehicle services by leveraging an infotainment unit's existing capability to access vehicle electronic systems, connect to peripherals, and/or connect to communications networks. Different IVAs may be used in different contexts, and an IVA may be specifically tailored to provide a set of connected vehicle services and functionality appropriate for a given context. For some contexts, the IVA may utilize certain sets of peripheral devices in order to provide the desired connected vehicle services and functionality. For example, IVA 204 may be configured for the purpose of DUI-prevention using ignition interlock devices or breathalyzers. Infotainment Unit 202 may be paired with a breathalyzer device. IVA 204 may require a driver to blow into the breathalyzer device and allow the car to start only if the driver is under the legal limit for alcohol.

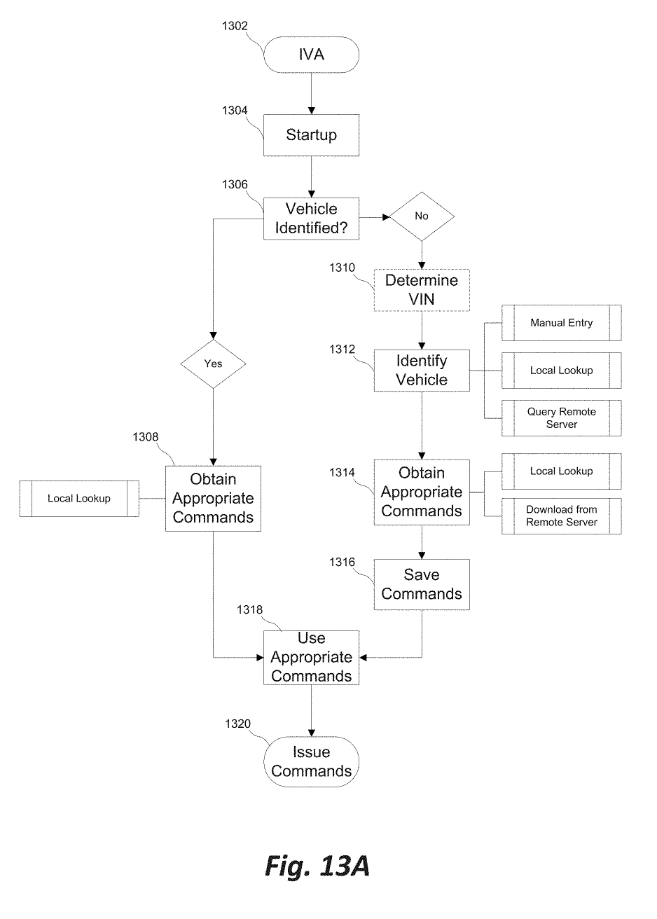

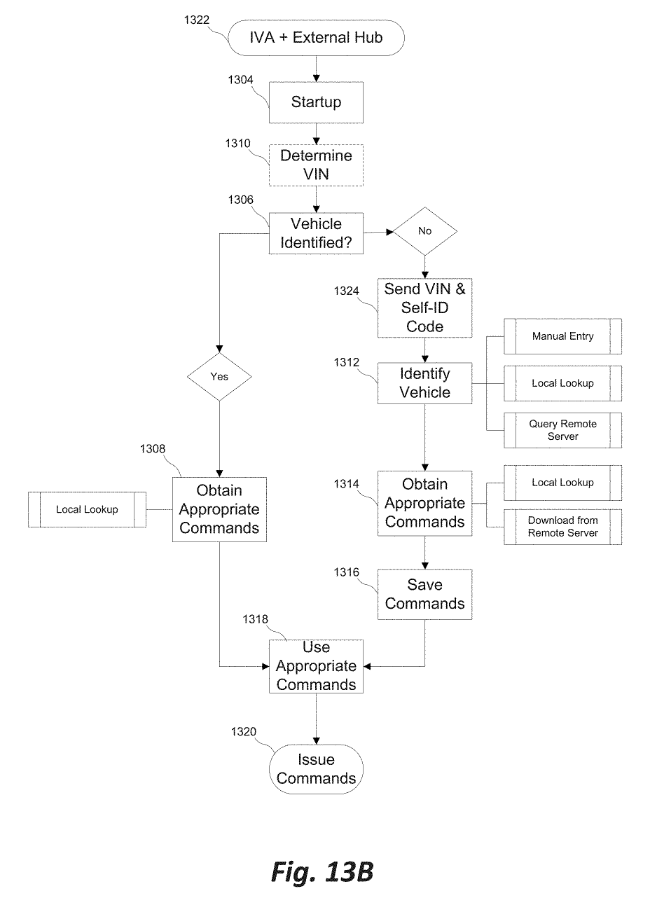

Thus, IVA 204 may be configured to access and control various aspects of the vehicle. It should be noted that this functionality of the IVA 204 is in some cases supported by, or supplanted with, the use of an external hub device, which is described in further detail in FIG. 5A. In some embodiments, the IVA 204 may be broadcasting digital commands to, or receiving messages from, the various systems of the vehicle over the CAN Bus network. Some of these digital commands may be unique to the year, make, and model of the vehicle. Therefore, to control the various electro-mechanical functions within a vehicle, the IVA 204 or external hub must be able to determine the identity of the vehicle in order to utilize the right command codes. In some embodiments, a user of the IVA 204 may have to manually configure the IVA 204 by inputting the vehicle's year, make, and model. In other embodiments, IVA 204 and/or the external hub may automatically determine the year, make, and model of the vehicle, such as by monitoring transmissions over the CAN Bus and identifying the vehicle based on the transmission protocols used. These various processes are described in more detail in FIG. 13.

However, once that is properly determined, the IVA 204 may exercise a high degree of access and control to all aspects and components of the vehicle. IVA 204 may be able to send commands to various electronic systems of a vehicle, such as arm/disarm alarm, lock/unlock doors, control trunk release and horns, and so forth. In some vehicles, IVA 204 may even be able to upload user seat settings, upload user radio channel/settings, remove call log and paired devices, etc.

The IVA 204 and/or external hub may also be able to collect and store a variety of data, which may be provided to the driver, a user of the vehicle access and management system, or a third-party. For example, IVA 204 may be able to access vehicle data, with common examples including odometer reading, vehicle speed, engine RPM, freeze frame log, fuel level, ECU firmware version, and so forth. IVA 204 may collect data about car diagnostics or critical diagnostic information, such as active Diagnostic Trouble Codes (DTC) revealing whether the car has a low battery or engine coolant, whether the car has been towed or tampered with, whether maintenance has been performed, and miles driven since last DTC. IVA 204 may collect trip logs, which may include start/end locations, date/time, miles driven, duration of trip, max speed, average speed, max acceleration, fuel level, etc., as well as whether extreme acceleration or braking occurred, whether the engine was ever turned on without proper access (unauthorized user), the maximum speed, and whether the vehicle has left a certain geographical area.

In some embodiments, IVA 204 may have full access of a vehicle's embedded wireless modem, GPS, sensors and control modules even while the vehicle is off. For example, IVA 204 may be designed to function while drawing an extremely low amount of power from the vehicle battery when the vehicle is turned off. Thus, in some embodiments, the IVA 204 may be configured for power management. The IVA 204 may continue to be powered off of the car battery while managing the power draw so that the battery does not run down. For example, after 48 hours if the IVA 204 does not perform any activity and it is not aware of an upcoming transmission or task (e.g., an upcoming reservation for a car rental), then it may shut down and go into receive-only mode. After 72 hours, the IVA 204 may perform a hard shut down. The cellular modem may be shut off and a signal may be sent to the backend servers that informs of the IVA 204 entering power save mode. In power save mode, the IVA 204 may start up every hour and check in with the backend servers every hour. If information is to be sent to IVA 204 in the interim (such as reservations being made), that information may be added to a queue and retrieved by the IVA 204 when it checks in with the backend.

However, there may also be scenarios in which the IVA 204 may have full access of a vehicle's embedded wireless modem, GPS, sensors and control modules while the vehicle is in ON (e.g., the key is in the auxiliary position or the engine is running), but not the same level of access if the vehicle is turned off. More specifically, once the vehicle is turned off, the vehicle systems and the onboard cellular modem may also be shut off. In order to utilize the vehicle access and management system, an external hub device can be used in this scenario to perform all the functionality of the IVA 204 when the vehicle is off. This external hub device would also be able to perform the power management functionality as previously described. Further details about the external hub device are provided in regards to FIGS. 5A and 5B.

FIG. 2B is a system diagram that illustrates one embodiment of a vehicle access and management system.

FIG. 2B is very similar to FIG. 2A, with the main difference being that Infotainment Unit 202 may not have a direct wireless connection to Cloud Based Gateway 110 via Communications Carrier 122. In the illustrated embodiment, the Infotainment Unit 202 may be able to connect to, or be paired with, a Mobile Device 206 in order to communicate with Mobile Device 206. Mobile Device 206 can be any portable electronic device having a wireless data connection for connecting to Cloud Based Gateway 110, such as a smart phone, mobile phone, laptop, tablet, and so forth. Infotainment Unit 202 may connect to Mobile Device 206 in any manner. In some embodiments, this may be done using a wireless data connection such as Bluetooth, RFID, Infrared, Wi-fi, or any other NFC technology. In some of such embodiments, IVA 204 and Infotainment Unit 202 may be paired to a user's smart phone via Bluetooth in order to access a wireless network. In the figure, the Infotainment Unit 202 has a Wireless Transceiver 210 that communicates wirelessly with the Wireless Transceiver 208 of the Mobile Device 206.

However, Infotainment Unit 202 and Mobile Device 206 do not need to communicate wirelessly. In other embodiments, Infotainment Unit 202 may be physically coupled or connected to Mobile Device 206, using a data cable or an access port within the vehicle. For example, there may be a USB port located somewhere within the vehicle that allows the Infotainment Unit 202 to be connected to Mobile Device 206 through a data cable.

FIG. 3 is a diagram that illustrates some example peripheral devices that may be used with the vehicle access and management system.

Examples of Peripherals 220 include the Mobile Device 206 of the user, a RFID/NFC Reader 302, a Camera 304 such as a Dash Mount Camera, Video Camera, or Photo Camera, a Breathalyzer 306, a Credit Card Swipe 308, Credit Card/Key Holder 310 or a key fob, Starter Disable 312, or any Other Peripheral 314 that may be useful in a vehicle access and management system. Peripherals and even specific combinations of peripherals may be utilized in different ways depending on the context, the needs of the user, and the configuration of the IVA. In some embodiments, the example peripherals provided or their functionality may be embodied in one device. For example, Mobile Device 206 may be used both for its RFID/NFC reading capability and its integrated camera. The various Peripherals 220 may interface with components of the vehicle access and management system through a wireless connection or a hardwired connection.

As a more specific example of peripheral usage, RFID/NFC Reader 302 may enable a user to gain access to a specific vehicle by presenting a RFID card to RFID/NFC Reader 302. This may be useful in the context of car rental services. The user may reserve a car electronically and then gain access to the car via the RFID/NFC Reader 302 during the rental period, which would start the reservation. The IVA or external hub would send a door unlock command over the vehicle bus to unlock the doors, as well as an enable command to the starter interrupt allowing the vehicle to start. At the end of the rental period, the IVA or external hub may end the reservation by sending a door lock command over the vehicle bus to lock the doors and send a starter disable command to the starter interrupt to disable the starter circuit.

Other peripherals may also be valuable in this specific car rental context, either for information processing or granting the user access to an asset. For example, Credit Card Swipe 308 may be used in order to process rental fees and allow the user to pay inside the vehicle. Additionally, Credit Card/Key Holder 310 may be used to make sure credit cards or keys or returned to the vehicle. In some use cases, credit cards (such as a gas card) and keys to the vehicle may be left within the unused vehicle and can be obtained by the user once they successfully start the reservation and gain entry to the car. The user would remove the key during the rental period and return it to the Key Holder at the end of the rental. The user would remove the credit card when fueling the vehicle and return it to the Credit Card Holder when that task is complete. The Credit Card/Key Holder may have sensors that enable to the determination of whether the credit card and/or key are present. The user may be requested to return those items to the vehicle when the reservation ends.

In particular, Mobile Device 206 may be configured to run a mobile application that may further comprise user interfaces and functionality for communication, over the wireless network/Internet, with the IVA/external hub and/or the Cloud Based Gateway 110. For example, the mobile application may be able to communicate with a rental car service or car share service (e.g. their servers) during the rental period. As a further example in the rental car context, these user interfaces may allow a user to terminate a reservation, extend a reservation, purchase gas plans or insurance, add new drivers, change reservations, or contact a customer service representative. In some embodiments, the user may be able to perform these functions through the IVA. However, by putting this functionality into a mobile application for Mobile Device 206, it allows the user to perform the functions outside of the vehicle, it reduces custom hardware and software requirements by leveraging existing customer hardware, and it may save on wireless data costs paid for by the rental/carshare service.

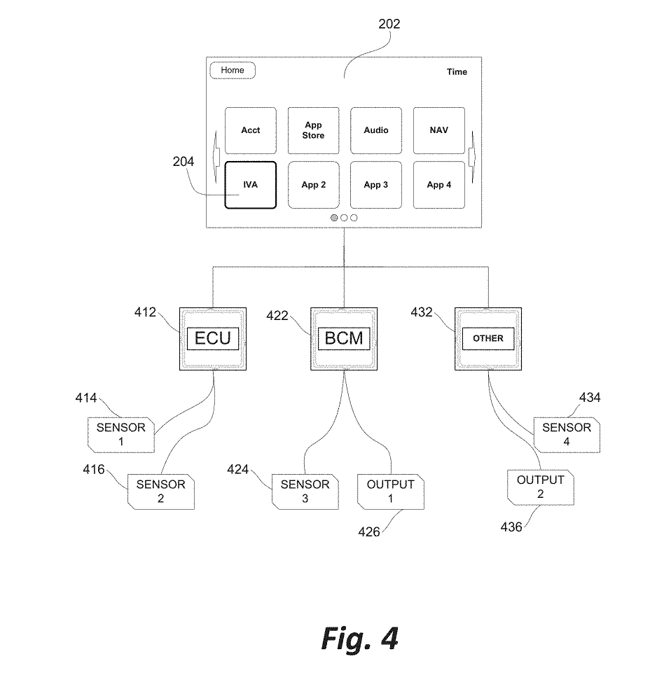

FIG. 4 is a system diagram that illustrates some examples of electronic systems of a vehicle that may be accessed with one embodiment of the vehicle access and management system.

Infotainment Unit 202 may be connected via the CAN network to various in-vehicle computer modules or electronic systems. As previously mentioned, some non-limiting examples of ECUs found in automobiles include the Electronic/Engine Control Module (ECM), the Powertrain Control Module (PCM), the Transmission Control Module (TCM), the Brake Control Module (BCM or EBCM), the Central Control Module (CCM), the Central Timing Module (CTM), the General Electronic Module (GEM), the Body Control Module (BCM), the Suspension Control Module (SCM), the Engine Control Unit, the Door Control Unit (DCU), the Electric Power Steering Control Unit (PSCU), the Human-Machine Interface (HMI), the Seat Control Unit, the Speed Control Unit (SCU), the Telematic Control Unit (TCU), the Telemetry Unit (TU), and the Battery Management System.

In the figure, Infotainment Unit 202 is connected to ECU 412, which may handle readings from Sensor 414 and Sensor 416. Infotainment Unit 202 is also connected to BCM 422, which may handle readings from Sensor 424 or provide Output 426. Infotainment Unit 202 is also connected to Other 432, which may be any other in-vehicle computer module and have Sensor 434 and Output 436. These various sensors and outputs are abstractions, and in reality may be any kind of instrumentation, sensor, output, or vehicle component connected to a given vehicle computer module. For example, a sensor may inform of the temperature of the engine, the speed of the car, the status of the door, and so forth, while an example of an output could be starting the engine or unlocking the doors to the car.

Since the Infotainment Unit 202 may be connected to various vehicle electronic systems, as well as various paired peripheral devices, through a IVA the Infotainment Unit 202 may have access to all the information accessible to, and functionality associated with, smart phones, sensors, cameras, on-board diagnostics, automated driver assistance systems, and so forth.

FIG. 5A is a system diagram that illustrates one embodiment of a vehicle access and management system. FIG. 5A illustrates an embodiment that is similar to the embodiment shown in FIG. 2A. The main difference is that Infotainment Unit 202 is being used with External Hub 502.

In some cases, the Infotainment Unit 202 may be deficient in connecting to peripherals and/or communications networks for accessing Cloud Based Gateway 110, although Infotainment Unit 202 may still retain access to Vehicle Control Modules 240. External Hub 502 may be used to cure these technological deficiencies in Infotainment Unit 202. For example, External Hub 502 may be connected to Infotainment Unit 202 using Connection 504. External Hub 502 may also be connected to Peripherals 220, which allows Peripherals 220 to be connected to Infotainment Unit 202 through External Hub 502 if Peripherals 220 are unable to be paired directly to Infotainment Unit 202. External Hub 502 may be able to communicate wirelessly with Communications Carrier 122 to access Cloud Based Gateway 110, such as through the Internet. With External Hub 502, the Infotainment Unit 202 may also be able to access Cloud Based Gateway 110. Thus, External Hub 502 may be equipped to use various wireless data connections or communications networks, such as cellular, Bluetooth, GPS, RFID, wi-fi, and so forth. External Hub 502 can be used to provide this connectivity to Infotainment Unit 202 when Infotainment Unit 202 does not have a high level of access to that connectivity by default.

In particular, this scenario may arise when a vehicle is not equipped with a cellular modem and/or Bluetooth. Another possible scenario is if the IVA 204 does not have access to the cellular modem and/or Bluetooth when the vehicle is turned off (e.g., the engine is not running and the key is not in the AUX position). When the vehicle is turned off, the Infotainment Unit 202 typically powers down which eliminates access to vehicle information, cellular modem (if equipped), GPS and Bluetooth. In the future, third-party IVAs may be able to run in the background when the vehicle is turned off and control in-vehicle components, such as the wireless modem, Bluetooth, ECU, and so forth. However, External Hub 502 may be utilized today to deal with any technological shortcomings in current vehicles. The External Hub 502 may be able to perform the roles of the IVA 204 and process tasks that the IVA 204 either does not have access to at all times or is not available (not equipped). External Hub 502 may be able to manage the wireless connectivity (cellular, Bluetooth, etc.) and any external Peripherals 220.

Connection 504 may be any available means of transmitting data between the External Hub 502 and Infotainment Unit 202. In some embodiments, Infotainment Unit 202 may be physically connected to External Hub 502, such as through a serial communication data line or USB cable.

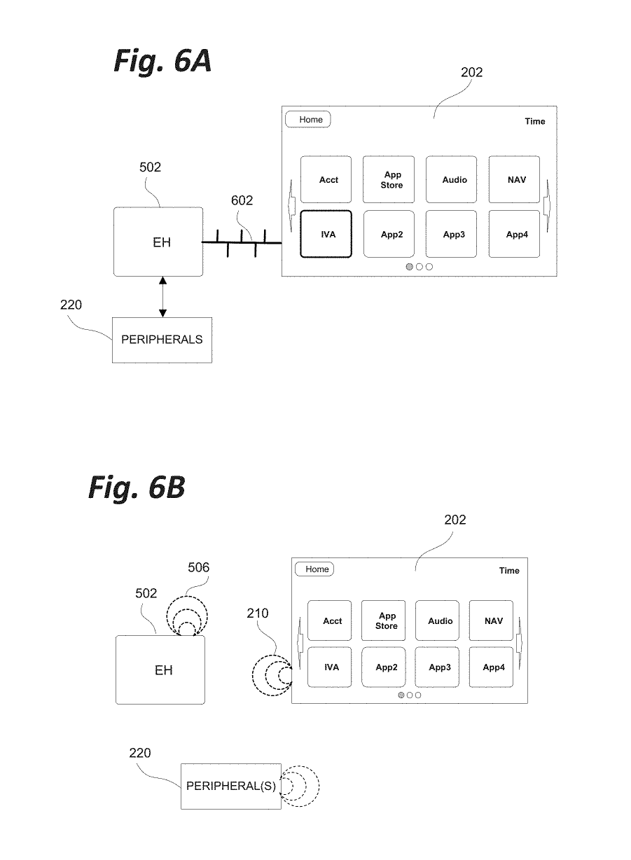

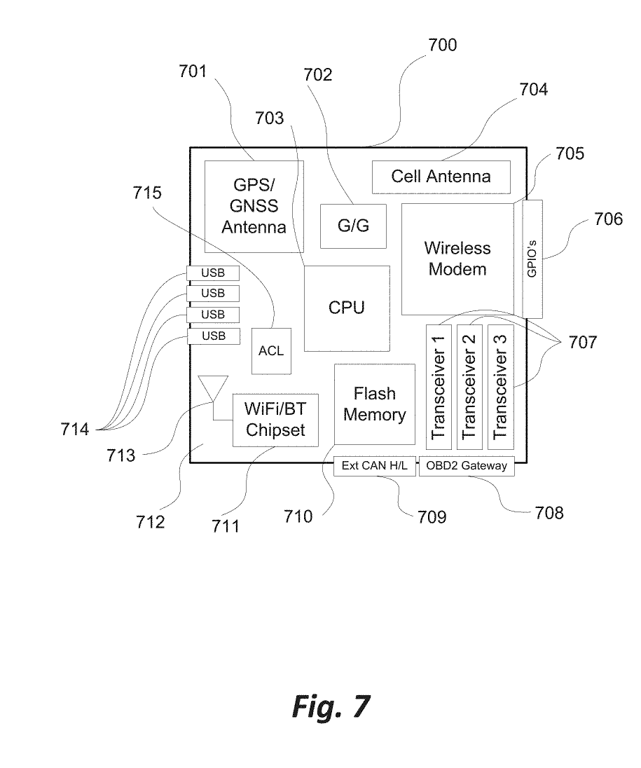

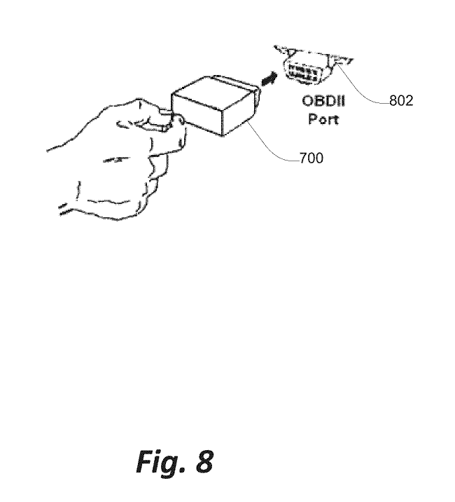

In some embodiments, Infotainment Unit 202 may communicate with External Hub 502 over the CAN Network. This is shown in more detail in FIG. 6A. External Hub 502 may be configured to access the CAN Network in various ways, which are described in further detail in FIGS. 7 and 8. One particular way is to plug the External Hub 502 into the vehicle's OBD2 diagnostic port, which is part of the CAN Network. Communication between Infotainment Unit 202 and External Hub 502 over the CAN Network may be performed with a custom, proprietary protocol in order to transmit information between the various components of the vehicle access and management system.

In other embodiments, Infotainment Unit 202 may have a wireless transceiver and be able to communicate with External Hub 502 wirelessly, such as using Bluetooth, RFID, Infrared, Wi-fi, or some other NFC technology, even if for some reason Infotainment Unit 202 cannot pair with Peripherals 220. In other embodiments, Infotainment Unit 202 may connect directly to Peripherals 220 and External Hub 502 may be utilized primarily for accessing Cloud Based Gateway 110. An example embodiment of a wireless connection between the Infotainment Unit 202 and the External Hub 502 is provided in FIG. 6B.

In some of such embodiments, the IVA 204 may have an open pairing feature to facilitate communications between the IVA 204 and External Hub 502. For example, if the External Hub 502 is unpaired, then plugging in the External Hub 502 into the OBD2 Port, plugging it into a direct or hardwired connection (e.g., a dedicated serial or USB port), or switching on its wireless transceiver may cause the device to enter into discovery mode. The device may be displayed on the user interface of IVA 204 under available devices, along with a pair icon next to the device. The user may select the pair icon to initiate the pairing process between External Hub 502 and IVA 204. In other embodiments, the IVA 204 and External Hub 502 may be configured to automatically perform the pairing process without needing user guidance, such as by having the IVA 204 actively search for External Hub 502 at repeated intervals or by having External Hub 502 broadcast to the IVA 204 when installed or switched on.

It is possible that in the future, most standalone IVAs will have full access and control of a vehicle's embedded modules, which may include a wireless modem, GPS, Bluetooth connection, door lock/unlock functionality, engine disable/enable functionality, and so forth. The IVA would be able to freely access the Internet and manage connected-vehicle services on its own. External Hub 502 would no longer be needed in this instance, which would simplify the solution as illustrated in FIG. 2A and, in some cases, reduce or eliminate the costs associated with the External Hub 502.

FIG. 5B is a system diagram that illustrates one embodiment of a vehicle access and management system. FIG. 5B illustrates an embodiment that is similar to the embodiment shown in FIG. 5A. The main difference is that External Hub 502 now does not have access to Cloud Based Gateway 110.

However, External Hub 502 may have a Wireless Transceiver 506 capable of communicating with the Wireless Transceiver 208 in Mobile Device 206. Thus, External Hub 502 may utilize the Mobile Device 206 for communicating with Cloud Based Gateway 110. Infotainment Unit 202 and IVA 204 would then have access to the Cloud Based Gateway 110 as well, with External Hub 502 bridging the Internet access capabilities of Mobile Device 206 with Infotainment Unit 202. In some embodiments, the External Hub 502 is paired to a user's smart phone or cell phone via Bluetooth. Through the phone, the External Hub 502 is able to communicate with Cloud Based Gateway 110 and manage data associated with connected-vehicle services, such as rental data for car rentals.

FIG. 6A is a system diagram that illustrates the connection methods of one embodiment of External Hub 502.

As previously mentioned, Connection 602 between External Hub 502 and Infotainment Unit 202 may be over some sort of serial bus, such the CAN bus. Communication between Infotainment Unit 202 and External Hub 502 over the CAN Network may be performed with a custom, proprietary protocol in order to transmit information between the various components of the vehicle access and management system. This protocol may be different from those typically used by the Infotainment Unit 202 to manage, access, or interface with the various sensors and electronics present in the vehicle. Once the External Hub 502 is connected to the CAN Network, it may establish communication with the IVA of Infotainment Unit 202 during the configuration process. For example, plugging External Hub 502 into the OBD2 diagnostic port may automatically begin the configuration process.

The External Hub 502 may also be connected to Peripherals 220 via a direct wire or serial bus. Some examples of common Peripherals 220 that may be connected in this way include a RFID/NFC Reader, a Credit Card Reader or Swipe, a Video or Picture Camera, a Credit Card/Key Holder, and a Breathalyzer. Additional examples of Peripherals 220 may be seen in regards to FIG. 3. In some embodiments, installing Peripherals 220 in the vehicle may involve mounting the peripheral somewhere within the car (e.g., the dashboard), and then running a connecting wire from the peripheral to the External Hub 502.

FIG. 6B is a system diagram that illustrates the connection methods of one embodiment of an external hub. It is very similar to FIG. 6A, except that FIG. 6B illustrates Infotainment Unit 202 being wirelessly connected to both Peripherals 220 and External Hub 502 using Wireless Transceiver 210.

In various embodiments, Infotainment Unit 202 may be wirelessly connected to either External Hub 502 or Peripherals 220, or both, depending on the available connections. For example, Infotainment Unit 202 may be able to communicate wirelessly with External Hub 502 over Bluetooth or Wi-Fi, while at the same time Infotainment Unit 202 has a USB port that Peripherals 220 plugs into.

In the scenario for which the External Hub 502 is wireless connected to Peripherals 220 (such as through Bluetooth), the connection can be dedicated or a mesh network. Each peripheral device would be paired with External Hub 502 through the IVA during the initial setup process. Some examples of common Peripherals 220 which may be connected in this manner include a RFID/NFC Reader, a Credit Card Reader or Swipe, Video or Picture Camera, a Credit Card/Key Holder, and a Breathalyzer. Additional examples of Peripherals 220 may be seen in FIG. 3.

FIG. 7 is a system diagram that illustrates the components of one embodiment of an external hub.

In some embodiments, the External Hub 700 may comprise various electrical and hardware components embedded in a printed circuit board, such as PCB 712. As shown in the figure, in some embodiments the External Hub 700 may comprise one or more processors (including, but not limited to, special purpose processors or general processors) that control the External Hub 700, such as CPU 703. The processor(s) may allow the execution of executable computer code capable of instructing the processor to control various aspects of the External Hub 700 and any connected peripherals. It also may allow the execution of computer code configured to interact with other devices in a vehicle, or on the Internet (such as a user with a mobile device, or a server(s) on the Internet).

In some embodiments, the External Hub 700 may also include one or more storage devices, such as a magnetic disk, memory, cache, or any combination of storage devices. These storage devices may store instructions and/or data required for the operation of the External Hub 700. In the figure shown, External Hub 700 comprises Flash Memory 710.

In some embodiments, External Hub 700 may comprise, or be connected to, a GPS/GNSS Antenna 701 and a GPS/GLONASS Chipset 702 which serve as a GPS tracking sub-system that may be either internal or external to External Hub 700. This GPS tracking sub-system may be configured to track, using longitude and latitude provided by GPS satellites, the current location of External Hub 700 and the attached vehicle. This information may be queried from the GPS sub-system and accessed by External Hub 700.

In some embodiments, External Hub 700 may comprise wireless networking components, such as a Cellular Antenna 704 and/or a Wireless Modem 705. For example, a PCB-mounted wireless (cellular) modem with internal antenna (or any type of wireless networking, such as satellite, Wi-Fi, or ad hoc networking) may provide External Hub 700 (and also any attached infotainment unit) access to the Internet. Through these wireless networking components, the External Hub 700 may be connected to remote server(s) such as the previously-mentioned Cloud Based Gateway 110, which may contain a vehicle database, a customer registration mobile device interface, a billing system, and any other applications, software, or interfaces that can be used to manage connected-vehicle services.

In some embodiments, External Hub 700 may have GPIOs, such as GPIOs 706, which may be generic pins that may be used for custom input and output purposes. In some embodiments, the GPIO pins may be controlled and accessed by the External Hub 700 for interfacing with certain peripheral devices that may not have more-common connectors such as USB.

External Hub 700 may have Transceivers 707, which may be a component configured for both the transmission and receiving of data signals. In some embodiments, Transceivers 707 may be bus transceivers or common vehicle transceivers, such as CAN Bus Transceivers. In that scenario, Transceivers 707 may serve as the interface between the physical bus, and provide External Hub 700 with the capability to transmit and receive data with the CAN Network without interfering with other devices on the CAN Network.

For connecting to the Infotainment Unit of a vehicle, External Hub 700 may utilize various physical connections. In some embodiments, External Hub 700 may have a vehicle gateway I/O that is configured to interface with a port in the vehicle. In some embodiments, External Hub 700 has an OBD2 Gateway 708 configured to interface with a vehicle's OBD2 Port, which is the vehicle's diagnostics connector for interfacing with diagnostic tools. Thus, External Hub 700 may be connected to an on-board diagnostic unit in the vehicle. An example of such an External Hub 700 and a corresponding OBD2 Port is shown in more detail in FIG. 8.

In some embodiments, the External Hub 700 may have an External CAN H/L 709 for connecting to an external CAN bus harness. Once connected, the External Hub 700 may be able to issue and receive data over the CAN Network. For example, in some embodiments the External Hub 700 may issue special commands via this connection to the CAN bus in order to lock or unlock a vehicle door.

Thus, the External Hub 700 may be able to access the various electronic subsystems of a vehicle over the CAN bus, either through the OBD2 Gateway 708 or the External CAN H/L 709. Accessing the various electronic subsystems through the CAN bus is more convenient than running wires from the External Hub 700 directly to the various hardware components, sensors, and instrumentation in the vehicle, and allows the External Hub 700 to be quickly installed and setup within a vehicle. Over the CAN bus, the External Hub 700 may issue commands to enable/disable the starter, lock/unlock the door, flash lights, open/close windows, open/close sunroof, sound horn, pop trunk, etc.

In some embodiments, the External Hub 700 may have a Wi-Fi/Bluetooth Chipset 711 and a Wi-Fi/Bluetooth Antenna 713. In other embodiments, some other kind of wireless transmission technology may be used, such as for example, RFID (radio-frequency identification) and NFC (near field communication), which are methods of querying information from, and communicating with a radio identification device within a set proximity. While RFID usually operates in one direction, NFC is typically used by smartphones for two way RFID type communication. By connecting to Wi-Fi/Bluetooth/RFID/NFC enabled peripheral device, the External Hub 700 may communicate with that device to obtain identification (or other) information and transmit/receive any other relevant information for connected-car services. For example, a user may pair their smart phone to External Hub 700 over Bluetooth and use it to query a vehicle identifier associated with the vehicle, or provide a user identifier to External Hub 700. In some embodiments, the External Hub 700 may be able to connect to the Infotainment Unit through Wi-Fi/Bluetooth/RFID/NFC or any other wireless technology and be able to issue commands for the Infotainment Unit to send to the various electronic subsystems over the CAN bus, allowing the External Hub 700 access to the various electronic subsystems of the vehicle without needing to be installed through OBD2 Gateway 708 or External CAN H/L 709.

In some embodiments, the External Hub 700 may have one or more USB plugs 714. These USB plugs 714 may allow peripheral devices to be connected to the External Hub 700 directly, or may also allow the External Hub 700 to be directly connected to the Infotainment Unit. For example, the Infotainment Unit may have a corresponding USB plug on the front of the unit or somewhere within the vehicle's console that the External Hub 700 may be connected to in order to communicate with Infotainment Unit. Thus, the External Hub 700 may be able to access the CAN bus indirectly through the Infotainment Unit.

In some embodiments, External Hub 700 may also include, or be connected to, one or more Accelerometers 715. Accelerometers 715 can be used to measure vehicle acceleration and deceleration. They allow for evaluation of overall vehicle performance and response. This information can then be used to make adjustments to various vehicle subsystems as needed. They can also be used for modeling and detecting events. For example, given a certain abnormal deceleration detected, the External Hub 700 may determine that the accelerometer detected a vehicle accident. This can be recorded in the External Hub 700 and/or reported to the driver, the installer, the owner of the vehicle, and/or communicated to a remote server on the Internet. Other events that can be tracked via the accelerometer may include, but are not limited to, unsafe driving habits, vehicle speed, rollover or tilt (e.g. to detect towing) etc. As an example, this kind of reporting would be useful in the rental or car sharing industries for allowing a vehicle and/or a driver to be remotely monitored. The External Hub 700 may either calculate these types of events themselves using accelerometer data, or, in the case of more sophisticated accelerometers, be informed of (or have access to) the detected events by the accelerometer.

FIG. 8 illustrates one embodiment of an external hub being plugged into an OBD2 Port.

In particular, External Hub 700 is being shown being plugged into an OBD2 Port 802. As previously mentioned, OBD2 Port 802 is an example of a standard diagnostic connector which is found in modern automobiles that abide by the OBD-II Standard. This diagnostic connector is typically located within two feet of the steering wheel and is designed to be coupled to standard diagnostic tools or scanners, which also allows for the External Hub 700 to be coupled and quickly setup within an automobile. The ODB2 Port 802 may be used to query a wide range of information from the vehicle, including, but not limited to, vehicle information, such as a Vehicle Identification Number (VIN), Calibration Identification, Calibration Verification Number, Electronic Control Unit or Module (ECU and ECM) firmware version. It can also query engine performance measures, such as catalyst counters, the primary oxygen sensor, the evaporating system, EGR system, WT system, secondary air system, secondary oxygen sensor. Other query-able information includes vehicle speed, RPMs, odometer, and current fuel level, among others. Through the CAN bus, the ODB2 Port 802 may be connected to other devices that may provide functionality such as enable/disabling the starter, door lock/unlock, flash lights, open/close windows, open/close sunroof, sound horn, pop trunk, etc.

The installation method of External Hub 700 illustrated in the figure represents a significant reduction in labor and time compared to alternative devices for interfacing with vehicle subsystems.

For example, other devices configured for unlocking doors may involve running wires directly to the door lock and unlock motor. As another example, other devices for monitoring the mileage and fuel levels may involve running wires directly to certain sensors, such as the fuel gauge and Vehicle Speed Sense (VSS) output. The installer may then have to calibrate the device to current mileage and fuel levels. Calibrating the fuel level may involve turning on the engine with an empty fuel tank to sample the voltage output from the fuel sensor, and then filling up the gas tank to sample the voltage output when full. Calibrating the mileage may involve the installer driving the vehicle 2 to 3 times, for over a mile each time. The installer may then compare the miles driven (vehicle trip log) with the reported mileage from the device. If they were within 1% each trip, the device is considered calibrated.

These other devices may also involve a long test and registration process. After they are installed, the installer may have to call a remote technician and give them the serial number of the device to be tested. The technician will run several tests to verify connectivity to the network, GPS and send forward commands to the device, all in order to verify the device is installed and functioning. Alternatively, the installer may register the device through a website on a laptop or other desktop and perform similar tests. This may add up to 15 minutes per vehicle, and add considerable cost to a vehicle each time a device is moved from one car to another.

In comparison, the vehicle access and management systems disclosed herein significantly reduce install, setup, and calibration time. In embodiments for which the infotainment unit has a high degree of control over the vehicle subsystems, installation may involve downloading the appropriate IVA. In embodiments for which an External Hub 700 is needed, the External Hub 700 may be easily connected to the OBD2 Port 802. In either case, vehicle information may be requested over the CAN bus or a similar vehicle network which eliminates the need to calibrate, test, and register the vehicle access and management system.

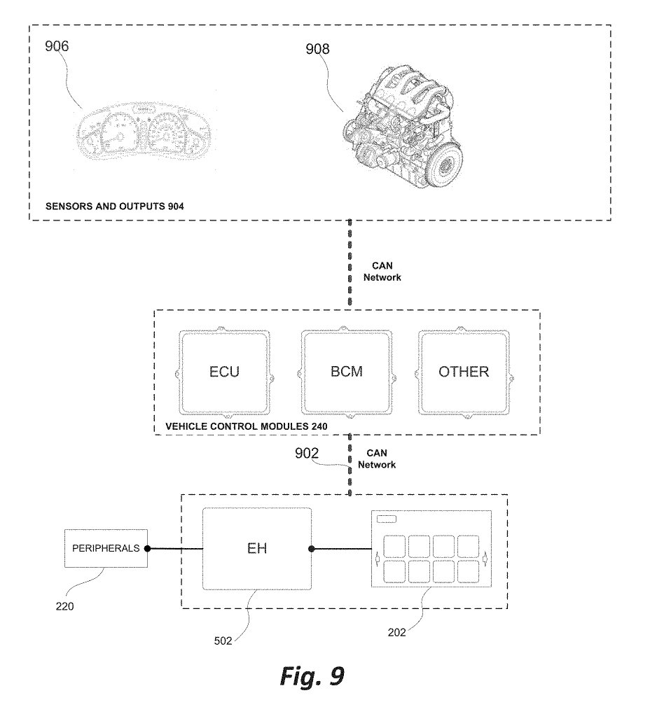

FIG. 9 is a system diagram that illustrates how example embodiments of the External Hub 502 and Infotainment Unit 202 are used in conjunction with various computers within a vehicle.

Peripherals 220 are connected to External Hub 502, which is connected to the Infotainment Unit 202 of the vehicle through one of the various ways previously described. External Hub 502 and Infotainment Unit 202 may be connected to CAN Network 902. In some embodiments, External Hub 502 communicates with Infotainment Unit 202 through CAN Network 902. An IVA running on Infotainment Unit 202 access and manage the various Vehicle Control Modules 240, which includes the Electronic Control Unit—ECU, Body Control Module—BCM, and any other In-Vehicle Control module. These units are responsible for monitoring and controlling various electronic accessories within the vehicle. The control units communicate with other on-board computers via the vehicle's bus, and its main application is controlling load drivers—actuating relays that in turn perform actions in the vehicle such as locking the doors or dimming the salon overhead lamp.

Through these Vehicle Control Modules 240, the IVA has access to any available Sensors and Outputs 904 associated with the Vehicle Control Modules. For example, the IVA may be able to access Instrument Cluster 906 and any related sensors to obtain readings from the odometer, engine RPM, speed, fuel and so forth. The IVA may be able to access Automobile Engine 908 and any engine related sensors, such as obtain readings from the mass air flow sensor, take exhaust readings, check for engine misfires, and so forth. Additional examples of tasks the IVA could generally perform include monitoring speed, airbag status, vehicle diagnostics, as well as perform actions and outputs such as unlock the door, start the motor, open the windows/sunroof/trunk, and so forth.

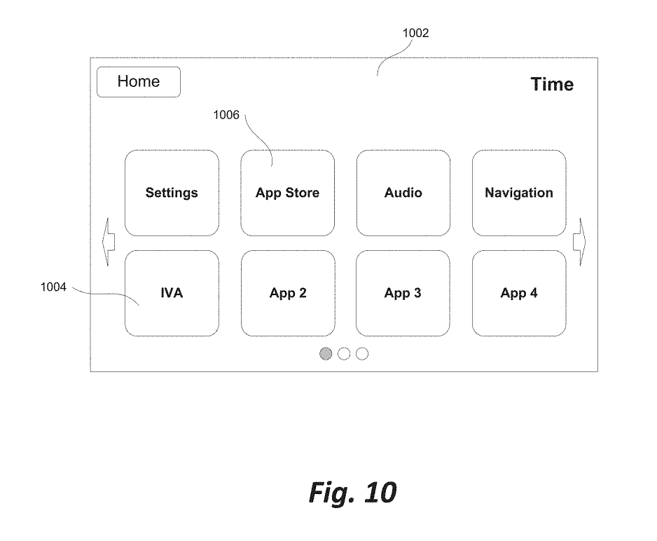

FIG. 10 is an example user interface of one embodiment of an in-vehicle infotainment unit.

As seen in the figure, the infotainment unit may have a user interface 1002 with a button 1004 or selector for running the IVA. Pressing button 1004 may run the IVA and present the user with another user interface. It should be noted that there may be a single IVA that manages various connected-vehicle services. For example, the IVA may be a platform that handles rental/carsharing, taxi management, finance, and ignition interlock or in-vehicle breathalyzer functionality. In other embodiments however, there may be multiple IVAs that are tailored for specific tasks. For example, there may be a rental car IVA or a car sharing IVA.

In some embodiments, the IVA may come preloaded on the infotainment unit from the factory or dealership. In some embodiments, the IVA may not come with the factory-default infotainment unit. Instead, the IVA may reside in the infotainment unit only after being downloaded from an app store, uploaded from a remote computer (PC, tablet or smartphone), or uploaded via an external media port (USB). Once the IVA is installed, then it will be displayed within the infotainment unit—for example, button 1004 shows that the IVA has been installed and is available. Highlighting and selecting button 1004 may then open the IVA.

Button 1006 on user interface 1002 of the infotainment unit may open up an app store interface that allows third-party applications to be downloaded to the infotainment unit through an available Internet connection, such as through an OE embedded cellular modem or the Internet connection of a paired mobile device. The app store may allow the user to search for the desired IVA, select download, and then download the IVA to their infotainment unit. Some infotainment units may have a web browser to access the Internet, in which case the user may also be able to open up the web browser on their infotainment unit and direct it to a web page hosting the IVA for download. Upon selecting download, the IVA may be downloaded to the infotainment unit and installed.

In some embodiments, the third-party application may instead be transferred and installed through Bluetooth/Wi-Fi, such as a Bluetooth-enabled smartphone, tablet, or PC. In some embodiments, the third-party application may be transferred and installed through a direct connection, such as a USB cable linked to a smartphone, tablet, or PC. For example, the IVA may be downloaded to a USB memory stick, which can then be inserted into a vehicle USB slot. The user can navigate the user interface of the infotainment unit to select the media, and then the IVA will automatically be loaded and installed onto the infotainment unit.

FIG. 11 is a flowchart that illustrates how a user may access one embodiment of the IVA. The figure is described using the context of an IVA paired with a breathalyzer for reducing DUIs, wherein the driver must be under a certain limit in order for the vehicle to start. That context is used to provide examples for understanding the various settings and configurations associated with the IVA and user accounts, but the examples are not intended to limit the possible settings and configurations in any way.

At Block 1102, the user may launch the IVA from the main menu of the infotainment unit. For example, in some embodiments the user may highlight and select the IVA in the infotainment unit's user interface, such as by pressing button 1004 as described in FIG. 10.

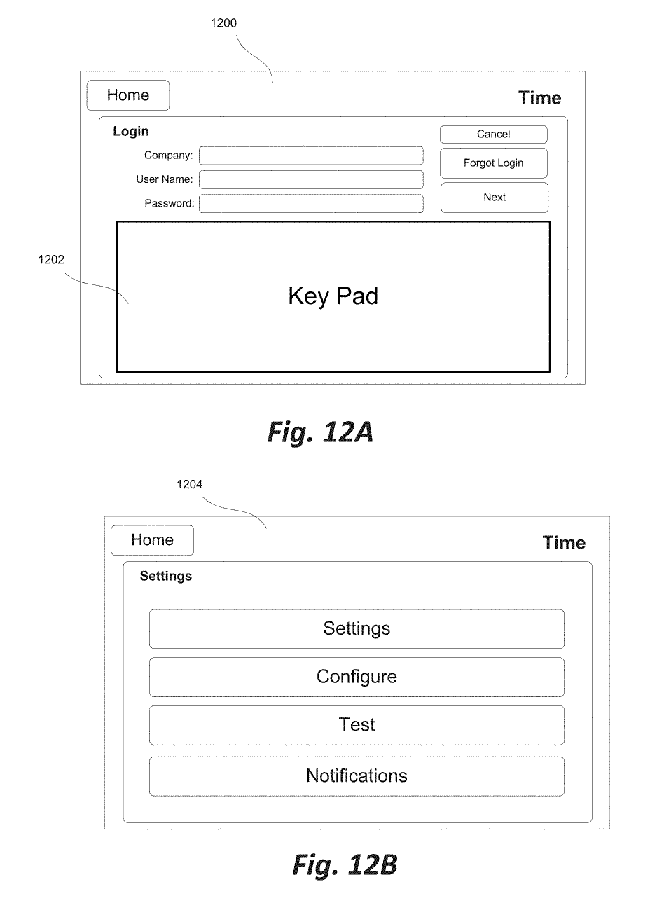

At Block 1104, the IVA may assess whether the user is a first time user, or whether a user profile associated with the user already exists. In some embodiments, this may be done using a login user interface where the user may enter credentials associated with an existing user profile or request the creation of a user profile. An example embodiment of such a login user interface is provided in FIG. 12A.

At Block 1106, if the user has a user profile the user may login using that user profile. Upon successful login, at Block 1108 the main menu of the IVA may be shown to the user and the settings and configurations associated with the user profile may be automatically utilized.

Once the user is logged in, the user may then have the ability to edit settings and configurations depending on the access level provided to their user profile. The type of profile or account that the user has may dictate what features may be accessible to the user. For example, an administrator may have full access to the IVA settings and configuration. In the context of a breathalyzer or ignition interlock device, the administrator account would have the authority to disable the breathalyzer completely and allow the vehicle to function normally. In contrast, some users may have limited access, while other users may have the ability to edit settings, activate/deactivate the IVA, pair any devices, and delete paired devices.

If instead the user is a first time user, the user may be presented a variety of different interfaces. At Block 1110, the user may be prompted to input an ID that has been previously provided to the user. In the case of a mandated program by a court, insurance company, or business, a unique ID may be granted to the user. The user may input the ID into the IVA and the settings will be automatically configured based on that ID. Then, at Block 1116 the user may be prompted to pair peripheral devices.

If the user does not provide a previously configured ID, then at Block 1112 the user can manually input user account information. During this setup process, the user may provide their name, an emergency bypass login (which may consist of 4 numeric digits), contact information, and notification settings. For some connected-vehicle services, the notification settings may consist of an email and/or cell number that a notification may be sent in the event of a violation. For example, if the user drives while intoxicated, a notification may be sent. In the case of a mandated program (insurance company, business or court) this field will be automatically populated and all information will be routed accordingly.

At Block 1114, the user can input account settings and configure the IVA. In some embodiments, a parent, business, insurance, or court system may be able to configure the IVA. In some embodiments, the settings may be automatically configured. In some embodiments, the settings may be downloaded or transferred from a paired device, such as from the breathalyzer. In some embodiments, the user may be provided a user interface for changing settings and configuration that resembles the user interface shown in FIG. 12B.

Some examples of configurable settings include the days and hours of operation. For example, the application may be configured to be active on Monday through Friday, from 8 AM to 5 PM. In this case, the app will request the vehicle operator to provide a breathalyzer sample during M-F between the hours of 8 AM and 5 PM. The times of operation could alternatively be set to 7 days and 24 hours (i.e., 24/7). In other use cases, such as for occupational drivers driving taxis, the app can control the hours of operation for the vehicle and no breathalyzer would be required.

Another configurable setting may be the alcohol level or cutoff for the vehicle to start. If this is not mandated, the user can set the alcohol sample level. If the sample is equal to or great than the preset limit the data will be reported and app will initiate the preconfigured settings. If mandated, the app will automatically configure the alcohol level and vehicle settings.

Another configurable setting may be the emergency bypass, which allows the user to bypass the vehicle access and management system in case of an emergency—regardless of the alcohol level of the user or any day and time restrictions. This setting may specify a number of times (e.g., 0 to “X”) that the emergency bypass may be utilized.

There may also be vehicle settings associated with vehicle operation. For example, there may be an engine disable setting. If the engine disable setting is disabled then the vehicle would operate normally. When the engine disable setting is enabled, the application would send an engine disable command to the vehicle control module when the vehicle is turned off. When the user turns the key to the ON position during operational hours the app will request a sample from the paired breathalyzer. If the sample is within the preset Alcohol level, the application will send an engine enable command to the vehicle control module enabling the vehicle to start.

There may also be vehicle settings associated with data collected during the operation of the vehicle. For example, data may be collected regarding the driver behavior resulting from monitoring and tracking the driver's habits. Data may be kept on the miles driven, the dates and times of vehicle operation, the total drive time, the start/end locations for trips and path taken, any rapid and extreme acceleration/cornering/braking, and air bag deployment. This data may be more useful in some contexts than others. For example, this data may be useful to car rental or insurance companies looking to monitor driving behavior.

At Block 1116, the user may pair the application to any peripherals. For example, the application could be paired to a breathalyzer over Bluetooth using standard discovery and pairing methods.

At Block 1118, the user will be allowed to activate the current settings and, if required, any relevant data may be uploaded to a third party (e.g., a court or business). The user may also be provided with an option to go back and edit or change the settings, as well as an option to delete/reset all the settings and return to the ID input page.

FIG. 12A is an example user interface of one embodiment of an in-vehicle application. More specifically, it illustrates a user interface 1200 in which a user may login to an associated user profile by entering credentials associated with that user profile.

User interface 1200 may have a key pad 1202 on which the user can enter their credentials for their user profile. They may be text fields for the user to enter their user name, password, and any other information associated with their user profile.

FIG. 12B is an example user interface of one embodiment of an in-vehicle application. More specifically, it illustrates a user interface 1204 in which a user may change settings or configurations associated with the in-vehicle application.

From user interface 1204, a user can access and edit account settings, users and app settings depending on the level of access provided to the user profile. For example, if the user profile is provided admin level access, than the user may be able to configure when and how notifications are to be received, such as through an email or a cell number (for SMS). The user may also have the ability to perform automatic or manual updates of the application, or even delete the application. Otherwise, the user may be provided the ability to change or edit their name, an emergency login, vehicle settings, paired devices, and so forth. This allows new users to be added and peripheral devices to be paired to the same app/vehicle.

FIGS. 13A and 13B are flowcharts that illustrate how embodiments of the vehicle access and management system may be configured to identify the vehicle.

As previously mentioned, the sets of executable instructions or command codes utilized by the IVA or the external hub can be unique to a specific year, make, and model of the vehicle. In some embodiments, the IVA or the external hub may be configured with sets of executable instructions or command codes to use with many different types of vehicles. This superset of command codes may be stored within a data store (i.e. magnetic disk, memory, etc.). In other embodiments, the appropriate command codes for that specific vehicle may be retrieved over the wireless network via download, and stored for future use. These command codes or executable instructions may be organized in storage and mapped according to their functionality. For example, a table or mapping may exist that cross references a key for the “unlock doors” command with either the storage location for the command code/executable instruction, or the codes/instructions themselves. However, in any case, the IVA or external hub must be able to determine the identity of the vehicle in order to utilize the right command codes.

In some embodiments, a user may be able to manually select the identity of the vehicle through an interface on the IVA. In other embodiments, the IVA or external hub will determine the identity of the vehicle (such as a year, make, and/or model) and the appropriate transmissions protocols when the IVA/external hub is initially run. They may be automatically configured to perform this determination once or repeatedly. For example, the IVA or external hub may determine the vehicle identity each time they are powered up or run, when they are put into a specific “learning” mode for making the determination, or they may only make the determination the first time they are run and being associated with a new, unidentified vehicle. Thus, in some of such embodiments, the IVA or external hub will store that identity for future use so that the identity of the vehicle only needs to be determined once, and any subsequent use will already be configured with the appropriate command codes or executable instructions needed for the vehicle.

Various methods may be used for determining the identity of the vehicle. For example, the IVA may query the vehicle ECU over the CAN bus in order to obtain the Vehicle Identification Number (VIN), which is a 17-digit number encoded with the vehicles year, make and model. The VIN may be stored in memory and used in order to determine the vehicle's identity, which then allows the appropriate codes to be determined depending on how the codes are stored.

In the embodiments where a superset of command codes for all vehicles are stored locally, the VIN may be analyzed in order to decode the year, make and model of the vehicle. The Code of Federal Regulations contains information on how to decode the VIN. For example, the 1st character may determine where the vehicle was manufactured/assembled. The second two characters of the VIN may determine the manufacturer. The 4th-8th characters may determine the brand, engine, size, and type of vehicle. The 9th character may identify the VIN as being authorized by the manufacturer. The 10th character may provide the model year of the car. The 11th character may indicate which plant assembled the vehicle, and the final 6 characters may contain the serial number of the vehicle. A table can be used to map the VIN to a make, model, and year. Once the year, make and model (YMM) is known, the appropriate YMM may be cross referenced with stored command codes or executable instructions for that specific YMM. These codes may then be referenced in the appropriate memory location for future use on the CAN bus for automated car commands.

In other embodiments, a superset of command codes may not be stored locally. The appropriate command codes for the specific vehicle may need to be retrieved and downloaded over a wireless connection, such as through the embedded cellular modem. The VIN may be instead sent via the wireless network connection to the remote computing system. The remote computing system may then determine the correct codes to use by decoding the VIN to lookup in a database the correct command codes and/or executable instructions to transmit back to the IVA over the wireless network/Internet. The codes (e.g., command codes or executable instructions) may be received by the IVA and stored in an appropriate table for lookup, access, and use to enable car commands such as unlocking the doors, etc.

These methods are also available with the external hub, although there may be some slight differences. An external hub connected to the OBD2 Port may perform the same query for the VIN over the CAN bus. Once the VIN is obtained, the VIN may then be stored in memory and/or compared to existing VINs in memory. The previously stored VIN may have been received from a prior startup or learning mode operation, for example from the same vehicle or a different vehicle that the external hub may have been previously installed in. If the vehicle is the same, and the VINs match, then there is no need to do any additional configuration, and the process may end. If the VINs do not match (or if there was no previously stored VIN because this is a new install), then the appropriate codes for the vehicle may need to be determined. In some embodiments, old VINs are not overwritten, which allows for a history of VINs to or may be stored in a new memory location, thus allowing for the external hub to record a history of VINs that the external hub has been associated with.

If the external hub (or the paired IVA) has a superset of command codes, then the VIN can be used locally to determine the vehicle identity for determining the appropriate command codes, as described above. However, if the appropriate command codes must be retrieved over the wireless network, then the external hub may send the VIN to the remote server via the wireless network/Internet, along with any other useful information for the remote servers to use for authentication or authentication purposes. In some embodiments, a self-identification code for the external hub may be sent as well. The remote servers may update the vehicle associated with the external hub by updating the VIN in their database and associating it with the self-identification code for the external hub, which may serve to verify the pairing between the VIN and the external hub.

FIG. 13A illustrates these processes from the perspective of a vehicle access and management system that utilizes the IVA 1302 alone.

At block 1304, the vehicle may be started up, and the IVA 1302 may detect that the vehicle has been started by detecting the ignition to be on or an engine start. At block 1306, the IVA 1302 determines whether the vehicle has been identified. This can be done in a variety of ways. For example, IVA 1302 may see if the VIN or the vehicle identity has been determined, whether a set of appropriate commands for a specific vehicle has been saved or is accessible, or it may query a status for whether the vehicle has been identified.

If the vehicle has been already identified, then the corresponding commands for that vehicle should also have been identified or saved. At block 1308, the appropriate commands are obtained from memory, where they may be saved in a table or database. At block 1318, those commands may be utilized at block 1320 to issue commands to the various vehicle subsystems (or interpret received messages from the subsystems).

However, if the vehicle has not been already identified then at block 1320, the IVA may determine the VIN—such as by querying the ECU over the CAN bus. However, block 1320 may be optional since the VIN is not necessarily needed to identify the vehicle. For instance, at block 1312 the vehicle may be identified by manual entry through the IVA 1302. More typically however, at block 1312 the vehicle will be identified by local lookup of the vehicle identity corresponding to the VIN, or by querying a remote server to lookup the identity corresponding to the VIN.

Once the vehicle has been properly identified, the appropriate commands corresponding to that vehicle may be obtained at block 1314. This can be done locally if stored with the IVA 1302, or it may have to be downloaded from the remote server. Once those commands are identified and obtained, at block 1316 they may be saved in memory for future use. At block 1318, the commands may be utilized at block 1320 to issue commands to the various vehicle subsystems (or interpret received messages from the subsystems).

FIG. 13B illustrates these processes from the perspective of a vehicle access and management system that utilizes IVA with External Hub 1322. The figure is very similar to FIG. 13A.

However, in some embodiments, after startup of the vehicle and the external hub, at block 1310 a VIN determination may be made. The external hub may be configured to store VINs that it has been associated with historically, and a VIN comparison may be one way of determining whether the current vehicle has already been identified. At block 1324, the VIN and a self-identification code associated with the external hub may be sent to a remote server, which can return the identification of the vehicle based on the VIN. Alternatively, the other methods of identifying the vehicle previously described may be used. The rest of the figure can be carried out as described in regards to FIG. 13A.

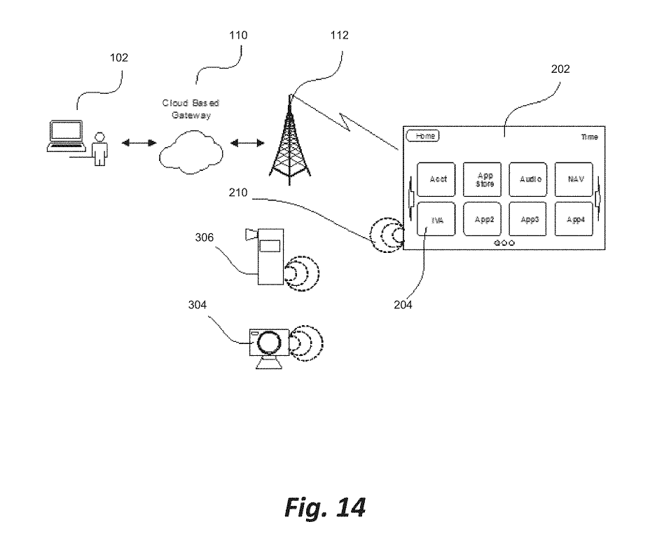

### Example Contexts—(FIGS. 14-28B)

Specific contexts and example vehicle access and management systems are described in this section. However, these examples are not intended to be limiting and serve only to illustrate how the vehicle access and management system can be used in performing a variety of functions and connected-vehicle services depending on the peripheral devices used and the configuration of the vehicle access and management system.

### Ignition Interlocks/Breathalyzers

One context in which the vehicle access and management system can be used is with ignition interlocks or breathalyzers. Most states have some form of ignition interlock laws, in which ignition interlock devices are equipped in motor vehicles operated by convicted drunk driving offenders for some period of time. These ignition interlock devices are used to disable the vehicle unless the driver can prove that the alcohol level in their blood does not exceed a certain level. There are currently bills pending at the State and Federal levels to mandate interlock devices on new vehicles. Such ignition interlock devices and breathalyzers would be beneficial to many entities, including car financiers, car insurers, local and state law enforcement, parents seeking to monitor their children, and so forth.

However, there are many drawbacks associated with current ignition interlock devices. Current devices pose an estimated annual cost of $1300 per user when taking into consideration the hardware costs, the installation and removal costs, and any additional monthly fees. This high cost may not be the only barrier to adoption for current ignition interlock devices. There may also be issues with offenders not installing the devices, the resources needed to monitor and maintain all the interlock devices, the availability of funding and program costs at the Government level, and the availability of local support to install and activate the devices.

The vehicle access and management system disclosed herein can be used with an in-vehicle breathalyzer application, which would reduce and in some cases eliminate hardware and installation cost. Furthermore, for vehicles that have access to the embedded modem, GPS and engine control, hardware installation would not be required since an external hub would not be needed.

Thus, there are at least three embodiments for the vehicle access and management system that can be utilized with the in-vehicle breathalyzer application. In some embodiments, the IVA 204 and Infotainment Unit 202 are without access to OE embedded systems and need to use the wireless connection from an external hub device. In other embodiments, the IVA 204 and Infotainment Unit 202 may need to interface with a user's smartphone and use the smartphone's wireless connection. In other embodiments, the IVA 204 and Infotainment Unit 202 have access to OE embedded systems.

FIG. 14 is system diagram that illustrates how the vehicle access and management system may be implemented in an ignition interlock context. In particular, it illustrates an example embodiment in which the IVA 204 and Infotainment Unit 202 have access to OE embedded systems, such as the on-board cellular modem of the vehicle. In some embodiments, the system has full access of the vehicles embedded wireless modem, GPS, sensors and control modules while the vehicle is in ON (key in auxiliary position or engine running).

In the figure, the Infotainment Unit 202 and IVA 204 may be paired with Breathalyzer 306 and Camera 304 through Wireless Transceiver 210, such as through Bluetooth. In some embodiments, application configurations and settings may be downloaded from Breathalyzer 306. The Infotainment Unit 202 may have direct access to Cloud Based Gateway 110 through Communications Carrier 122 by using the embedded cellular modem of the vehicle. In some embodiments, User 102 may configure the vehicle access and management system through Cloud Based Gateway 110.

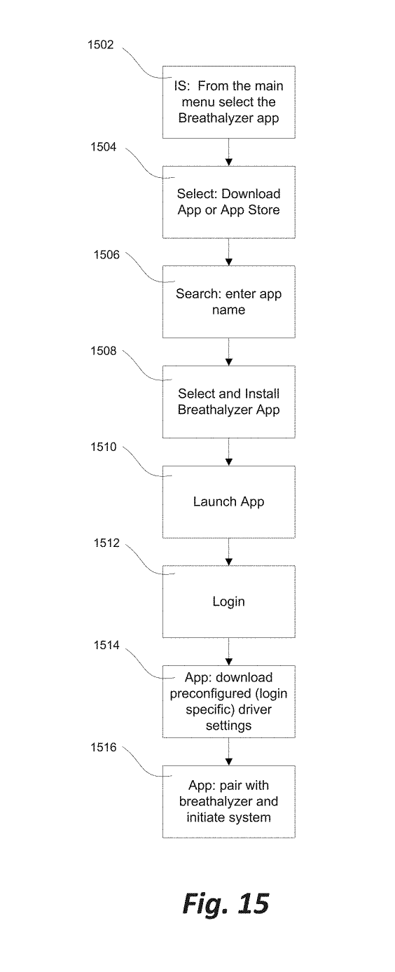

A driver looking to drive the vehicle would have to provide a sample to the Bluetooth-enabled Breathalyzer 306, which is paired to IVA 204. If IVA 204 determines that the driver's alcohol level is below a certain limit, than the IVA 204 may be configured to enable the vehicle to start by sending a command to the vehicle's engine. IVA 204 may then send data associated with the driver's compliance to Cloud Based Gateway 110, where it can be collected and tracked by a court, business, third-party, or so forth. Additional details for how the IVA 204 may be configured with Breathalyzer 306 are provided in regards to FIG. 15. Camera 304 may be a photo and/or video camera used to identify the driver as the driver provides a sample to Breathalyzer 306.

In some embodiments, every time the driver looks to drive the car, a notification may be sent to the driver's mobile device or to the IVA that informs the driver to blow into the breathalyzer. These readings may be logged and accessed later by a supervisor, such as a court, business, third-party, parent, etc. The supervisor may be able to access the backend and setup notifications, so that they are notified if the driver blows over the limit or if the driver has any alcohol in their system. In some of such embodiments, the system may even be configured to disable the vehicle if the driver blows over a certain limit, or enable the vehicle if the driver blows below a certain limit.

FIG. 15 is a flowchart that illustrates how a user may access one embodiment of an in-vehicle breathalyzer application for the first time.

At Block 1502, the driver may navigate the main menu of the infotainment unit and select the Breathalyzer application to be opened and run. However, if the Breathalyzer application does not exist on the infotainment unit, which may be the case on a factory-default infotainment unit, the application would have to be downloaded and installed on the infotainment unit.

At Block 1504, the driver may have to download the application from a connected hardware device or an online application store. If the driver chooses to download the application from the application store, then at Block 1506, the driver may enter the application name into a search field for the application store in order to find the desired application.

At Block 1508, the driver may select the breathalyzer application. The breathalyzer application would be downloaded from the application store and installed onto the infotainment unit.

At Block 1510, the driver may select and launch the application from the infotainment unit.

At Block 1512, the driver may be prompted to login into a user profile. In some embodiments, the login screen may look like the login user interface previously described in FIG. 12A. If the driver does not yet have a user profile, they may choose to create one.

Once the driver logs into their user profile, then at Block 1514 the application may download preconfigured driver and application settings that are associated with the user profile. In some embodiments, these settings may be downloaded from a paired peripheral device, such as from a breathalyzer once the breathalyzer is paired with the infotainment unit.

At Block 1516, the application may attempt to pair with the breathalyzer. Once paired to the breathalyzer, the application may carry out its intended function, such as by prompting the driver to provide a sample through the breathalyzer, as described in regards to FIG. 14.

### Rental-Carshare

Another context in which the vehicle access and management system can be used is managing vehicles for car rental companies or car sharing companies/services. Both of these markets are often referred to together as rental-carshare (RCS). The terms rental car share (RCS) and RCS vehicle are broad terms that include their ordinary and plain meanings, including, but not limited to, vehicles rented and leased by traditional car rental services such as Budget, Enterprise, Hertz, etc., and are returned to locations usually run by these services. The terms also include vehicles that may be a part of a car share business model, (e.g. ZipCar®, etc.) where customers may rent cars on the fly throughout a city or location using a member identification system, and need not return the vehicle to a rental service.

Currently, RCS companies utilize a vehicle management system that includes several hardware modules that are mounted in the RCS vehicle in order to manage a fleet of RCS vehicles. Such modules are usually connected by through the Internet to a remote server containing a vehicle database, a customer registration web based interface, and a billing system.

The RCS ideal business model requires its vehicles be in service for approximately 12 months. However, currently, the RCS vehicles are rolled over every 18 to 24 months due to the high labor cost of removing the hardware and re-installing it in a new vehicle, which typically costs about $85 to remove and $285 to re-install. Thus, the expense and time intensive installation and transfer process of vehicle management hardware is a significant burden on RCS companies. In addition, current hardware to support a management system may be expensive, due to sophisticated hardware and expensive RFID readers, and draw too much power.

The vehicle access and management system described herein can be used by RCS companies to reduce the drawbacks associate with current hardware. For vehicles in which the infotainment unit and any IVA have a high degree control of vehicle embedded systems, which include wireless communication technology, a RCS-tailored application can be used. For vehicles that lack that degree of access, an external hub may be installed into the rental car or carshare vehicle and interact with the RCS-tailored application in order to provide rental or carsharing services. Once the IVA and/or external hub obtain access to the CAN bus, they may be able to execute a variety of commands for the car, including unlocking the doors or a trunk, controlling lights, chairs, windows, headlights, etc. Furthermore, a customer may be able to utilize a mobile application to interact with the IVA and/or external hub via one or more wireless networks and/or the Internet, in order to make reservations, unlock doors, and access vehicles with an existing reservation.

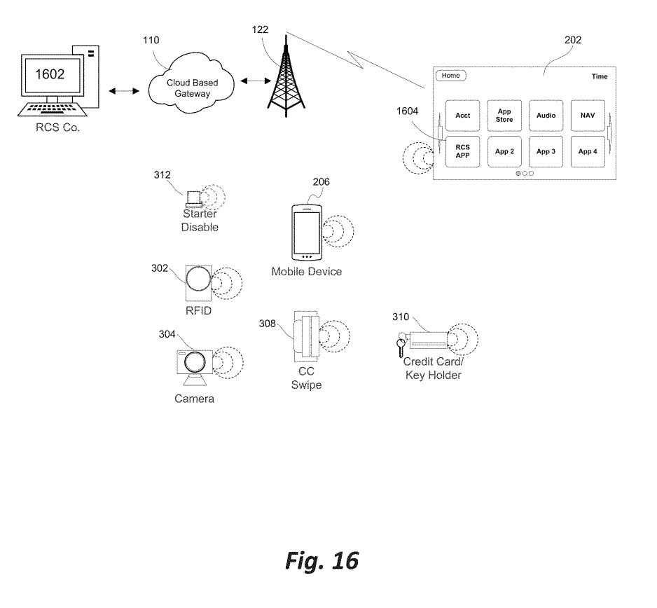

FIG. 16 is system diagram that illustrates how the vehicle access and management system may be implemented in an ignition interlock context.

The remote server 1602 may be called remote computing servers, remote computing services, remote servers, remote services, etc. They may be managed by the rental car share company, the manager or manufacturer of the external hub, or a third party. They may be hosted by a third party hosting service in a location unaffiliated with the rental/car share company. Their role is to provide a central repository of vehicle control, and an associated database. In some embodiments, remote server 1602 may be combined or interchangeable with Cloud Based Gateway 110, or a similar cloud computing service performing the functions of remote server 1602. Thus, the functions of remote server 1602 may be performed instead by Cloud Based Gateway 110, which interfaces with all the vehicles and the reservation system.

The servers may keep a number of tables, which may contain associations between the cars, external hubs, customers, and others as required by an RCS operation. These associations assist with billing and authorization/control of car functionality. Some of these associations are not as useful in certain scenarios, such as if no external hub is involved, since vehicle commands may be sent directly to the car through the IVA 1604. However, when an external hub is used, there may exist an association within the server (e.g. in a database table) between a vehicle's VIN number and the external hub. Thus, in order to control a specific vehicle, the vehicle access and management system will know by the association which corresponding external hub to send the command to. As previously described in regards to FIGS. 13A and 13B, this association may be created when the external hub is first installed or turned on in a vehicle.

There may also be an association between a customer and a vehicle, which in some cases may be associated with an external hub. The association between the customer and the vehicle may be created when the customer rents a vehicle or makes a reservation. In some embodiments, there may also be an association between an owner of the RCS fleet, and the external hub or vehicle. Again, this allows a program (such as a web program accessible through a GUI) to determine the exact vehicles in the installers/owners fleet, and the external hubs belonging to or associated with the owner.

These associations, and many other associations, may enable billing to take place. The billing software that uses data stored in the remote servers 1602 may use the associations to charge owners or customers. For example, owners may be charged based on the number of vehicles or external hubs used with the vehicle access and management system. In some embodiments, a rental car company may be charged for rental or service of unused external hubs that are uninstalled in vehicles (and thus, unassociated). For example, some rental car companies have over a million vehicles, many of which are in a state of transition. Thus, it is contemplated that costs may be reduced for rental car companies if they do not have to pay a monthly wireless service charge (or other charge) for unused external hubs. In some embodiments, customers may be charged based on the number of vehicles they have rented, how long those vehicles have been rented, and so forth.

In addition to these associations, any information accessible by the IVA 1604 or an external hub may also be uploaded to remote server 1602 to be accessed by an owner, user (such as a manager of the vehicle access and management system), or an interested third-party (like an insurance company). This data may include, for example, accelerometer information or its results (such as whether there was safe driving or not, or whether an accident occurred, its time/date, etc.), RFID/NFC access or communication, starts or stops of the vehicle, its GPS location, door lock or unlock events, etc. Any data available to the various vehicle systems, the IVA 1604, and the external hub is contemplated.

In some embodiments, the external hub or IVA 1604 may be paired to an RFID reader 302 that can detect a mobile device, such as Mobile Device 206. The RFID reader 302 may be able to read RFID/NFC/Bluetooth or other wireless signals. This allows Mobile Device 206 to be easily identified when in close-enough proximity. Thus, a customer who has made a reservation may be able to walk within ten feet of the vehicle. From the mobile device's RFID/NFC/Bluetooth signal, the mobile device's ID (and/or the customer's ID) can be quickly ascertained and sent to the remote servers 1602 (which can then, in turn, confirm a reservation and send commands to unlock the doors of the vehicle).

In other embodiments, the RCS vehicle may be associated with visual identifiers, such as a bar code or QR code that can be scanned. For example, RFID reader 302 may be replaced with a QR code or bar code on a decal that can be placed in the window of a RCS vehicle. A user may be able to use a mobile application on Mobile Device 206 that is configured to scan the QR codes or bar codes in order to receive corresponding information associated with the identifier. In some embodiments, the application may allow a customer to bypass a reservation desk and pickup/dropoff reserved RCS vehicles. Thus, customers would be able to get the doors of the vehicle unlocked so long as they owned a Mobile Device 206 with camera functionality, such as a mobile phone, tablet or laptop. This feature significantly reduces hardware and installation costs by eliminating the need for any expensive RFID and/or NFC hardware, and it may maintain security by placing the customer at the vehicle.

In yet other embodiments, no additional visual identifier or RFID/NFC communication is needed. Instead, a customer could photograph the car's license plate or VIN label via the Mobile Device 206. This photo could then be analyzed by the Mobile Device 206 or the remote server 1602 to extract the VIN or license plate number. That information can be used to identify the vehicle and for commands to be sent to the vehicle, such as unlocking the doors.

Thus, once the identifier has been scanned (or interacted with using any input method, including NFC communication, or taking a digital photograph of the car's license plate or VIN), it may be decoded or converted to determine the vehicle's identifier (e.g., sending the photograph to the remote servers to be converted). The vehicle identifier, along with a customer identifier, may be uploaded to remote server 1602 for verification. The customer identifier may include a phone number/ESN (electronic serial number) and mobile account information, or other identifier, and it may be encrypted. In some embodiments, the identifier may be used for an access code that allows a customer frequent access to a vehicle during a reservation. The remote server 1602 may generate an access code to be sent to the mobile application for storage, along with all relevant reservation data (i.e. length of reservation, dates, times, destination, starting places, prices for all services, services included, etc.). The access code may then be used to access the car in a variety of ways. For example, the access code itself may be transmitted from the remote servers 1602 to the vehicle. Then, if the access code is presented by the mobile device 206 to the IVA 1604/external hub (e.g. for example, using RFID/NFC with RFID Reader 302), and it corresponds to the access code on the IVA 1602 or external hub, commands will be sent to unlock all the doors and enable the starter. An example of the access code presented by the mobile device 206 corresponding to the code on the IVA 1602 or external hub includes the access codes matching. In other embodiments, one or more operations may be performed on the first access code and/or reference access code (such as a hash or an intermediary lookup operation) to determine the correspondence between the first and/or temporary access code with a reference access code. In some embodiments, the temporary access code may instead be sent from the mobile device 206 to the remote servers 1602. If the access code corresponds to the access code that the remote servers 1602 have associated with an active reservation, the remote servers 1602 will send a command to the vehicle to unlock the doors for the customer and enable the starter.

In more general terms, a program or device (such as a mobile device running a mobile application) may be able to communicate with, and control, the vehicle through remote server 1602. For example, in one embodiment, the remote server 1602 may communicate over the Internet with a mobile application that can control the car's functionality after authentication and authorization of the user (such as through a login, where the user is authorized to control the car (e.g. they rented the car), or if the car can tell that the user is in close proximity (e.g. through a QR/Bar code scan, RFID communication, NFC, or ad hoc wireless networking). At this point, the user may control a variety of functions, depending on its access control, including the list of the following commands: locating the vehicle, such as by sending GPS information back to the user, tracking the vehicle via frequent updates of GPS information, locking or unlocking the doors, unlocking doors for an approved valet, updating a list of RFIDs that are able to access the car (such as approved user RFIDs (e.g. a member of a car share organization), RFIDs associated with maintenance personnel, or a valet), or set settings in the control module, such as for the accelerometer, or to configure mileage tracking.

Thus, the programs and data in the remote servers 1602 may allow a user with a Mobile Device 206 to communicate with (and issue commands) to the IVA 1604 or external hub, even if there is no local communication between the Mobile Device 206 and the IVA 1604 or external hub. This may allow for all remote capabilities to be accessed, not just by a user of the car on their smartphone, but also by a remote user (such as an operator assisting a customer with a car). For example, an operator can unlock the car doors for a customer if they have lost their smartphone. Another example is if the car has been stolen during the rental period, the operator could issue a command to Starter Disable 312 to shut off the car and prevent it from starting.

In the context of rental/car-sharing, the customer's mobile application may further comprise user interfaces and functionality for communication, over the wireless network/Internet, with the rental car service or car share service (e.g. their servers) during the rental period. For example, these user interfaces may allow a use to terminate a reservation, extend a reservation, purchase gas plans or insurance, add new drivers, change reservations, or contact a customer service representative. By putting this functionality into an application on a mobile device such as a mobile phone, it reduces custom hardware and software requirements by leveraging existing customer hardware. In addition, it saves on wireless data costs paid for by the rental/carshare service.

Since the system is modular, peripheral devices can be added to the vehicle in order to perform specific, desired functions. Thus, any additional functionality desired by the RCS company can be added to the system while keeping hardware and software costs down. For example, as shown in the illustration the vehicle access and management system may include paired peripheral devices that include a Camera 304, Credit Card/Key Holder 310, Credit Card Swipe 308, and Starter Disable 312. As previously described, Credit Card/Key Holder 310 may be used to provide the customer a gas card or keys to the vehicle, which need to be returned before the reservation may end. Credit Card Swipe 308 may be used in situations where it is desirable to allow the customer to pay with a credit card inside the vehicle. Starter Disable 312 may be used and installed in the vehicle if for some reason the vehicle does not respond to commands sent over the CAN bus (e.g., a command sent to the vehicle ECU), and it can be used to disable the vehicle when the reservation is over.

In some embodiments, these components can be used for ride sharing and peer-to-peer relay rides. The IVA 1604 may be tailored for this ride sharing context. A person may be able to offer their vehicle to someone else when they are not using it. That person may be able to choose the rental rate they wish to lend out their car for. Someone may be able to borrow the vehicle using the same methods as described for renting a car from rental car companies. When someone borrows the car, the vehicle access and management system may collect data on time driven, miles driven, and driver behavior. Additionally, the system may monitor acceleration, deceleration, G-Force, whether the vehicle was bumped or crashed using the accelerometer, and whether the airbags deploy. This information can be used to determine if the borrower is a reckless driver. In the event that the airbags deploy, an email or text message may be sent to the mobile device of the owner of the car.

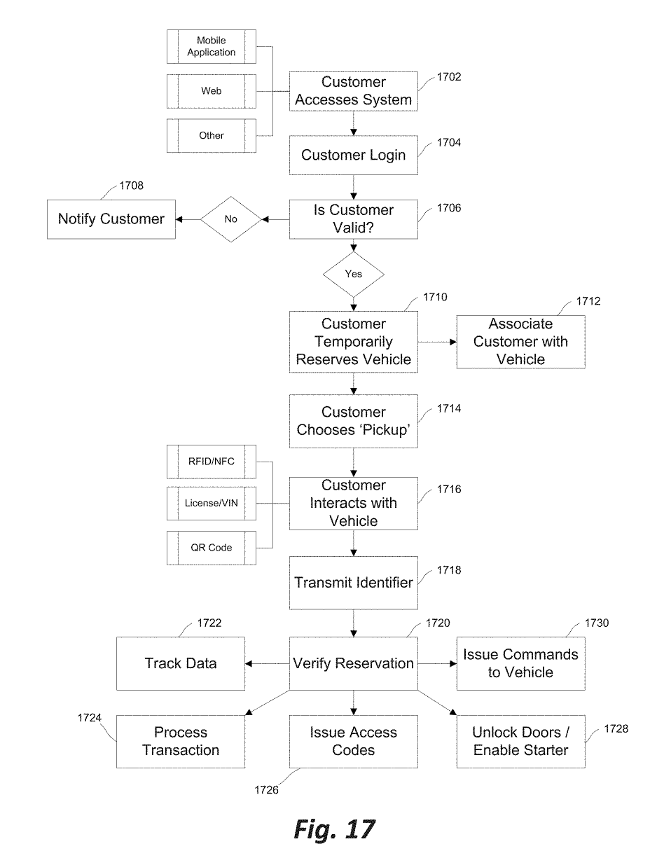

FIG. 17 is a flowchart that illustrates how a customer may typically use a mobile application in the rental car context.

At block 1702, the customer may access the vehicle access and management system. This can be done through a mobile application, a website, or by some other means having an electronic user interface for placing reservations. For the purposes of this example, the customer will be described as accessing a mobile application running on their mobile device.

At block 1704, the customer will provide an identifier or login credentials associated with their user profile to the remote servers. At block 1706, the remote servers may then test to determine whether that customer is in its database based on the identifier and credentials provided. If the customer isn't valid (e.g., the account does not exist), then the customer may receive a notification or indication that they are not a valid customer (e.g., the remote server may send back an error message to the platform the customer is using for access, such as sending an error message to via a mobile application). If that customer is a valid customer (e.g. subscribed, up to date on payments, such checks may require communication with the RCS provider), then the customer may gain access to the system.

At block 1710, the customer may be able to temporarily reserve a nearby vehicle. At this point, information associated with unreserved nearby vehicles may be displayed to the customer. For example, a customer browsing on their mobile application may be able to view different vehicles, their locations, their rental fees, and any other relevant information associated with the vehicle. Upon selecting a desired vehicle, the customer may then temporarily reserve that vehicle. The remote servers may associate the customer's identity or credentials with an identifier for the vehicle, which may be stored in a reservation database. This temporary reservation would allow a customer to reserve a car that is not currently within the customer's proximity, and would ensure the car is available when the customer goes to pick up a car. At this point, the customer may be able to pay for the reservation or select/customize certain reservation criteria, such as the length of time to rent/use the car, accept terms and conditions required by the rental or car share service to use the car, be offered insurance with its own terms and conditions, etc.

However, in other embodiments, the customer performs the reservation step after coming into close proximity with the vehicle and interacting with it (e.g., after block 1716 and performing the reservation at block 1718/1720). In such embodiments, at block 1710 the customer would primarily browse for available vehicles and their locations. This embodiment could be used for a first-come-first-serve car rental service where customers must be in proximity to a vehicle in order to reserve it. In this scenario, the customer may stand next to the car while selecting/customizing certain reservation criteria, such as the length of time to rent/use the car, accept terms and conditions required by the rental or car share service to use the car, be offered insurance with its own terms and conditions, etc.

At block 1714, the mobile application may allow a customer to enter data during the vehicle pick up process in order to speed up the process. For example, a customer may select “pickup” from a list of menu options in the mobile application running on their mobile, wirelessly connected device.

At block 1716, the customer will then walk over to the vehicle and interact with the vehicle in some matter that notifies the vehicle access and management system that the customer is attempting to pick up the vehicle. For example, the mobile application may then query the user to use a camera integrated with the mobile device to scan a visual identifier associated with the vehicle, such as a QR code, bar code, license plate, VIN number, or other identifier associated with the vehicle to be picked up. The QR code may be located on the rental vehicle, such as adhered to one of the windows. This will allow the mobile application to determine the correct identifier associated with the vehicle. Other methods of input for this identifier are also contemplated for this procedure, including, but not limited to RFID/NFC communication between the mobile device and a RF reader that has been paired with the vehicle's IVA/external hub (and can be placed on the dashboard), or texting a specific phone number associated with the car or rental service (the appropriate car may be unlocked via the rental service knowing which car was reserved for the user associated with a mobile phone).

At block 1718, after the vehicle's identifier has been determined, the mobile application may transmit the identifier to the remote servers to verify the person has reserved that vehicle, along with any other relevant information such as a customer identifier, a reservation identifier/request, and so forth.

At block 1720, the remote servers would attempt to verify the reservation by seeing if the customer has been associated with the vehicle. If the remote servers' database contains a valid reservation for the identified car for the customer at or near the time period the request is made, then the reservation may be considered valid. In some embodiments, if the remote servers determine that a valid reservation does not exist and that the vehicle is available for reservation, then the system may allow for the customer to make the reservation at this point. One way this could happen is if the customer had not made a reservation and just walked up to the vehicle. If the vehicle cannot be reserved, such as if it has already been reserved by someone else, the remote servers may determine if any nearby vehicles may be reserved, and if so, transfer that information back to the mobile device, including the location of the proposed vehicles. If no vehicles are nearby that can be reserved, an error message is transmitted back to the mobile application.

If instead, the customer has not yet placed a reservation on the vehicle and the inquired vehicle can be reserve, the remote servers may initiate the reservation process via the mobile application. The customer may select that he is picking up the car, or that he wishes to reserve the car. The customer may be able to use the RFID/NFC capability of the mobile device, or the camera of the mobile device to scan the barcode, QR code (or some other visual identifier), in order to obtain the vehicle information to inform the remote servers about the specific vehicle the customer is seeking to reserve. The customer may then be able to pay for the reservation or select/customize certain reservation criteria, such as the length of time to rent/use the car, accept terms and conditions required by the rental or car share service to use the car, be offered insurance with its own terms and conditions, etc.

Once the remote servers verify the reservation, a confirmation may appear on the mobile device. At block 1726, once the reservation has been verified (or even whenever the customer places the reservation), the remote server may generate a temporary access code and issue it to the customer. The access code may be sent to the mobile application for storage, along with all relevant reservation data (i.e. length of reservation, dates, times, destination, starting places, prices for all services, services included, etc.) The access code may now be used by the customer to begin using the car. This may be done in multiple ways. In some embodiments, the access code itself may be transmitted from the remote servers to the IVA or external hub of the vehicle. Then, if the access code is presented by the mobile device to a paired peripheral device (e.g. using RFID/NFC for example), and it corresponds to the access code provided to the IVA or external hub, the vehicle will unlock all the doors and enable the starter (e.g. through commands sent to the CAN buses and/or starter as described herein). In other embodiments, the temporary access code may instead be sent from the mobile device to the remote servers. If the access code corresponds to the access code that the remote servers have associated with the reservation, the remote servers will send a command to the IVA or external hub to unlock the doors for the customer and enable the starter. In other embodiments however, this access code is not used and the remote servers may issue commands without it, as described in regards to block 1728 and 1730.

At block 1728, the remote servers may inform the IVA or external hub, such as over a wireless connection/Internet, to unlock the vehicle doors and enable the starter. The IVA or external hub would then send the appropriate commands over the CAN bus for unlocking the doors and enabling the engine to be started. Thus, the customer would then be able to enter the car and use keys found within the vehicle to drive the vehicle. Any commands or instructions sent to the IVA or external hub may be protected using host and network security mechanisms known in the art, such as Authentication, Authorization, and Accounting schemes, including PKI, identifiers/passwords, access control lists, etc. In some embodiments, the remote servers may first receive a mobile device identifier or customer identifier from the customer's mobile device and verify that the customer is a registered customer with the RCS service before the customer is provided access to the car.

At block 1730, the remote servers may also issue any other appropriate commands to the vehicle wirelessly to be received by the IVA (or through the external hub if the vehicle does not have a native wireless connection), which would continue to monitor for any signals sent by the remote servers. For example, if the vehicle is stolen during the rental period, then an operator or administrator of the remote servers may issue commands to the vehicle to disable the engine of the vehicle.

At Block 1722, the IVA or external hub may begin to monitor vehicle data or driver behavior using the various sensors and instruments of the vehicle or the external hub. For example, driver behavior may be monitored using the accelerometer and other information queried via the CAN bus (such as driver habits, going past a geofence when the vehicle departs a preset area, diagnostic trouble codes (DTCs), or collisions). The driver and vehicle data may be sent to the remote servers via the wireless network. For example, the servers may periodically receive and verify the vehicle fuel level (along with location, mpg, etc.) to monitor fuel consumption over the reservation. In some embodiments, the fuel consumption can be used to charge the customer's credit card or account.

In some embodiments, the fuel consumption monitoring can be used in order to notify the customer of fuel-related emergencies, either through a notification through the IVA or to the customer's mobile device. For example, a customer may be notified that they need to stop for gas prior to returning a vehicle and ending the reservation. The remote servers may calculate the driving distance of the associated vehicle of the shortest route to the destination. Based on this distance, and the mpg of the vehicle, the remote servers may calculate the fuel required to reach the destination. Even if there is enough fuel to reach the destination, the remote servers may repeat this process periodically. As the vehicle progresses through its trip, it will periodically upload new information (new location, new fuel level, optionally new mpg) to the remote servers. The remote servers may then recalculate the distance and fuel calculations to determine whether there is enough fuel to reach the destination. If at any time, it is determined that there is not enough fuel to reach the destination, the remote servers may calculate the fuel station closest to the destination that is still reachable with current fuel levels. This may be performed with geomapping services, such as Google Maps. The destination may then be transmitted to the customer. For example, the user may receive a text message about the current fuel level, the inability to reach the destination, and the location of the calculated fuel station to stop at. This may include a map or other information usable to find the fuel station. This may be conveyed via SMS, IM, email, or in car display. This concept may also be applied to other services involving geomapping. For example, the remote servers may be able to use location, destination, and current fuel in order to inform the customer if they have a last chance to stop for food, rest stops, oil, water, and so forth.

In some cases, the destination for the trip (e.g., used in fuel calculations) may be determined from the reservation. There may be a final destination associated with the reservation, or there may be multiple destinations as part of a trip log. The destination used for the measuring and comparison process (e.g., of sufficient fuel levels) may be the next destination rather than the final destination. In some embodiments, the customer may be able to seamlessly add destinations to the reservation. For example, during the trip the customer may be able to add a new location or waypoint through the IVA interface and that destination will be provided to the remote servers for any calculations that need to be made.

At Block 1724, the transaction for the reservation may also be processed. For example, if the rental rate is a flat daily charge then the customer's account may be charged. A confirmation message may be displayed on the customer's mobile application, or a receipt may be sent to the email address on the customer's account or via SMS text. In some embodiments, the customer may be able to pay by swiping a credit card with a credit info may then be sent to the remote servers for the transaction to be processed.

In some embodiments, when a customer's trip ends (for example, time of card swipe inside the vehicle that has been paired to the IVA or external hub. The credit card

the reservation has run out and/or the destination has been reached or approached which can be tracked via GPS data uploaded to the remote servers from the control module), all relevant reservation data may be sent to the mobile app from the remote servers (i.e. checkout information, fuel information, etc.). If the customer confirms that the reservation is over, then all end of reservation data may be sent to the mobile app, such as the final checkout receipt and inspection of the vehicle. In some of such embodiments, the customer may be able to pay at the end of the reservation. Thus, the transaction will be processed at the end. For example, a customer may be able to reserve a car with a payment scheme where the rental fee is dependent on how many miles were driven during the rental period. Vehicle data about the miles driven over the rental period may be collected and sent to the remote servers. At the end of the reservation, the customer may be able to pay with the in-vehicle credit card swipe and be charged based on that information. After the reservation is over, the remote servers may send a command to the vehicle's IVA or external hub to disable the starter, lock the doors, and dispose of the temporary access code if any. In some embodiments, the reservation information for the customer may be deleted from the reservation database once the reservation has ended.

### Taxi Management

Another context in which the vehicle access and management system can be used is with taxi cabs or taxi services. A taxi company may have a fleet of taxis with in-vehicle infotainment units running the taxi application. The application may be configured with the taxi rates, and for each ride the mileage and time may be tracked. In some embodiments, the taxi application may be able to geofence a driver and limit the drive to a territory or zone. This would prevent too many drivers from being in the same area.

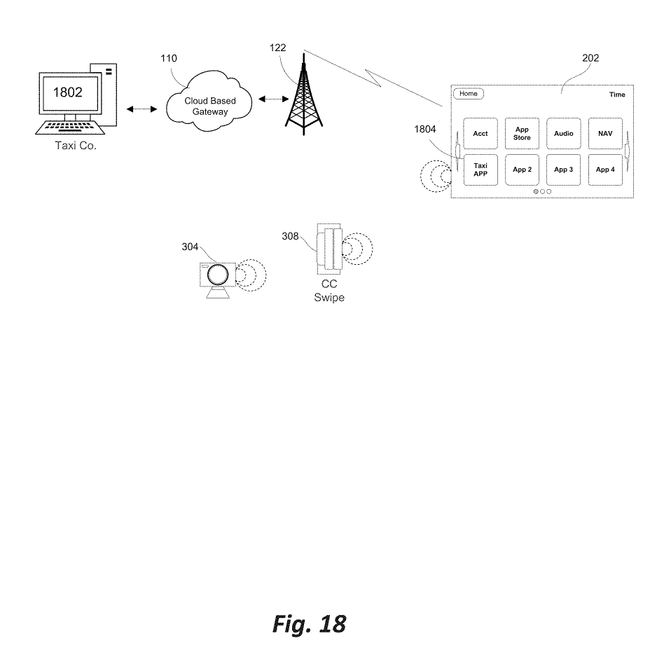

FIG. 18 is system diagram that illustrates how the vehicle access and management system may be implemented in a taxi management context.

As with the RCS context, the remote server 1802 may be managed by the taxi company, the manager or manufacturer of the external hub, or a third party. In some embodiments, remote server 1802 may be combined or interchangeable with Cloud Based Gateway 110, or a similar cloud computing service performing the functions of remote server 1802. Thus, the functions of remote server 1802 may be performed instead by Cloud Based Gateway 110.

A taxi driver may run the taxi application or IVA 1804 over the infotainment unit to handle functions during his shift. In some embodiments, the IVA 1804 may be paired to a Credit Card Swipe 308 and a Camera 304. The Credit Card Swipe 308 would allow the customer to pay for a taxi ride by credit card, and the Camera 304 could be a video or photo camera used for security by capturing footage or images of the customer. For vehicles that have trouble paring with a specific credit card swipe or camera peripheral, an external hub may be used to facilitate the pairing.

For some mobile taxi services like Uber, the driver is usually provided with a mobile phone that allows the driver to receive pickup requests and drop-off destinations. Instead, the taxi application or IVA 1804 can be used instead to handle everything. A driver that wishes to start working could turn on the taxi application on the infotainment unit and receive pickup requests that way. On vehicles with infotainment units, this would save a great deal of money that would be otherwise spent on additional hardware like the mobile phones provided to the drivers.

### Equipment Rental

Another context in which the vehicle access and management system can be used is with construction or farming vehicles and equipment. For example, a tractor may have an infotainment unit that may be able to run an IVA or be paired to an external hub. The system may be able to log operating hours and usage of the tractor. Many of the aspects of the system with regards to the RCS context may be applied in this context as well, such as the reservation system, data monitoring, uploading data to the backend servers, accessing an internal wireless modem, and interfacing with the customer.

A customer may be able to rent out the tractor. In some embodiments, the customer may be able to pay a rental rate that depends on how much time the tractor is being rented out for, or for how much fuel has been used. In other embodiments, the logged operating hours may be used to charge the customer based on use, so that the customer is not charged if the tractor is just sitting there.

Road Usage Charge, Tax, and/or Fee (RUC)

Another context in which the vehicle access and management system can be used is as a way to implement viable alternatives to the fuel tax. The fuel tax is the principal mechanism for funding state and federal transportation programs. In most states, it is an excise tax, levied on the physical amount of fuel purchased and not the purchase price of the fuel. Thus, even as fuel prices decline or rise, the fuel tax remains static at a fixed rate per gallon. Since the fuel tax is paid as part of regular fuel purchases, every driver of a vehicle with an internal combustion engine prepays for road usage whenever they refuel their vehicle. Upon its initial inception the fuel tax was thought to be a true user fee because those who drove more would purchase more fuel and thus pay more taxes. However, this relationship is being undermined by various fuel efficiency improvements in vehicles.

The average fuel efficiency of the U.S. auto fleet is continually improving. Federal corporate average fuel economy (CAFE) standards require automakers to continually develop and market vehicles with higher and higher fuel efficiencies. Historically high fuel prices are driving increased demand for these vehicles. As a result, the average vehicle in the U.S. is paying less and less in fuel taxes for every mile it drives. This situation is further exacerbated by two significant factors. The first is that there are new vehicle technologies coming onto the market that allow vehicles to operate on even less fossil fuels, such as plug-in electric hybrids, or on no fossil fuels at all in the case of pure electric vehicles. The second factor is inflation. State and Federal fuel taxes have, in many cases, not been raised in over two decades. This means that the fuel tax has lost over 20 years of purchasing power.

State governments have been the leaders in examining potential solutions to the unsustainable nature of the fuel tax for funding transportation investment. Many are studying fees based on actual miles traveled as a potential long-term solution, rather than the amount of fuel used. This approach is referred to as Road Usage Charge, Tax and/or Fee (RUC).

In order to properly implement a road tax, there needs to be a robust method for metering the distance traveled by vehicles. Some of these mileage reporting methods were evaluated in the Road Usage Charge Pilot (RUCP) Program, which was a multi-year endeavor overseen by the Oregon Department of Transportation (ODOT). In the RUCP, at least four options were tested for road usage metering, which represents an improvement over the single metering option testing in the 2006 mileage fee pilot. These four options included: (1) a basic plan; (2) an advanced plan; (3) a switchable/smartphone-based plan; and (4) a simplified flat fee plan. Under the basic plan, participants used a device that recorded all miles driven. There was no GPS component in the device and no location data was collected. Participants paid for every mile they drove in their vehicles. Under the advanced plan, participants used a device that recorded miles driven and allocated those miles to zones based on GPS data, with each zone set up based on state boundaries. Participants paid only for mileage accrued on public roads in their state. The switchable/smartphone-based plan was a hybrid of the basic and advanced plans; under the switchable/smartphone-based plan, participants used a GPS-enabled device that allowed them to choose whether to report miles on a zone basis or report all miles traveled. If the participant did not want location data to be collected for a particular trip, they turned the device to basic mode. However, if they traveled out-of-state, they turned the device to advanced mode and were not charged for mileage accrued out-of-state or for non-eligible mileage (such as on private property). Thus, participants chose whether to report and pay for mileage accrued on public roads in their state or for all mileage accrued on a per-trip basis. Under the simplified flat-fee plan, participants did not use a reporting device at all. Instead, participants paid a fee based on an assumed maximum annual mileage. The amount paid was based on 35,000 miles per year at $0.0156 cents per mile, which was prorated to a monthly fee of $45 or a total of $135 for the three-month period of participation for the RUCP.

Thus, participants who chose a plan that used an in-vehicle device were essentially choosing among three different mileage reporting devices, all of which were in the configuration of a “dongle”. Participants in the basic plan received a simplified dongle that did not have an internal GPS component. The dongles used for the advanced and switchable plans collected GPS data so that the pricing systems could tell whether travel was occurring within public right-of-way, such that a participant would cease accruing chargeable mileage when they departed the public right-of-way or left their state. Initial estimates for the cost of the individual units tested were in the range of $100 to $200 per unit, although ODOT believes those costs would be greatly reduced as part of a statewide pilot or implementation due to economies of scale. These various dongles were mailed to participants, who self-installed them by connecting the dongle to the vehicular on-board diagnostic port. This vehicular connection provided the dongle with the information needed to determine miles driven. In addition to installing the dongle, participants in the switchable plan also had to download a specialized smartphone application that allowed the phone to communicate with the dongle and receive data. The app allowed the user to switch between basic and advanced mileage reporting. Users were able to disable the vehicle location reporting component of the phone at any time through the smartphone application. The ODOT found that most people did not have any trouble with the installation itself. In fact, most of the inquiries received by the ODOT helpline were from participants who had trouble finding their vehicular OBDII port, not actually installing the device.

Throughout the RUCP program, the technologies behind the various dongles and plans were evaluated under numerous metrics to determine their suitability in monitoring vehicle distance traveled. These metrics included the adaptability of the RUC system, the ease of installation of mileage reporting devices, the safety of mileage reporting devices, the mileage reporting device installation, and system operations for motorists, anti-tampering, and system performance. Additionally, the hardware, software, and other elements were evaluated based on various criteria including feasibility, accuracy, reliability, security/encryption, open system, energy consumption, and account management system experience.

However, to properly utilize those in-vehicle devices from the RUCP program, all participants had to have a vehicle with a model year of 2004 or newer because all of the in-vehicle devices relied on connecting to the vehicular OBDII port. Although such ports have been standard in new model vehicles since 1996 in order to facilitate emissions testing, the pins that comprise the vehicular OBDII port do not necessarily provide the same information between different makes and models. ODOT discovered that the OBDII pins and the information they provide is only consistent enough for models manufactured after 2004, such that a common dongle could be used without too many data issues.

Rather than using the in-vehicle devices evaluated in the RUCP Program, the vehicle access and management system described herein can fulfill all of those roles and be used for metering vehicle distance traveled. The vehicle access and management system also has additional benefits in being able to work with a wider range of vehicles and can be used for other applications and contexts as well.

The vehicle access and management system may include a road usage charge (RUC) in-vehicle application (RIVA). The RIVA may be installed onto an In-Vehicle Infotainment Unit, such as the In-Vehicle Infotainment Unit 202, and configured to communicate with one or more computers. For example, there may be a backend server or RUC Account Manager that the RIVA communicates with in order to update data associated with the user. In order for the RIVA to communicate with any servers, the RIVA may utilize resources available to the Infotainment Unit. For example, the RIVA may be able to transmit data by accessing a vehicle's embedded wireless modem (commonly referred to as the OE modem) and GPS. In a configuration in which an external hub is used, such as the External Hub 502, the RIVA may be able to transmit data by accessing the external wireless modem and GPS from the external hub. Alternatively, the RIVA may be able access an embedded GPS for location information and transmit data by accessing the user's cell phone, which is paired to the Infotainment Unit (e.g., through OE Bluetooth). Thus, the RIVA would use the cell phone's wireless communications capability to upload or receive data. There are also different ways in which the RIVA could be configured. In one instance, the RIVA could be configured prior to download and installation. In another instance, the RIVA could be configured through a user interface accessed through the Infotainment Unit.

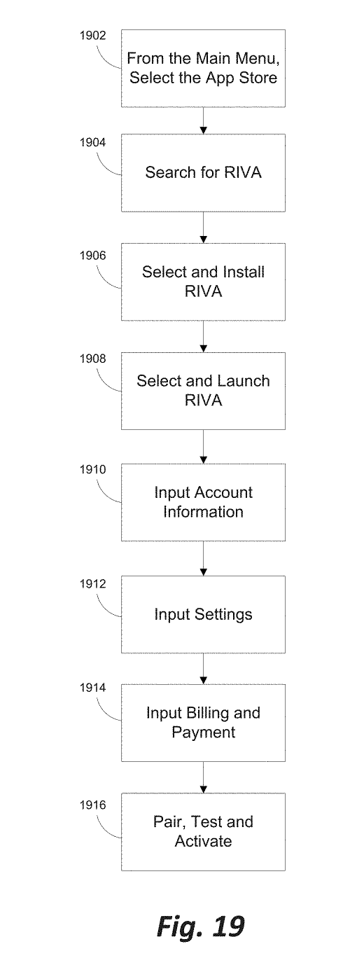

FIG. 19 is a flowchart that illustrates how a user may download and access one embodiment of a road usage charge (RUC) in-vehicle application (RIVA).

At block 1902, the user will navigate the main menu of their In-Vehicle Infotainment Unit to the App Store. At block 1904, the user will search the app store for the RIVA, such as by entering the application name in the search field. A list of search results would be presented on the user interface of the In-Vehicle Infotainment Unit.

At block 1906, the user would select the RIVA and choose to install it. This initiates downloading of the RIVA. At block 1908, once the application is downloaded the user selects to open or launch the application.

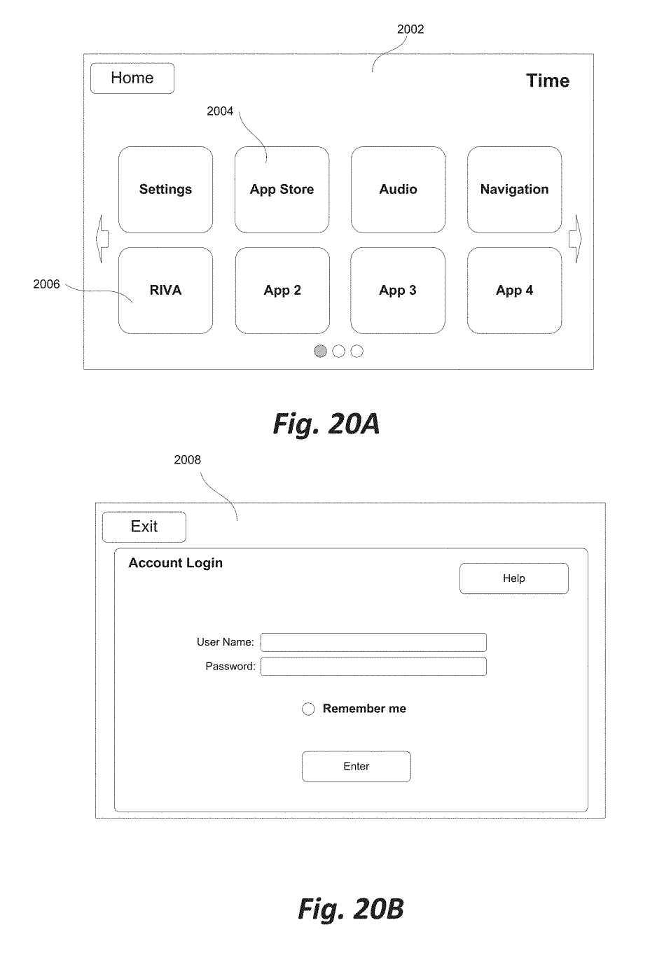

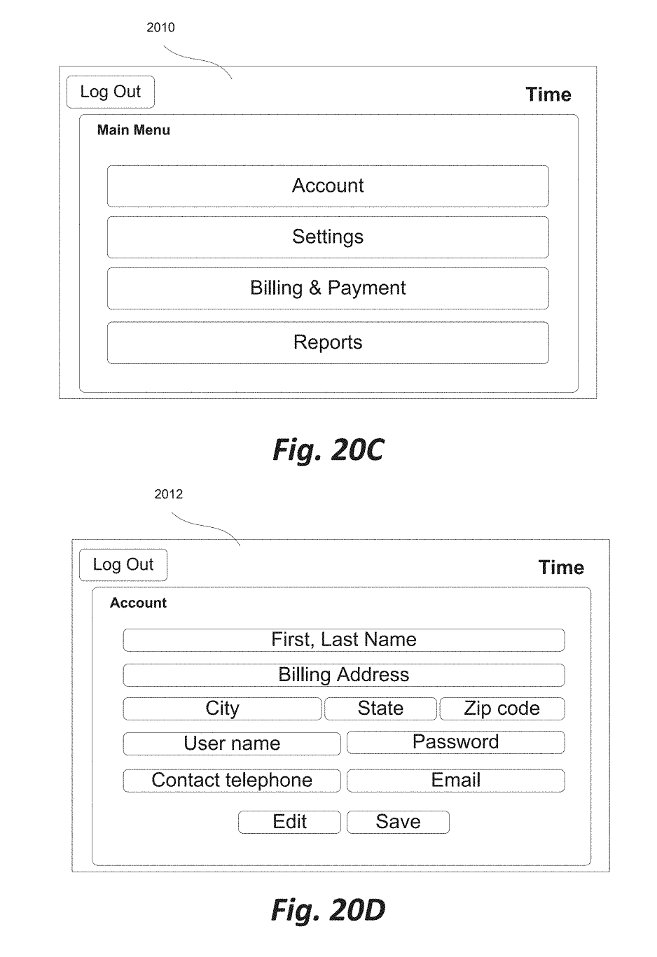

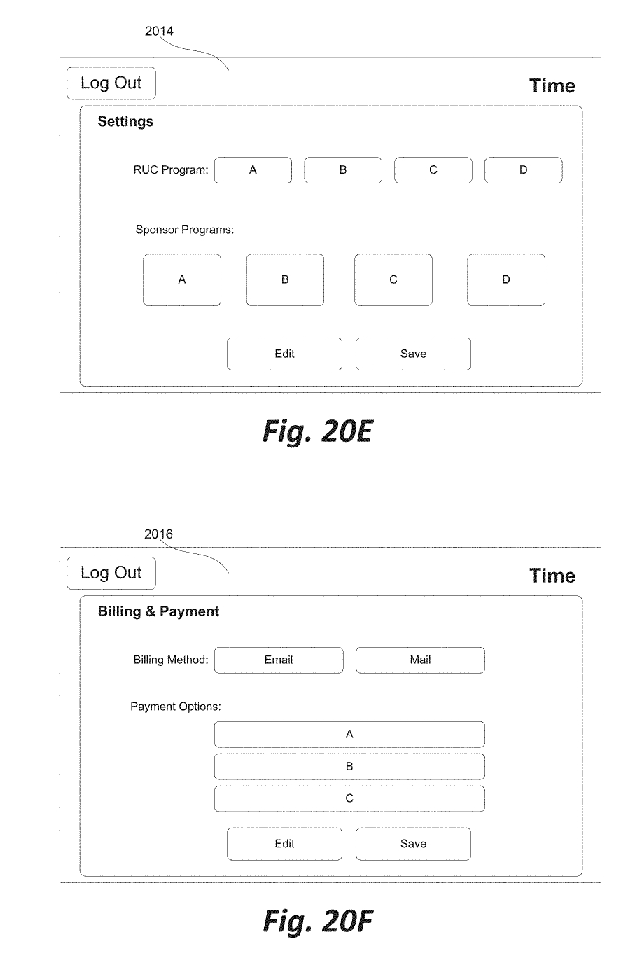

At block 1910, on initial launch the application will open to the “Account” page, through which the user can input their personal, billing, and login information and select save. An example of such an interface is shown in FIG. 20D.

At block 1912, after the user selects to save on the account page, the “Setting” page will be displayed. The user selects the RUC program type and any additional features. The user also selects sponsor programs, which are third party apps or internal features (options within RIVA) that can be downloaded or activated. These apps or features may include, but are not limited to, a User Based Insurance (UBI) app, an Alcohol Interlock app (requires Bluetooth enabled breathalyzer) and/or Vehicle diagnostic information. An example of such an interface is shown in FIG. 20E.

At block 1914, after selecting “Save” from the settings page, the Billing and Payment page will be displayed. The user will select the billing method (e.g., email or mail) and payment options. The payment options could be electronic payments, auto withdraw or paper invoice. An example of such an interface is shown in FIG. 20F.

At Block 1916, after selecting “Save” on the billing and payment page, the application will enter the “Pair, Test and Activate” mode. Initially the RIVA will scan for an external hub to pair with. If the RIVA discovers an external hub (e.g., the vehicle does not have embedded wireless modem and/or GPS), the RIVA will automatically pair with the external hub. Then, the RIVA will initiate a systems check and begin a test sequence to test in-vehicle communications, such as cellular connectivity, GPS, and vehicle communication data points (e.g., speed, odometer, RPM, MAF, etc.). The RIVA will upload the user's configuration settings and then activate to start monitoring and reporting vehicle mileage data.

FIG. 20A is an example user interface of one embodiment of an in-vehicle application. More specifically, it illustrates a user interface 2002 in which a user may access a road usage charge in-vehicle application (RIVA), such as RIVA 2006.

As can be seen in the figure, the user interface 2002 is a main menu that displays RIVA 2006 post-download and installation. The user interface 2002 allows RIVA 2006 to be accessed when selected by user. Also shown in user interface 2002 is the app store 2004, which is a potential way in which the RIVA 2006 can be installed onto the Infotainment Unit. Accessing the app store 2004 may allow the user to search for and download the RIVA 2006, as previously described.

FIG. 20B is an example user interface of one embodiment of an in-vehicle application. More specifically, it illustrates a user interface 2008 in which a user may login to their account associated with a road usage charge in-vehicle application (RIVA).

When the user selects RIVA from the main menu of their Infotainment Unit, the login page shown in user interface 2008 will be displayed. User interface 2008 includes text fields for the user to enter their user name, password, and any other information associated with their profile. There may also be a touch screen key pad (not shown) in the user interface 2008 on which the user may enter characters into the text fields, or the user may be able to use the vehicle's control knob. User interface 2008 may have a “Remember me” option to remember the user's credentials and bypass the login page, so that the user does not need to re-enter them each time they access the RIVA. Upon entering their credentials and login information, the user may hit the “Enter” button in order to gain access to the RIVA main menu and the rest of the functionality provided by the RIVA.

FIG. 20C is an example user interface of one embodiment of an in-vehicle application. More specifically, it illustrates a user interface 2010 in which a user may configure various aspects of a road usage charge in-vehicle application (RIVA).

User interface 2010 may be an example of the main menu of the RIVA, in which the user can manage the app settings and view reports. As shown in the figure, user interface 2010 includes buttons for “Account”, “Settings”, “Billing & Payment”, and “Reports”. Pressing one of those buttons may direct the user to a different menu or interface corresponding to that section. For example, pressing the “Settings” button may take the user to the “Settings” page. The “Account” page may allow users to edit/delete their user profile, contact, and/or login information. The “Settings” page may allow users to change the RUC program type and add or delete sponsor programs. The “Billing & Payment” page may allow users to manage their billing methods and/or payment options for the distance traveled. The “Reports” page may allow users to view the RUC current mileage, current RUC fees, along with a summary of any other useful information. Examples of “Account”, “Settings”, and “Billing & Payment” interfaces are further provided in FIGS. 20D, 20E, and 20F.

FIG. 20D is an example user interface of one embodiment of an in-vehicle application. More specifically, it illustrates a user interface 2012 in which a user may configure their account associated with a road usage charge in-vehicle application (RIVA).

If the user clicks the “Account” button in the main menu of the RIVA, the user may be directed to the “Account” page represented by user interface 2012. As seen in the figure, user interface 2012 includes text fields for a first name, a last name, a billing address (as well as city, state, and zip code), a user name, a password, a contact telephone number, and an email address. These fields are just representative of some of the common types of information associated with a user profile and are not meant to be limiting. The user can click the “Edit” button in the user interface 2012 to edit these fields in their user profile before clicking the “Save” button to save those changes.

FIG. 20E is an example user interface of one embodiment of an in-vehicle application. More specifically, it illustrates a user interface 2014 in which a user may configure a road usage charge in-vehicle application (RIVA).

If the user chooses to go to the “Settings” page in the main menu of the RIVA, the user may be presented with a page similar to the user interface 2014 illustrated in the figure. User interface 2014 allows users to change the RUC program type and add or delete sponsor programs. User interface 2014 is shown offering several different RUC programs, such as those employed in the RUCP program as discussed previously (e.g., basic, advanced, switchable, etc.). The RUC programs available may vary state by state. The user can select the RUC program they wish to participate in and change this selection on the fly. Once a RUC program is selected, the RIVA will automatically communicate and interface with the vehicle in order to perform the necessary functions under that RUC program. For example, if the user selected a basic program in which GPS data is not needed, the RIVA would simply communicate with the vehicle to meter the total distance traveled by the vehicle. User interface 2014 can also be used to select sponsor programs. Users may be offered additional programs they can choose to participate in (for example, User Base Insurance/UBI, vehicle insurance offers or maintenance programs). The user can select or edit preselected programs in user interface 2014.

FIG. 20F is an example user interface of one embodiment of an in-vehicle application. More specifically, it illustrates a user interface 2016 in which a user may configure billing and payment for a road usage charge in-vehicle application (RIVA).

If the user chooses to go to the “Billing & Payment” page in the main menu of the RIVA, the user may arrive at a page similar to the user interface 2016 illustrated in the figure. User interface 2016 enables the user to select their billing and payment methods. For example, the user may choose to utilize email for paperless billing, in which the invoice is emailed to the user. The user may instead choose to utilize mail, in which the bill or invoice is mailed to the user's billing address. For payment options, the user may choose to utilize electronic billing, their credit/debit card, standard billing, and so forth. Under electronic billing, the user provides their bank routing and account number, so that the user's bank account can be directly billed. Under the credit/debit card payment option, the user provides credit/debit card information for automatic billing. Under the standard billing option, the user receives a paper invoice in the mail.

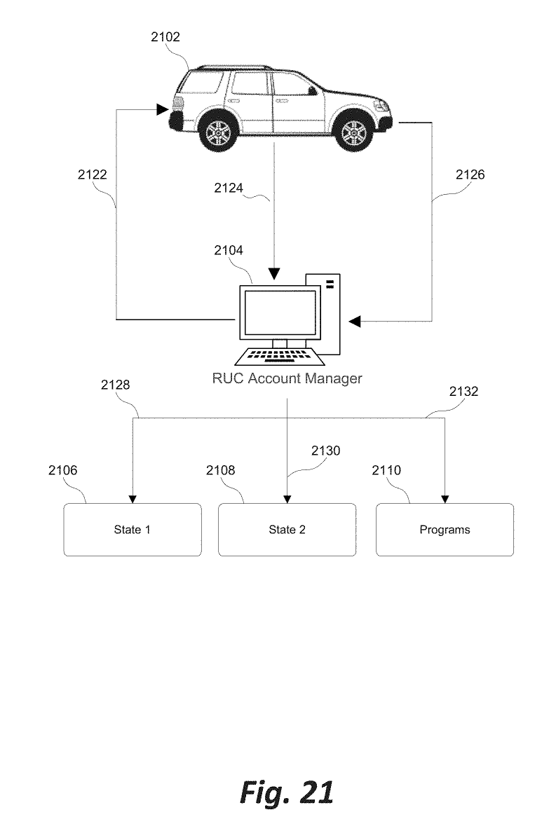

FIG. 21 illustrates how payment is processed for a road usage charge in-vehicle application (RIVA).

At arrow 2124, a RIVA-equipped vehicle 2102 will upload road usage data (miles driven on state highways, miles per gallon) at predetermined intervals via the cellular network. The RUC Account Manager 2104 will take that data and process it to invoice the user associated with the RIVA-equipped vehicle 2102. If there are any sponsor programs involved, the RUC Account Manager 2104 will send user data to the appropriate third party for the sponsor program (for example, an ignition interlock company or insurance company). The RUC Account Manager 2104 electronically processes received user data and invoices users electronically or by mail. If done electronically, the RUC Account Manager 2104 will at arrow 2122 send the invoice to the RIVA-equipped vehicle 2102. The user can submit payment electronically or by mail. If done electronically, the payment info will be sent at arrow 2126 to the RUC Account Manager 2104 to be collected and processed. At arrows 2128, 2130, and 2132, the RUC Account Manager 2104 will send road usage charge payments to any States or sponsor programs associated with road usage charges for the vehicle.

Currently, each state is operating their independent road usage charge program. If a vehicle leaves a state, the billing stops and the state the vehicle is traveling in does not receive any mileage based payment. This system has the ability to continue to collect mileage data and pay each state for the miles traveled in each respective State. For example, a vehicle could drive from CA to TX. The route traveled might be CA, AZ, NM and TX. The GPS coordinates (geofence) of the state lines can be monitored and logged when crossed. The RIVA would meter the miles driven in each state, collect each state's mileage tax, and pay each state accordingly. Payment would also be provided to any sponsor programs as well. As shown in the figure, the RUC Account Manager 2104 is seen distributing payments to State 2106, State 2108, and Program 2110.

### Financing and Loans

Another context in which the vehicle access and management system can be used is as a way to enforce financing and loan payments. A subprime loan is a type of loan that is offered at a rate above prime to individuals who do not qualify for prime rate loans. These subprime loans are issued relatively often; 25% of all new loans are subprime and the volume of subprime auto loans has reached more than $145 Billion. For subprime borrowers of auto loans, the average purchaser finances around 90 percent of the price of the automobile and the average loan size is around $11,000. However, repayment on the loan is highly uncertain; more than half of these subprime loans default, and the majority of these default within the first year of repayment. As a result, subprime borrowers are often turned away from traditional lenders because of their low credit ratings or other factors that suggest that they have a reasonable chance of defaulting on the debt repayment.

Furthermore, some creditors may not provide financing to a subprime borrower unless the borrower agrees to the installation of an electronic device that prevents the car from starting if the payments are not made on time. Such electronic devices have been installed in about 2 million vehicles, and 30% of auto loans issued by credit unions are associated with electronic devices for disabling and tracking. This technology has reduced the occurrence of late payments from nearly 29% to roughly 7%. Some dealers and lenders have even opted to use electronic devices with additional features, such as the ability to send payment reminders to their buyers, disable a car's ignition, or trigger alerts when vehicles cross pre-determined geographic boundaries or are stopped for an extended period of time (as in an abandoned vehicle). Overall, the use of these devices for enforcing loan payments has benefited both lenders (e.g., reducing repossession costs) and borrowers, primarily by modifying borrower behavior to help them stay on-time with payments. This has led to reduced delinquencies, lenders opening up to financing customers with lower credit scores or smaller down payments (without any increase in risk), and significant improvements in customer credit ratings.

These electronic devices currently cost around $200 and are offered in many configurations. For example, some devices are configured to reside under the dash of the car and provide GPS tracking to pinpoint the location of the car. A dealer or creditor only needs to pay a few dollars more to get the location data of the car if the borrower defaults on the loan. If the dealer or creditor is willing to pay $100 more, the device can be equipped with the ability to disable the car's ignition. Some devices may be configured to take a more active approach towards enforcing loan payment. Such devices may also have a keypad on which the borrower can enter a code to keep the car operating. The car may be outfitted with a monitoring box which starts to chirp with an audible warning when payment is due (typically every two weeks) in order to remind borrowers. If payment is not made and a code is not punched in, the device disables the car's ignition.

However, rather than using these devices, the vehicle access and management system described herein can instead be used for enforcing loan payments. This approach would provide many benefits. It eliminates the need for specialized, external hardware and installation, which would save money for dealers or lenders. Additionally, the vehicle access and management system could provide the same features from various existing devices (e.g., keypad codes, audible warnings, GPS tracking) while allowing the dealer or finance company to configure which sets of features to use with a specific borrower.

The vehicle access and management system may provide these features through a finance in-vehicle application (FIVA). The FIVA may be installed onto an In-Vehicle Infotainment Unit, such as the In-Vehicle Infotainment Unit 202, and configured to communicate with one or more computers using resources available to the Infotainment Unit. For example, the FIVA may be able to transmit data by accessing a vehicle's embedded wireless modem (commonly referred to as the OE modem) and GPS. In a configuration in which an external hub is used, such as the External Hub 502, the FIVA may be able to transmit data by accessing the external wireless modem and GPS from the external hub. Alternatively, the FIVA may be able access an embedded GPS for location information and transmit data by accessing the user's cell phone, which is paired to the Infotainment Unit (e.g., through OE Bluetooth). Thus, the FIVA would use the cell phone's wireless communications capability to upload or receive data.

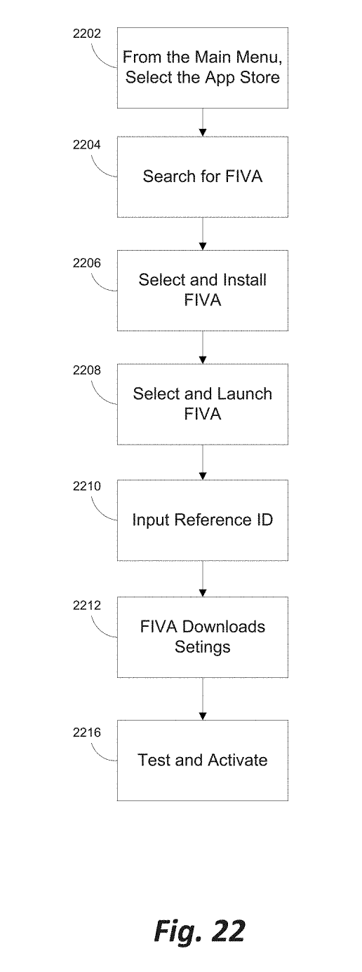

FIG. 22 is a flowchart that illustrates how a user may download and access one embodiment of a finance in-vehicle application (FIVA).

In some embodiments, the FIVA would need very little configuration by the borrower. Instead, the FIVA could be configured in advance by the dealer and/or the finance company prior to download and installation of the FIVA. The FIVA configuration settings could be preserved through the use of a special code, ID, or user profile. Once installed and configured, the FIVA would operate to warn the vehicle owner of late payment, remotely disable/enable the starter, and—if needed—locate the vehicle for recovery.

In some embodiments, the FIVA is downloaded by the car dealer at the time of purchase. At block 2202, the dealer navigates the main menu of the In-Vehicle Infotainment Unit to the App Store. At block 2204, the dealer searches the app store for the FIVA, such as by entering the application name in the search field. A list of search results would be presented on the user interface of the In-Vehicle Infotainment Unit.

At block 2206, the dealer selects the FIVA and chooses to install it. This initiates downloading of the FIVA onto the Infotainment Unit. At block 2208, once the application is downloaded the dealer selects to open or launch the application.

At block 2210, on initial launch the application will request a reference ID associated with the financial institution's account and settings. The settings for the FIVA may include, but are not limited to, an Emergency Bypass (EBP) PIN code (if required), the amount of EBP allowed, the EBP profile (based on how many starts or time extended), any payment extension requests where a borrower can request for a payment extension (e.g., extend payment for 1, 2, 5 days etc.), and so forth.

Once the reference ID is entered, at block 2212 the FIVA will download the corresponding configuration settings associated with that reference ID. These configuration settings may be located on a server for the FIVA to retrieve. At block 2216, once the settings have been downloaded the FIVA will enter the “Test and Activate” mode. In the “Test and Activate” mode, the FIVA will test all in-vehicle communication (wireless modem, GPS and diagnostics) and send an activation confirmation to the server.

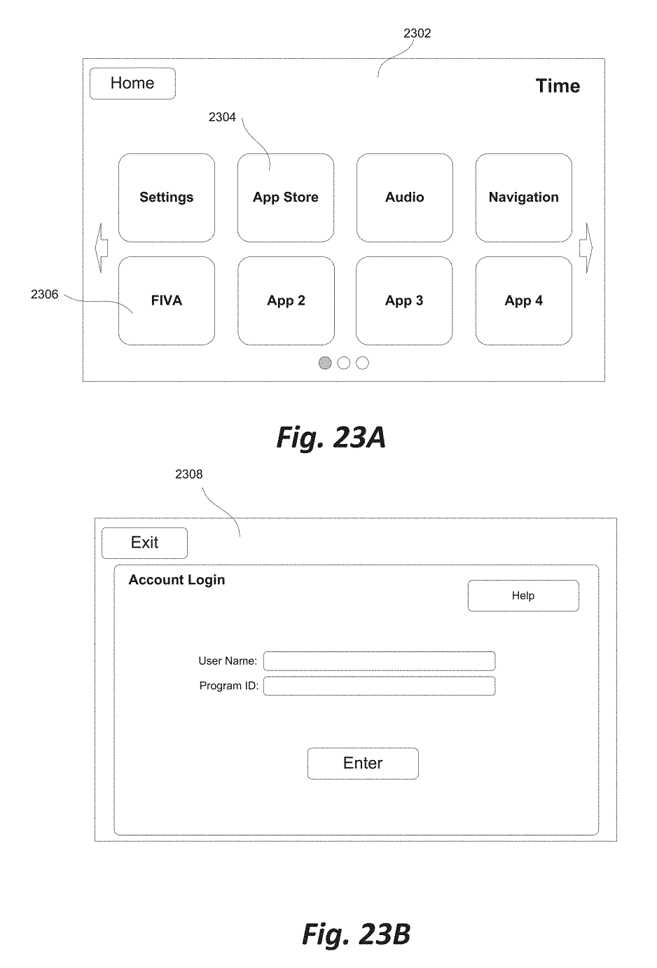

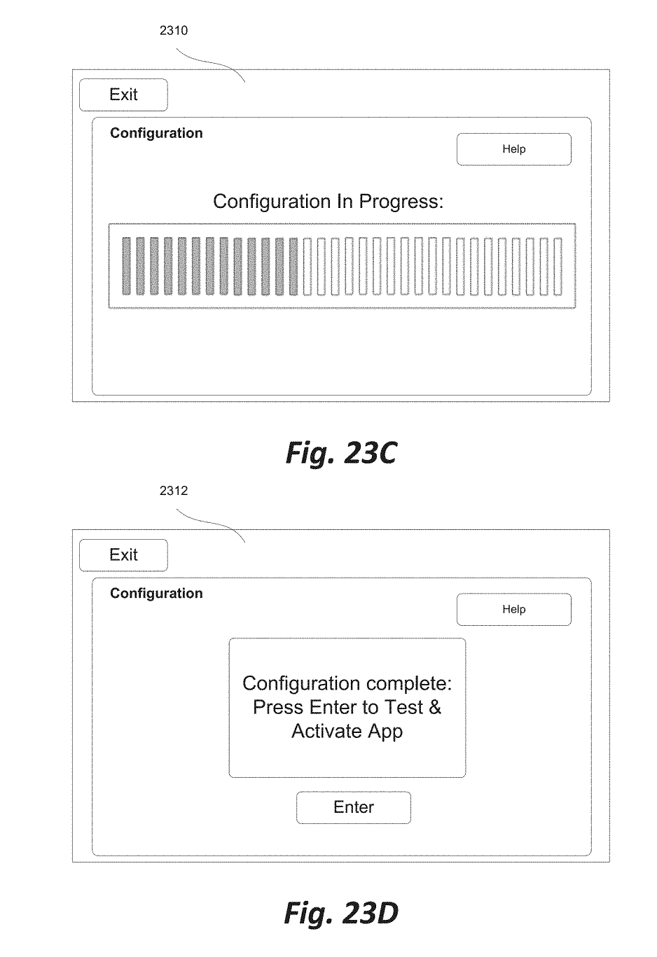

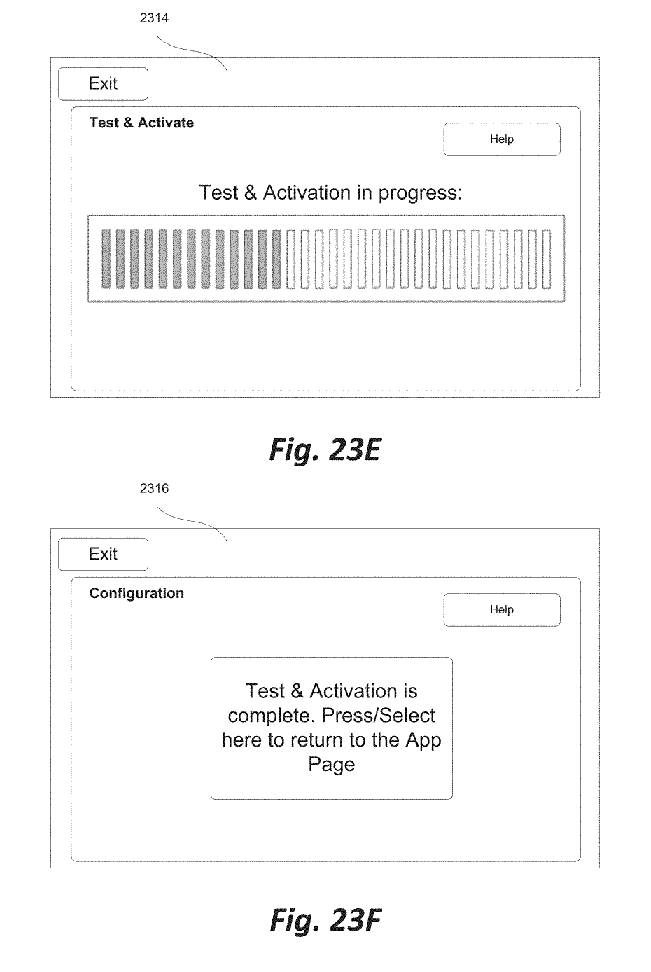

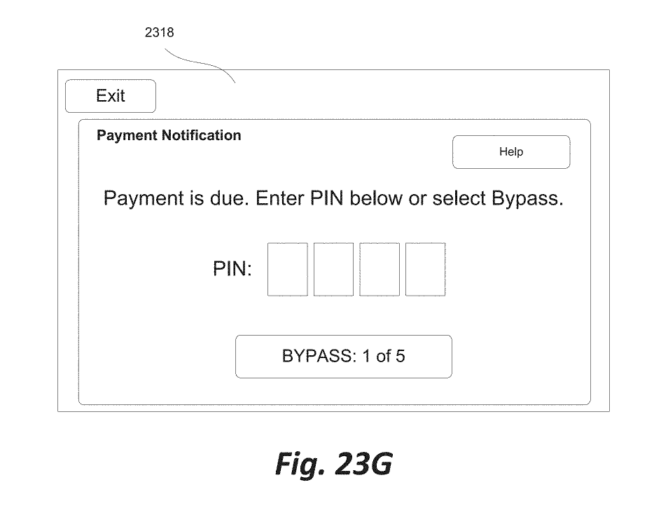

FIG. 23A illustrates an example user interfaces of one embodiment of a finance in-vehicle application (FIVA). More specifically, it illustrates a user interface 2302 in which a user may access a FIVA, such as FIVA 2306.

As can be seen in the figure, the user interface 2302 is a main menu that displays FIVA 2306 post-download and installation. The user interface 2302 allows FIVA 2306 to be accessed when selected by user. Also shown in user interface 2302 is the app store 2304, which is how the FIVA 2306 can be installed onto the Infotainment Unit. Accessing the app store 2304 may allow the user to search for and download the FIVA 2306, as previously described.

FIG. 23B illustrates an example user interfaces of one embodiment of a finance in-vehicle application (FIVA). More specifically, it illustrates a user interface 2308 in which the FIVA can be configured.

Upon launching the FIVA, the user may be presented user interface 2308 which has text fields for a user name and a program ID. The user may enter a user name, which may typically be a user name associated with the finance company. The user may also enter a program ID, which will download settings associated with that program ID. Examples of the settings that are associated with various program IDs include, but are not limited to, an EBP (Emergency Bypass) PIN (Personal Identification Number), an EBP limit for the number of times the vehicle operator can bypass or override the engine disable, the number of notifications before the engine is disabled, the Geozone(s) the vehicle is allowed to operate within (e.g., within a specific city or state), whether to monitor the driver's habits, and airbag detection for reporting if the vehicle has been in an accident.

FIG. 23C illustrates an example user interfaces of one embodiment of a finance in-vehicle application (FIVA).

Once the program ID is entered, the FIVA will attempt to download the configuration settings from the server. User interface 2310 is an example user interface that would be presented to the user while the configuration settings are retrieved and applied. There is a configuration status bar which communicates to the user the progress of obtaining the configuration settings.

FIG. 23D illustrates an example user interfaces of one embodiment of a finance in-vehicle application (FIVA).

Once the configuration settings have been applied, the FIVA may present a user interface such as user interface 2312 which communicates to the user that the configuration is complete. The user may hit the “Enter” button to test and activate the application, which yields a user interface such as the one shown in FIG. 23E.

FIG. 23E illustrates an example user interfaces of one embodiment of a finance in-vehicle application (FIVA).

Once the user opts to “Test and Activate” the application, the FIVA may present a user interface such as user interface 2314. There is a status bar which communicates to the user the progress of test & activation.

FIG. 23F illustrates an example user interfaces of one embodiment of a finance in-vehicle application (FIVA).

Once the test & activation is complete, the user is provided with user interface 2316 which informs the user that the process is complete. This lets the user know that the FIVA has been successfully configured and activated.

FIG. 23G illustrates an example user interfaces of one embodiment of a finance in-vehicle application (FIVA). More specifically, the figure illustrates how the FIVA could implement payment notification to remind borrowers their loan payment is due.

User interface 2318 prompts the vehicle owner to enter a unique PIN based on their payment schedule. This could be every 1, 2, 3 or 4 weeks (and so forth), depending on the configuration settings and the specifics of the loan. Once the payment has been processed, the vehicle owner receives a PIN electronically over email or SMS. The vehicle owner can then enter the PIN into user interface 2318 and the FIVA would extend the drive period accordingly (e.g., another 1, 2, 3 or 4 weeks). In an emergency scenario where the vehicle owner needs to operate the vehicle but cannot pay right away, the vehicle owner can choose to use one of their available bypasses in order to temporarily bypass the payment screen. If however, a payment is not received (i.e., PIN entered) FIVA will display a reminder message and sound a notification (through the vehicle's speaker system) each time the ignition is turned ON. If the PIN is not entered or the vehicle owner uses all their available bypasses, the FIVA would disable the engine by sending the ECU an engine disable command. Only once the payment has been made and the vehicle owner has entered the correct PIN will the FIVA enable the engine.

### Rental-Carshare (Continued)

Further in regards to the rental-carshare context as previously described, the carshare and connected car markets can be greatly improved by the technology disclosed herein. More specifically, a combination of hardware and software that includes customer-facing and back-office components will be necessary for implementing the carshare business model. Current technological implementations of carsharing may require $1000-$1700 per vehicle in upfront expenses related to the hardware for implementing carsharing, with the hardware lasting between three to six years. Furthermore, the software may be associated with a monthly hosting and support fee of $40-60 per vehicle, with an additional $15-20 for the cellular data plan.

The use of a rental-carshare in-vehicle application (RCSIVA) can greatly reduce the costs and resources needed to implement and maintain carsharing and connected car functionality by offering an improvement over current hardware and software implementations. The RCSIVA will enable vehicle/equipment/asset rental and allow carshare companies and corporate fleets to easily manage their assets, in most cases without the addition of external hardware to vehicles with existing internet capability. If the vehicle has an embedded cellular modem, GPS, and Bluetooth, all the required vehicle controls and customer interaction can be managed by the RCSIVA. However, if the vehicle does not have one or all of the required components needed for connected car services, an external hub can be added to provide the required long and short range wireless connectivity and GPS. For example, the external hub can provide cellular communication with the remote server, a Bluetooth interface with the customer, and GPS functionality for determining the location of the vehicle. The external hub can be used with the RCSIVA to also pair the RCSIVA with external peripheral devices. Some example user interfaces and illustrations of example embodiments of the RCSIVA are provided below.

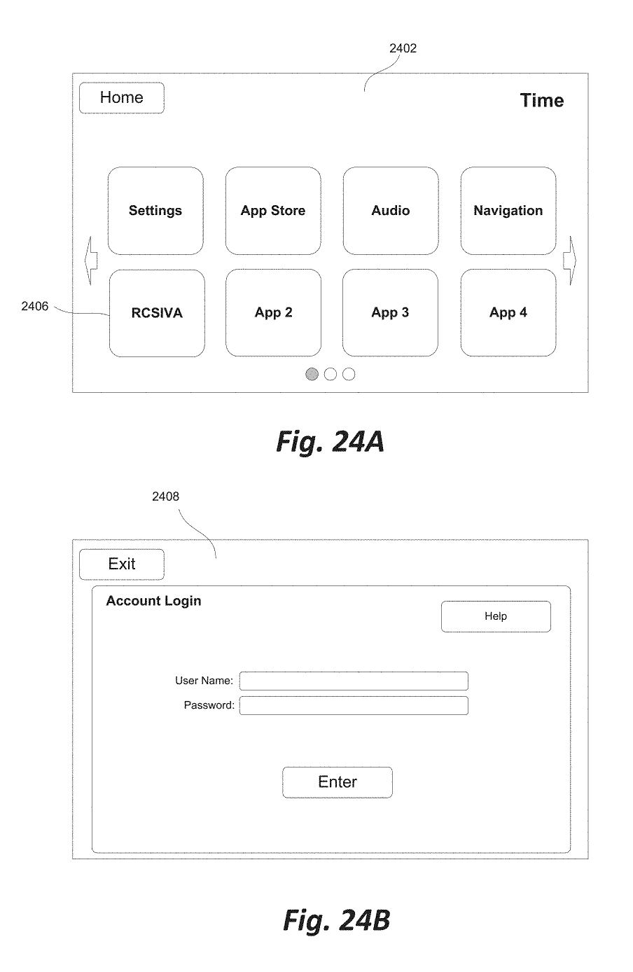

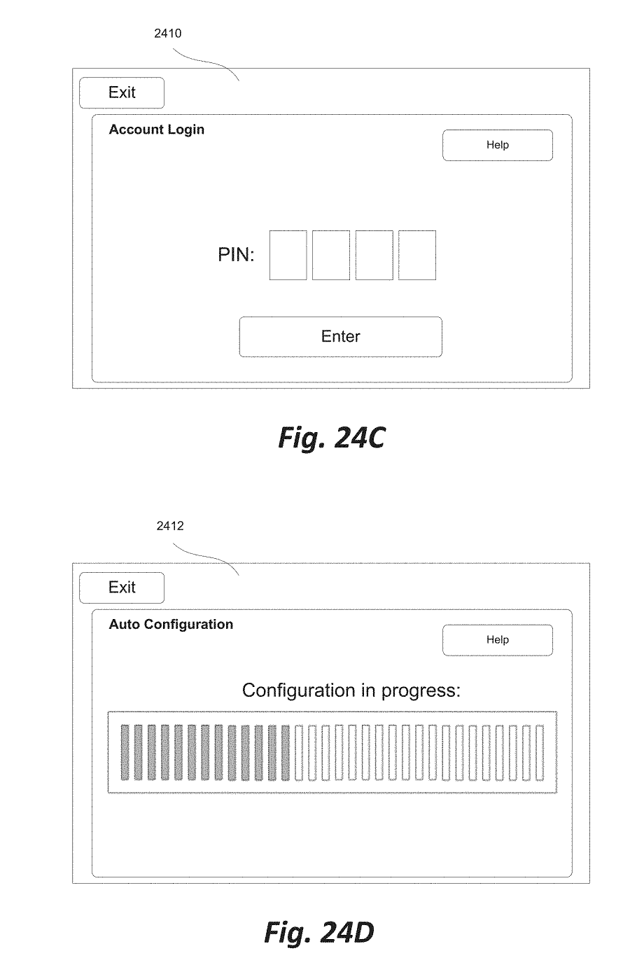

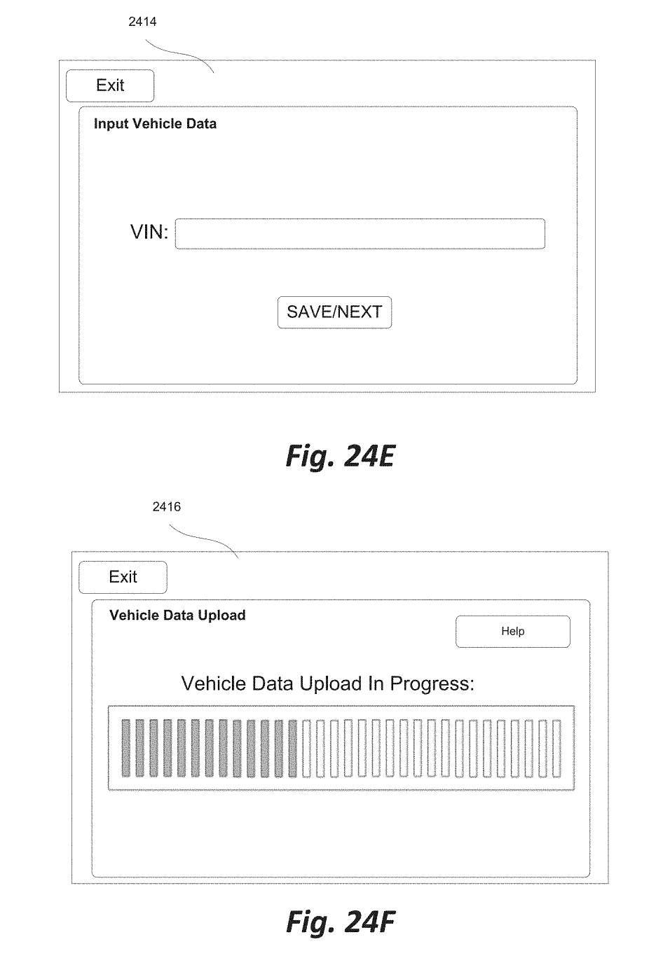

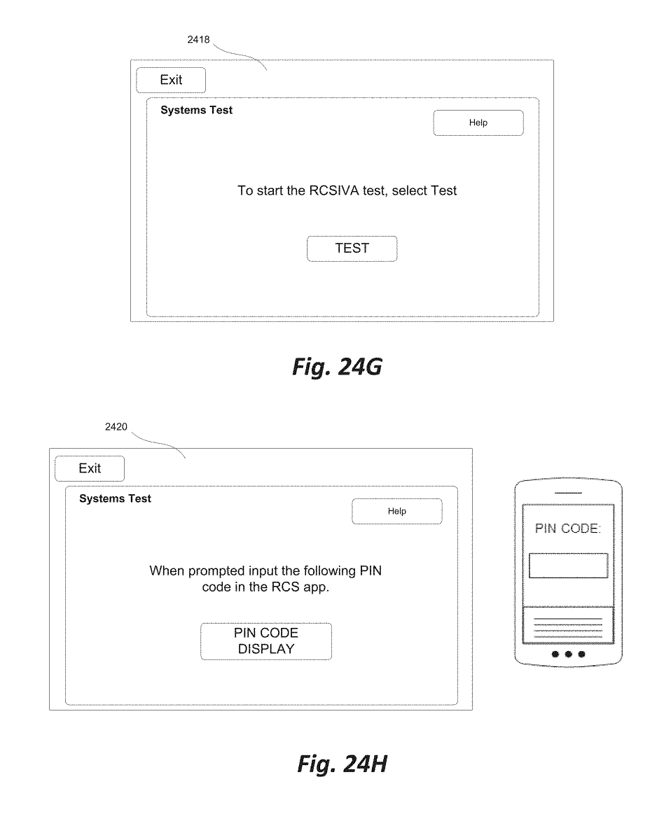

FIGS. 24A-24H illustrate various example user interfaces of one embodiment of a rental-carshare in-vehicle application (RCSIVA).

FIG. 24A illustrates a user interface 2402 having an option to select RCSIVA 2406. Once RCSIVA 2406 has been downloaded and installed on the in-vehicle infotainment system, selecting RCSIVA 2406 in an application menu such as the user interface 2402 may open the RCSIVA 2406.

FIG. 24B illustrates a user interface 2408 for logging into the RCSIVA. A user of the RCSIVA may enter their user name and password, such as through a touchscreen display of the in-vehicle infotainment system, in order to log into the RCSIVA.

FIG. 24C illustrates a user interface 2410 that may also be associated with an user logging into the RCSIVA. A user of the RCSIVA may have to enter a PIN as an additional credential in order to complete logging into the RCSIVA.

FIG. 24D illustrates a user interface 2412 that may be displayed while the RCSIVA is being auto-configured. After logging into the RCSIVA, if the RCSIVA has not been configured yet it will automatically launch the auto-configuration mode while displaying user interface 2412. During this auto-configuration, the RCSIVA will reference the login credentials and connect to the appropriate server to upload vehicle specific information, including but not limited to, vehicle identification number (VIN—which indicates the vehicle year, make, model, color, engine, body type, and so forth), readings for the odometer, and readings for the fuel level.

Once the upload is complete, the server may download vehicle configurations specific to the vehicle and/or rental type (rental, corporate, carshare, and so forth). For example, possible configurations include notifications types, which can include but are not limited to: 1) a check engine light ON notification, where if the check engine light is ON, the RCSIVA will send pending and stored diagnostic trouble codes (DTC); 2) driver habits notifications, which monitors hard/extreme braking and acceleration and sends an alert if the driver exceeds a preset limit; 3) speed limit notifications, where an alert is sent if the vehicle speed exceeds a preset limit; 4) geozone notifications, where an alert is sent if the vehicle leaves a predetermined area or radius; and 5) mileage based maintenance notifications, where the vehicle will generate a service alert when the vehicle drives a preset mileage (for example, an alert is sent each time the vehicle drives 3,000 miles, then the miles count is reset to zero). The mileage accumulator can be reset once maintenance has been done.

FIG. 24E illustrates a user interface 2414 that may be displayed if there are data fields that cannot be processed automatically while the RCSIVA auto-configures. Any data fields not automatically processed will require the user to input those data fields into the user interface 2414. For example, if the VIN could not be read, the user would be prompted to input the VIN. The user would select the Save button to finish inputting data, or the Next button if more vehicle data is required to be input.

FIG. 24F illustrates a user interface 2416 that may be displayed once all the required vehicle data has been manually input into the RCSIVA. The RCSIVA will upload vehicle data and the user interface 2416 provides a progress bar of that upload.

FIG. 24G illustrates a user interface 2418 that may be displayed once the upload of vehicle data is complete. The RCSIVA may enter a test mode to verify key information and connectivity. This will require the use of a Bluetooth-enabled smartphone with a corresponding IVA mobile application. The test can be done from the RCSIVA or a mobile app via Bluetooth. User interface 2418 may provide a button for the user to select to begin the testing process. As illustrated, the testing process is displayed via the RCSIVA but the testing may be duplicated on the mobile application or from a remote server (cloud).

FIG. 24H illustrates a user interface 2420 that may be displayed as part of the systems testing process. The user interface 2420 requests that the user input a RCSIVA PIN on their corresponding smartphone application. Submitting the PIN verifies the user and pairs the smartphone application to the RCSIVA for the test period.

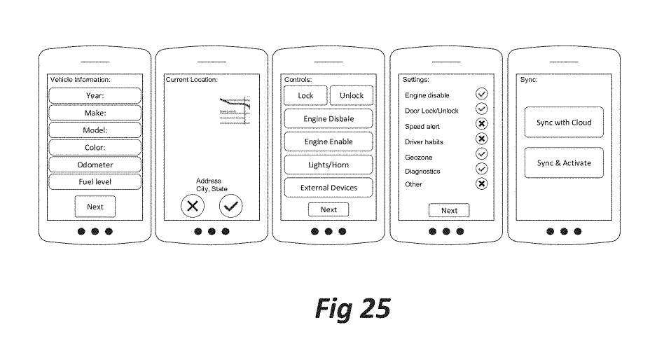

FIG. 25 illustrates various example user interfaces on a mobile device used in conjunction with a rental-carshare in-vehicle application (RCSIVA). Upon entering the PIN, various tests and settings pages illustrated in FIG. 25 are displayed via the smartphone application.

For example, the smartphone application may display vehicle information (including but not limited to the following): vehicle information can be obtained from the VIN, such as the year the vehicle was manufactured, the vehicle make (Audi, BMW, Ford, etc.), the vehicle model type or number (ex: A8, 4.0L), the vehicle body color, the current odometer reading, the current fuel level, and so forth. The vehicle data may be displayed in the proper section of the interface and be edited by tapping on that section, which would open a “picker window” that the user would scroll through until the right selection is in view. The user could then center the correct selection and tap on it to apply.

The smartphone application may also display the current location to confirm the vehicle's GPS is working properly. There may be a map display, which displays an icon on a map representing the graphical location of the vehicle. The application may display the address, including the street address, city, and state along with options for the user to verify the address. For example, there may be “X” and “I” marks, so that if the address is incorrect the user selects the “X” mark or if the address is correct, the user selects the “✓” mark to move to the next section.

The smartphone application may also display controls, which enables the user to test the RCSIVA vehicle control commands. For example, there may be an option for the user to send a door lock command to the vehicle, send a door unlock command to the vehicle, disable the engine so it will not start, enable the engine for starting, and flashing the lights and/or chirping the horn of the vehicle for a predetermined period. There may be options for the user to view and test external, connected devices. For example, the user may be able to see a connected external hub, the method of connection (such as Bluetooth or CAN Bus), the GPS and cellular signal strength, and any peripheral devices connected (e.g., RFID reader, Key/Gas card holder, breathalyzer, etc.). There may also be an option for the user to view and test devices connected to the RCSIVA via Bluetooth. Other control commands may be added as options as the RCSIVA gains additional access to vehicle controls.

The smartphone application may also display settings, which enables the user to set the RCSIVA settings or profile. In most cases this will be preset by the rental company and downloaded during the auto-configuration process. The settings may also be editable by the user through the settings page, in which various settings can be toggled ON/OFF by tapping the icon (or ✓ or X, respectively).

The smartphone application may also provide an option to sync the results with the backend or remote server once the test has been completed. The system may sync without activating the vehicle, or the system may sync and activate to make the vehicle rentable.

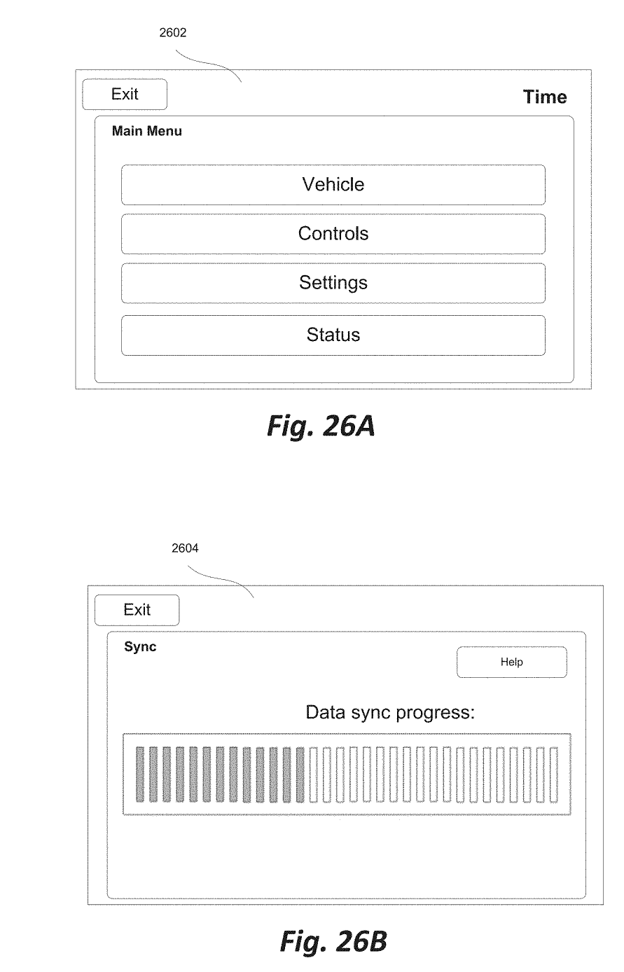

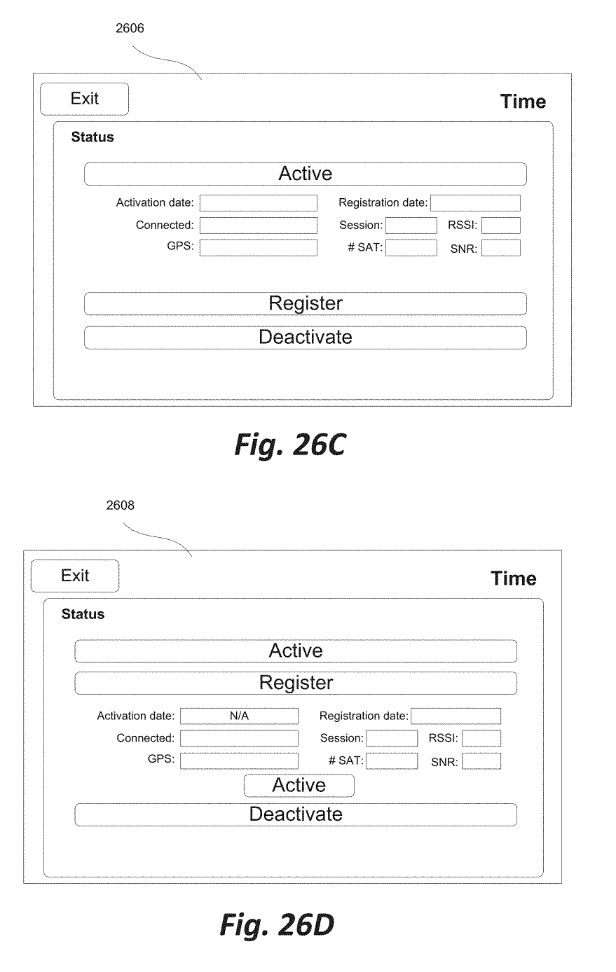

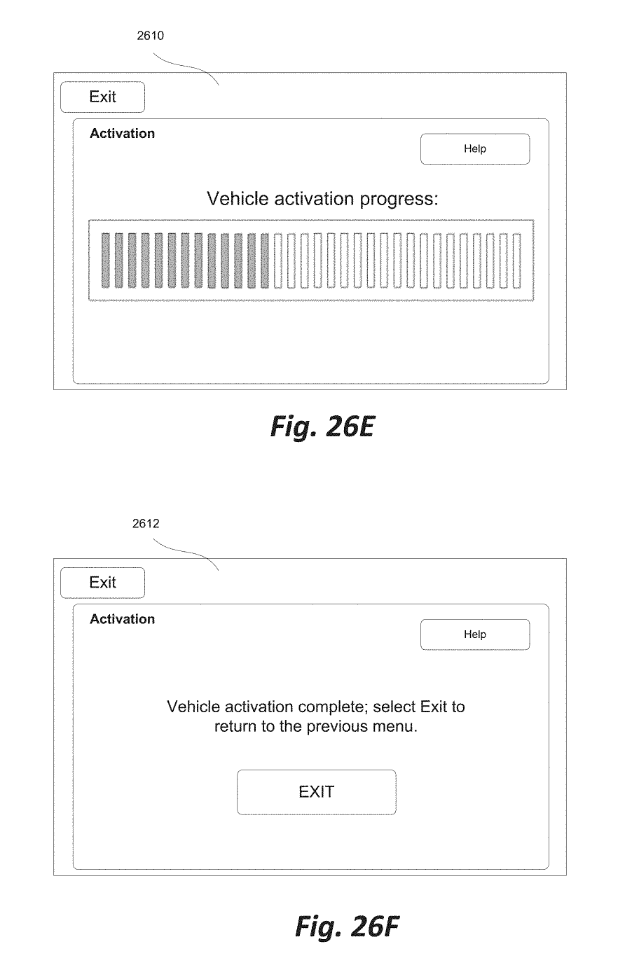

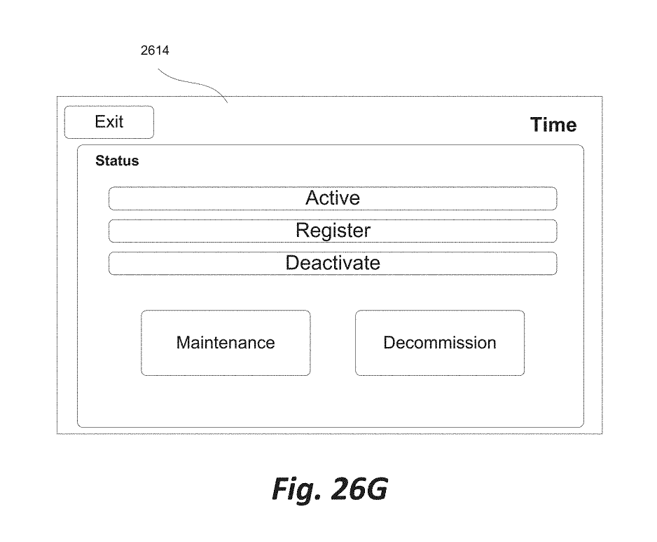

FIGS. 26A-26G illustrate various example user interfaces of one embodiment of a rental-carshare in-vehicle application (RCSIVA). More specifically, the figures illustrate example user interfaces of the RCSIVA once it has already been configured and tested.

FIG. 26A illustrates a user interface 2602 that may be displayed upon the user logging into the RCSIVA. The user interface 2602 may be a main menu, having sections for Vehicle, Controls, Settings, or Status. Each section may have a “Save and Exit” button, which causes the RCSIVA to return to the main menu. If any changes were made the application will automatically upload the changes to the remote server. During the upload process, the user interface 2604 of FIG. 26B may be shown in order to inform the user of the synchronization process.

In the Vehicle section, the user may be able to view and edit vehicle information, depending on data retrieved from the VIN and/or remote server. Some of the vehicle information includes the year of manufacture, make, model, color, odometer reading, fuel level reading, and so forth. The application may also be able to display the vehicle's current address, including the street address, city, and state. Certain data entries may be editable, while others may be restricted from editing. For example, the year of manufacture is generated from the VIN and would not be editable.

In the Controls section, the user may be able to view and test the capabilities for the RCSIVA to control various aspects of the vehicle. For example, the user may be able to lock/unlock vehicle doors, disable/enable the engine, turn on/off the lights/horn, and check or monitor external devices.

In the Settings section, the user may be able to view and edit vehicle settings. For example, the user may be able to turn on/off the engine disable, the door lock/unlock, the speed alert, the driver habits notification, the geozone notification (as well as set a zone, such as a specific city or state), and the diagnostics. This section may have additional monitoring options as more access to data is available and provided to the RCSIVA.

In the Status section, the user may be able to view the activation status of the vehicle. Within this section, if the vehicle/application is active, then the “Register” function is inactive and cannot be selected. Additional detail regarding the Status section is provided in FIGS. 26C and 26D.

FIG. 26C illustrates a user interface 2606 that may be displayed in the Status section of the RCSIVA main menu. If the vehicle is active, the Active bar of user interface 2606 will be expanded to display the activation date, registration date, connect, session, RSSI, GPS, # SAT, and SNR. The activation date may refer to the month/day/year and time the system was activated. The registration date may refer to the month/day/year and time the system was registered. Connect may refer to the current connection status. A “YN” may indicate the system is connected to the cellular network but not the remote server. A “YS” may indicate the system is connected to the network and the remote server. A “NC” may indicate that the system is not connected to the network or the remote server. Session may refer to the hours/minutes/seconds the system has been connected. If a “NC” is present, then it would instead display the hours/minutes/seconds the system has been disconnected. RSSI may refer to the cellular signal strength. GPS may indicate if the GPS has a fix and a location has been identified. If “fix” is present, a GPS location has been identified, whereas if “no fix” is present, then no GPS location has been identified. # SAT may refer to the number of satellites present. SNR may refer to the GPS signal strength or signal-to-noise ratio.

FIG. 26D illustrates a user interface 2608 that may be displayed in the Status section of the RCSIVA main menu. If the system has not been activated then the user may access the “Register” tab. Certain aspects of the “Register” tab will be similar to the “Activate” tab. For example, the user interface 2608 may display the same connectivity, cellular, and GPS data. A user may be able to select “Activate” in order to activate the system. Upon selecting “Activate”, the user interface 2610 of FIG. 26E may be presented to the user to inform the user of the activation progress. Once the activation is complete, the user interface 2612 of FIG. 26F may be presented to the user to inform the user that the vehicle activation is complete.

Choosing the “Deactivate” option may remove the RCSIVA from the in-vehicle infotainment system. This is primarily used when the vehicle or asset is removed from the fleet for maintenance, or if the vehicle or asset is being removed permanently. For example, most car rental companies roll the vehicle inventory every 12 to 14 months so vehicles are periodically removed from the fleet.

FIG. 26G illustrates a user interface 2614 which also has the “Active”, “Register”, and “Deactivate” tabs/buttons. However, the user interface 2614 also has options for “Maintenance” and “Decommission”. “Maintenance” is selected if the vehicle requires maintenance and will be placed back in the fleet post-maintenance. The system must be activated from the Register page prior to being put back in the fleet. “Decommission” is selected instead if the vehicle is being removed from the rental fleet permanently. Once a “Deactivate” selection has been made, the RCSIVA may display a user interface having a progress screen, such as the one shown in FIG. 26E.

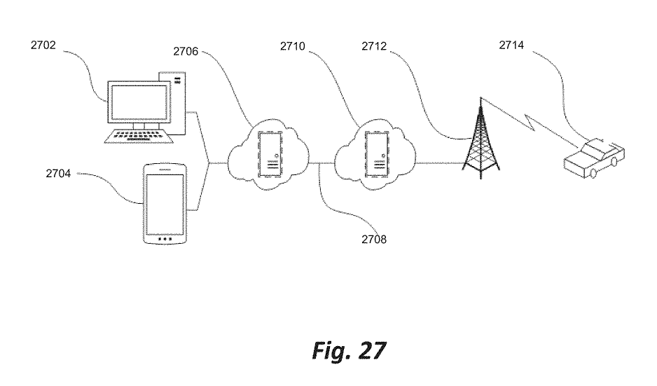

FIG. 27 is a system diagram that illustrates how the vehicle access and management system may be implemented in a rental-carshare context.

Once the RCSIVA has been downloaded, configured, and activated, it is ready for use. There are two types of reservations: scheduled reservations and open/onsite reservations. For a scheduled reservation, a renter will schedule the reservation online or from a mobile application. For an open or onsite reservation, the renter can select a vehicle from a specific location (e.g., within a lot where multiple cars are available) or a single location (e.g., at a parking spot within a city where the vehicle is parked). The user may process the reservation through the company's website or mobile application.

The customer or user can register to use the rental company's reservation website from any internet-enabled computer 2702 or smartphone 2704 running the company's mobile application. Both methods give the user access to all available vehicles at a specific location during the user's selected pick-up and drop-off dates and times (rental period).

Once the user confirms the vehicle type and rental period, the company's data center 2706 will send the information over the VPN connection 2708 to the cellular provider 2710. The cellular provider 2710 will process and send the information to the tower 2712 for which the cellular modem of the vehicle 2714 is registered on. The information will be passed to the vehicle 2714, and the RCSIVA will store the reservation data for future processing.

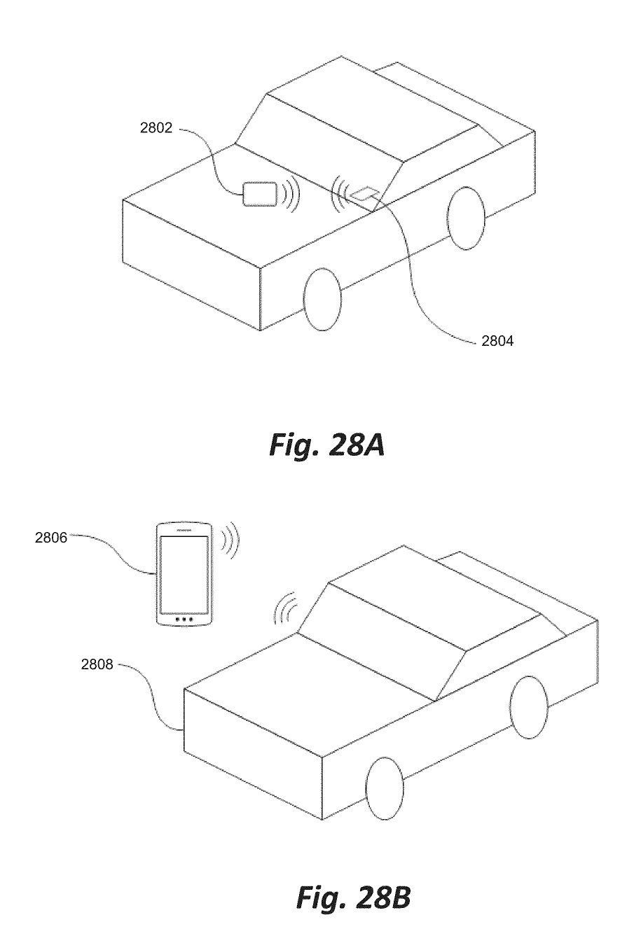

FIGS. 28A and 28B illustrate how the vehicle access and management system may be implemented in a rental-carshare context. After reserving a vehicle or asset, a user will need access to the vehicle at the pickup location and time indicated in the reservation. FIGS. 28A and 28B illustrate an example access method and are intended to be non-limiting; any access method may be used in connection with reservations and the RCSIVA.

In regards to FIG. 28A, a vehicle can be equipped with a dash mounted RFID/NFC reader. The reader will interface with the RCSIVA via the vehicle's embedded Bluetooth device or through the external hub via a hardware wire connection or Bluetooth. A user may register online with the rental company and select an access method. If the user selects to use a RFID card, it will be sent to the user. If the user selects to use a smartphone, the user will be required to download the company's mobile application. The mobile application ID used to identify the user can be generated by the application based on the smartphone or embedded Bluetooth (for example, phone ID, IMEI, MEID, UUID).

The user may present their RFID card 2802 to the RFID reader 2804 and the unique ID will be processed by the RCSIVA to verify the reservation. If verified, the RCSIVA will send a door-unlock command and an engine enable command to the vehicle. The user will gain full access to the vehicle during the rental period. In most cases, the vehicle key will be stored in the Key/Gas card holder located in the vehicle's glove box.

At the end of the rental period, the user will return the vehicle to the lot and present the RFID card 2802 to the RFID reader 2804. The RCSIVA will lock the doors, disable the engine, and upload vehicle-specific information related to the rental (for example, mileage, fuel level, driver habits, high or low impact, and current DTCs).

In regards to FIG. 28B, a user's smartphone mobile rental application 2806 will scan for the vehicle 2808 unique ID. Once the ID is detected, the mobile rental application 2806 and the RCSIVA will enter a communication process to validate the user's ID. Upon ID and reservation verification, the RCSIVA will unlock the doors of the vehicle 2808 and enable the engine. In this use case, the RCSIVA will become a beacon which allows the mobile rental application 2806 to detect the presence of the beacon and transmit data between the RCSIVA and the mobile rental application 2806.

### Example System Implementation and Architecture

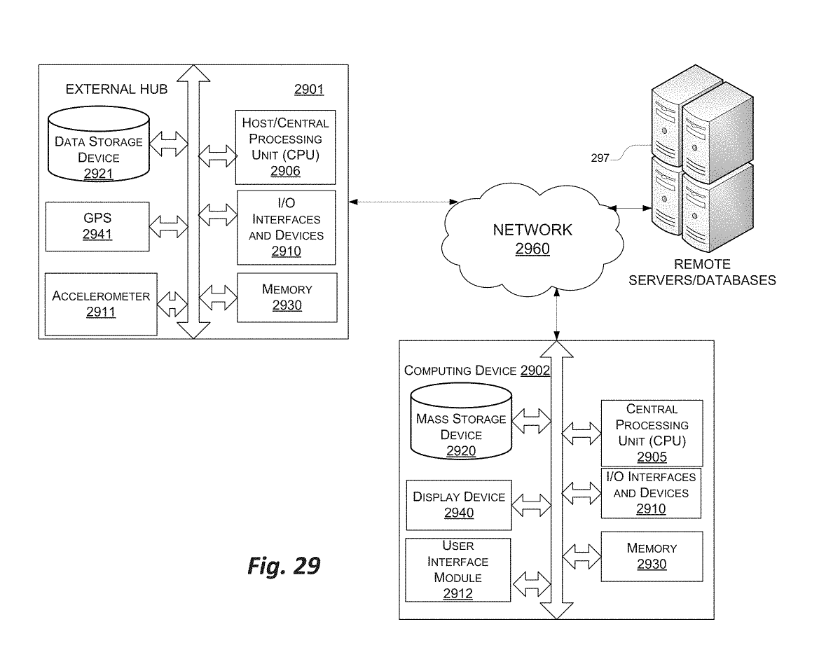

FIG. 29 is a block diagram showing an embodiment of computing device 2902 (which in some embodiments, may be the in-vehicle infotainment unit or a mobile device), and external hub 2901, which may be in communication with network 2960 (wireless networks connected to the Internet) and various computing systems, such as remote servers 2970, that are also in communication with the network 2960. The computing device 2902 and/or the external hub 2901 may be used to implement systems and methods described herein.

As described above, some embodiments may include portions that are executed by the remote servers 2970 and/or by the computing device 2902 and/or the external hub 2901, or are entirely executed by the remote servers 2970 or the computing device 2902, or the external hub 2901. Thus, discussion herein of any structure (e.g. CPU, memory, etc.) of the computing device 2902 or external hub 2901, or operations performed by the computing device 2902 or external hub 2901, may be equally applied to the remote servers 2970.

The computing device 2902 (e.g. the mobile device that executes mobile applications or the infotainment unit that executes IVAs as described herein) includes, for example, a personal computer that is IBM, Macintosh, iOS, Android or Linux/Unix compatible or a server or workstation. In one embodiment, the computing device 2902 comprises a server, a laptop computer, a smart phone, a personal digital assistant, a kiosk, or an media player, for example. In another embodiment, the computing device 2902 comprises an in-vehicle infotainment unit. In one embodiment, the exemplary computing device 2902 includes one or more central processing unit (“CPU”) 2905, which may each include a conventional or proprietary microprocessor. The computing device 2902 further includes one or more memory 2930, such as random access memory (“RAM”) for temporary storage of information, one or more read only memory (“ROM”) for permanent storage of information, and one or more mass storage device 2920, such as a hard drive, diskette, solid state drive, or optical media storage device. Typically, the modules of the computing device 2902 may be connected to the computer using a standard based bus system. In different embodiments, the standard based bus system could be implemented in Peripheral Component Interconnect (“PCP”), Microchannel, Small Computer System Interface (“SCSI”), Industrial Standard Architecture (“ISA”) and Extended ISA (“EISA”) architectures, for example. In addition, the functionality provided for in the components and modules of computing device 2902 may be combined into fewer components and modules or further separated into additional components and modules, and executed in software, hardware, or a combination of hardware and software.

The computing device 2902 is generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, or other compatible operating systems. In Macintosh systems, the operating system may be any available operating system, such as MAC OS X. In other embodiments, the computing device 2902 may be controlled by a proprietary operating system. Conventional operating systems control and schedule computer processes for execution, perform memory management, provide file system, networking, I/O services, and provide a user interface functionality usable by the user interface module 2912, such as a graphical user interface (“GUI”), among other things.

The exemplary computing device 2902 may include one or more commonly available input/output (I/O) devices and interfaces 2910, such as a keyboard, mouse, touchscreen, and printer. In one embodiment, the I/O devices and interfaces 2910 include one or more display devices, such as a monitor or touchscreen 2940, which allows the visual presentation of data to a user. More particularly, a display device provides for the presentation of GUIs, application software data, and multimedia presentations, for example. The computing device 2902 may also include one or more multimedia devices, such as speakers, video cards, graphics accelerators, and microphones, for example.

In the embodiment of FIG. 29, the I/O devices and interfaces 2910 provide a communication interface to various external devices. In the embodiment of FIG. 29, the computing device 2902 is electronically coupled to a network 2960, which comprises one or more of a LAN, WAN, and/or the Internet, for example, via a wired, wireless (such as 802.11 networks or a cell phone network), or combination of wired and wireless, communication link. The network 2960 communicates with various computing devices and/or other electronic devices via wired or wireless communication links.

In some embodiments information may be provided to the computing device 2902 over the network 2960 from remote servers 2970. Similarly, in some embodiments, information may be provided to the remote servers 2970 over the network 2960 from external hub 2901 or computing device 2902. The remote servers 2970 may include one or more internal and/or external data sources. The data sources may include internal and external data sources which store, for example, rental car or car share reservation data, and vehicle, control unit and customer data and properties, and associations thereof. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In the embodiment of FIG. 29, the computing device 2902 includes a user interface module 2912 that may be stored in the mass storage device 2920 as executable software codes that are executed by the CPU 2905. This and other modules in the computing device 2902 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 29, the computing device 2902 is configured to the execute the user interface module 2912 in order to for example, reserve and pickup vehicles, and perform and visualize other operations described herein.

User interface module 2912 may generate and render, for example, user interfaces used in the mobile application or the IVA that is displayed in the infotainment unit. By interacting with these user interfaces, a user of computing device 2902 may view various information about various connected-vehicle services.

In general, the word “module,” as used herein (except as otherwise defined, such as in control module), refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, such as the computing device 2902, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Like the computing device 2902, remote servers 2970 and external hub 2901 may comprise similar computing hardware, software, and functionality as described above for computing device 2902.

### Other

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the remote servers 1970, external hub 1901, computing device 1902, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A non-transitory computer storage medium which stores an application for vehicle access and management comprising executable instructions that direct an in-vehicle infotainment unit to perform a process comprising:
receiving, over a wireless network, reservation information from a remote computer system, the reservation information including a reference temporary access code;
storing the reservation information including the reference temporary access code in memory;
receiving, through a short-range wireless connection, a temporary access code from a mobile device;
determining that the temporary access code corresponds to the reference temporary access code;
determining a transmission protocol associated with a vehicle for issuing commands over a controller area network (CAN) bus within the vehicle;
determining a set of commands configured to instruct the vehicle to perform one or more vehicle functions;
determining an unlock command from the set of commands, the unlock command configured to instruct a locking mechanism of the vehicle to unlock; and
at least partly in response to determining that the temporary access code corresponds to the reference temporary access code, transmitting, over the CAN bus, the unlock command to the locking mechanism of the vehicle using the transmission protocol.

2. The non-transitory computer storage medium of claim 1, wherein the short-range wireless connection is one of: RFID, Bluetooth, or NFC.

3. The non-transitory computer storage medium of claim 1, wherein the locking mechanism is a door lock of the vehicle.

4. An external hub device configured to be used with an in-vehicle infotainment unit, the external hub device comprising:
a hardware processor,
a GPS chipset, the GPS chipset electronically connected with a first antenna, and in communication with the hardware processor;
a wireless modem, the wireless modem in communication with the hardware processor, and connected to a second antenna, the wireless modem configured to communicate over a wireless network;
a short-range communication chipset connected to a third antenna, the short-range communication chipset configured to communicate over a short-range wireless connection;
an accelerometer, the accelerometer in communication with the hardware processor;
an electronic communications port configured to communicate with an on-board diagnostics device of a vehicle;
a controller area network (CAN) bus transceiver, the CAN bus transceiver in communication with the hardware processor and configured to communicate with a controller area network; and
a data store, the data store in communication with the hardware processor, the data store comprising non-transitory computer storage comprising executable instructions that direct the hardware processor to at least:
receive, via the wireless modem, reservation information including a reference temporary access code;
store the reference temporary access code in the data store;
receive, over the third antenna connected to the short-range communication chipset from a mobile device, a temporary access code from a mobile device;
determine that the temporary access code corresponds to the reference temporary access code;
determine a transmission protocol associated with the vehicle for issuing commands over a CAN bus within the vehicle;
determine a set of commands configured to instruct the vehicle to perform one or more vehicle functions;
determine an unlock command from the set of commands, the unlock command configured to instruct a locking mechanism of the vehicle to unlock; and
at least partly in response to determining that the temporary access code corresponds to the reference temporary access code, transmit, over the CAN bus via the CAN bus transceiver, the unlock command to the locking mechanism of the vehicle using the transmission protocol.

5. The external hub device of claim 4, wherein the short-range wireless connection is one of: RFID, Bluetooth, or NFC.

6. The external hub device of claim 4, wherein determining the set of commands configured to instruct the vehicle to perform one or more vehicle functions comprises:
receiving, over the electronic communications port configured to communicate with the on-board diagnostics device, a vehicle identification number, the vehicle identification number identifying the vehicle and the set of commands configured to instruct the vehicle to perform one or more vehicle functions;
transmitting a request, via the wireless modem, to a remote computing system, the request comprising the vehicle identification number, the request configured to inquire for configuration information for the set of commands configured to instruct the vehicle to perform one or more vehicle functions;
receiving, via the wireless modem, from the remote computing system, the set of commands configured to instruct the vehicle to perform the one or more vehicle functions; and
storing, in the data store, the set of commands configured to instruct the vehicle to perform the one or more vehicle functions.

7-10. (canceled)
